(19) United States
(12) Patent Application Publication
(10) Pub. No.: US 2022/0007264 A1
(43) Pub. Date: Jan. 6, 2022

(54) UE AND SMF

(71) Applicants: SHARP KABUSHIKI KAISHA, Sakai City, Osaka (JP); FG Innovation Company Limited, Tuen Mun (HK)

(72) Inventor: TSUYOSHI TAKAKURA, Sakai City, Osaka (JP)

(21) Appl. No.: 17/293,875

(22) PCT Filed: Nov. 1, 2019
(86) PCT No.: PCT/JP2019/043113

§ 371 Date: May 13, 2021

(30) Foreign Application Priority Data
Nov. 16, 2018 (JP) 2018-215876

(51) Int. Cl. H04W 48/02; H04W 76/11; H04W 76/18

(52) U.S. Cl. CPC H04W 48/02; H04W 76/18; H04W 76/11

(57) ABSTRACT

To provide a communication control method for control signal management based on a reject cause related to a DN authentication procedure, in particular, other than congestion management. Based on a reject cause value indicating DN authentication failure, transmission of a new PDU session establishment message using a parameter identical to the DNN included in a rejected PDU session establishment message is suppressed. In addition, transmission of a new PDU session establishment message using information identical to the combination of the DNN and the S-NSSAI included in the rejected PDU session establishment message is suppressed.

### TECHNICAL FIELD

The present invention relates to a UE and an SMF. This application claims priority based on JP 2018-215876 filed on Nov. 16, 2018, the contents of which are incorporated herein by reference.

### BACKGROUND ART

The 3rd Generation Partnership Project (3GPP), which undertakes activities for standardizing recent mobile communication systems, has studied System Architecture Evolution (SAE) which is a system architecture of Long Term Evolution (LTE). The 3GPP is in the process of standardizing Evolved Packet System (EPS) as a communication system for realizing an all-Internet Protocol (IP) architecture. Note that a core network constituting the EPS is called an Evolved Packet Core (EPC).

Additionally, the 3GPP recently has been studying a next-generation communication technology and a system architecture for 5th Generation (5G) mobile communication system which is a next-generation mobile communication system. In particular, as a system for achieving the 5G mobile communication system, the 3GPP is in a process of standardizing 5G System (5GS) (see NPL 1 and NPL 2). In the 5GS, technical problems attributable to connection of various terminals to a cellular network are extracted to standardize solutions.

For example, requirement conditions include optimization and diversification of a communication procedure for supporting a continual mobile communication service depending on a terminal supporting various access networks, optimization of a system architecture suitable for the optimization and diversification of the communication procedure, and the like.

### CITATION LIST

### Non Patent Literature

Non Patent Literature 1: 3GPP TS 23.501 v1.0.0; 3rd Generation Partnership Project; Technical Specification Group Services and System Aspects; System Architecture for the 5G system; Stage 2 (Release 15)
Non Patent Literature 2: 3GPP TS 23.502 v0.4.0; 3rd Generation Partnership Project; Technical Specification Group Services and System Aspects; Procedures for the 5G system; Stage 2 (Release 15)
Non Patent Literature 3: 3GPP TS 24.501 v15.1.0; 3rd Generation Partnership Project; Technical Specification Group Core Network and Terminals; Non-Access-Stratum (NAS) protocol for 5G System (5GS); Stage 3 (Release 15)

### SUMMARY OF INVENTION

### Technical Problem

In 5GS, in addition to a mechanism that provides a function corresponding to congestion management, control signal management based on causes other than congestion management has been further studied (see NPL 1, NPL 2, and NPL 3).

However, operation processing for session management of a terminal that has received a cause notified to the terminal by the network in order to apply control signal management based on a cause other than congestion management is not clear. In particular, control signal management processing is not clear in a case that a PDU session establishment request for activation of a DN authentication procedure is rejected.

One aspect of the present invention has been made in view of such circumstances, and an object of the present invention is to provide a mechanism and a communication control method for implementing a control signal management process based on a cause other than congestion management.

### Solution to Problem

A User Equipment (UE, terminal apparatus) according to one aspect of the present invention includes a transmitter, wherein a first PDU session establishment request message is a PDU session establishment request message using a first user identity and a first DNN, and, in a case that a cause value indicating a reject cause value indicating user authentication or authorization failed is received in response to the first PDU session establishment request message, the transmitter does not transmit a second PDU session establishment request message using a user identity for the first DNN until a change to a user identity different from the first user identity is made, or until a terminal is powered on/off or a Universal Subscriber Identity Module (USIM) is ejected and/or inserted.

The UE according to one aspect of the present invention includes a transmitter, wherein a first PDU session establishment request is a PDU session establishment request using a first user identity, a first DNN, and a first S-NSSAI, and, in a case that a cause value indicating a reject cause value indicating user authentication or authorization failed is received in response to the first PDU session establishment request, the transmitter does not perform a second PDU session establishment request using a user identity for the first DNN and the first S-NSSAI until a change to a user identity different from the first user identity is made, or until a terminal is powered on/off or a Universal Subscriber Identity Module (USIM) is ejected and/or inserted.

### Advantageous Effects of Invention

According to one aspect of the present invention, terminal apparatuses constituting 5GS and apparatuses in a core network can perform control management processing other than congestion management related to DN authentication procedures in particular, for each network slice and/or DNN or APN initiated by the terminal apparatuses or initiated by the network.

### BRIEF DESCRIPTION OF DRAWINGS

FIG. 1 is a diagram illustrating an overview of a mobile communication system.

FIG. 2 is a diagram illustrating an example of a configuration and the like of access networks in the mobile communication system.

FIG. 3 is a diagram illustrating an example of a configuration or the like of a core network in the mobile communication system.

FIG. 4 is a diagram illustrating an apparatus configuration of UE.

FIG. 5 is a diagram illustrating an apparatus configuration of eNB/NR node/WAG.

FIG. 6 is a diagram illustrating an apparatus configuration of an AMF.

FIG. 7 is a diagram illustrating an apparatus configuration of an SMF/UPF.

FIG. 8 is a diagram illustrating an initial procedure.

FIG. 9 is a diagram illustrating a registration procedure.

FIG. 10 is a diagram illustrating a PDU session establishment procedure.

FIG. 11 is a diagram illustrating a PDU session establishment authentication and/or authorization procedure.

FIG. 12 is a diagram illustrating an RQoS validation procedure.

### DESCRIPTION OF EMBODIMENTS

A preferred embodiment for carrying out the present invention will be described below with reference to the drawings. Note that, as an example, an embodiment of a mobile communication system to which the present invention is applied will be described in the present embodiment.

### 1. System Overview

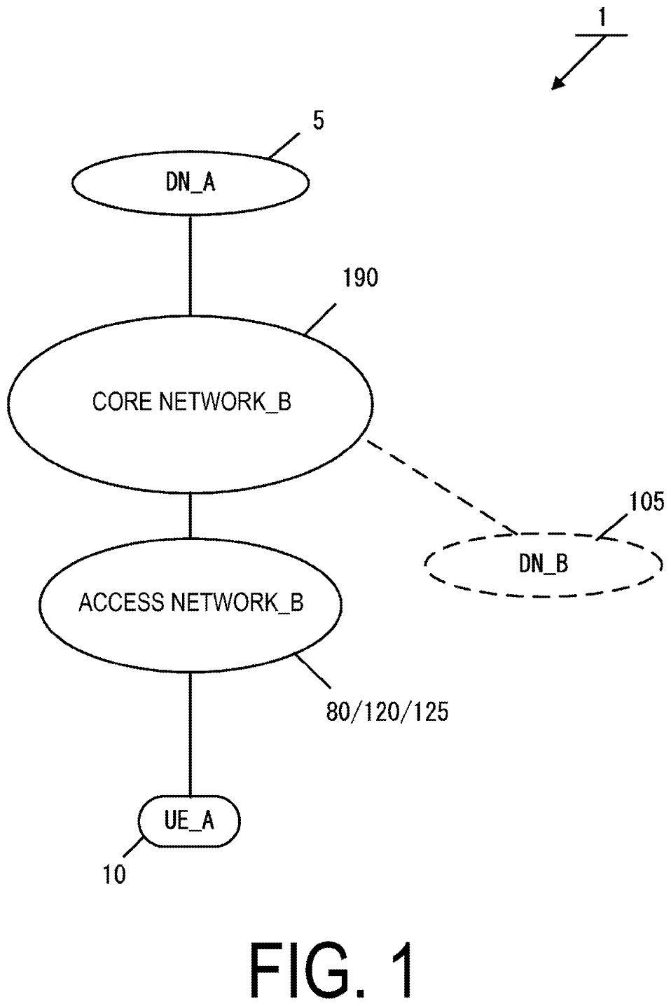

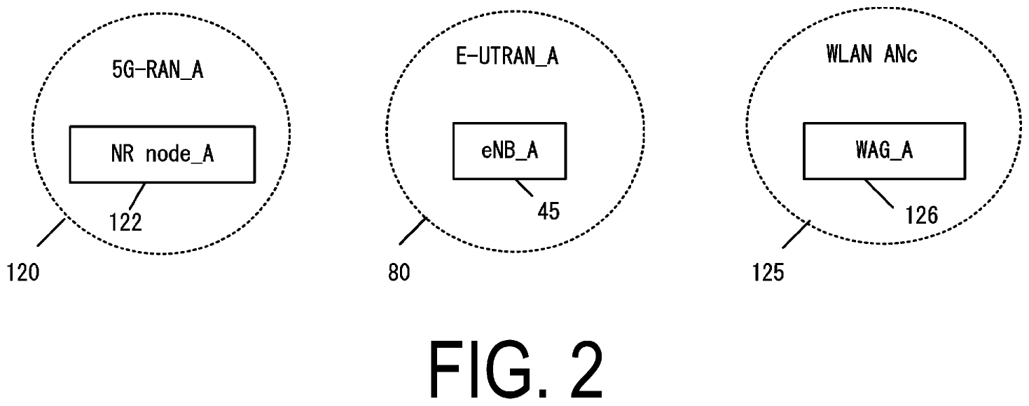

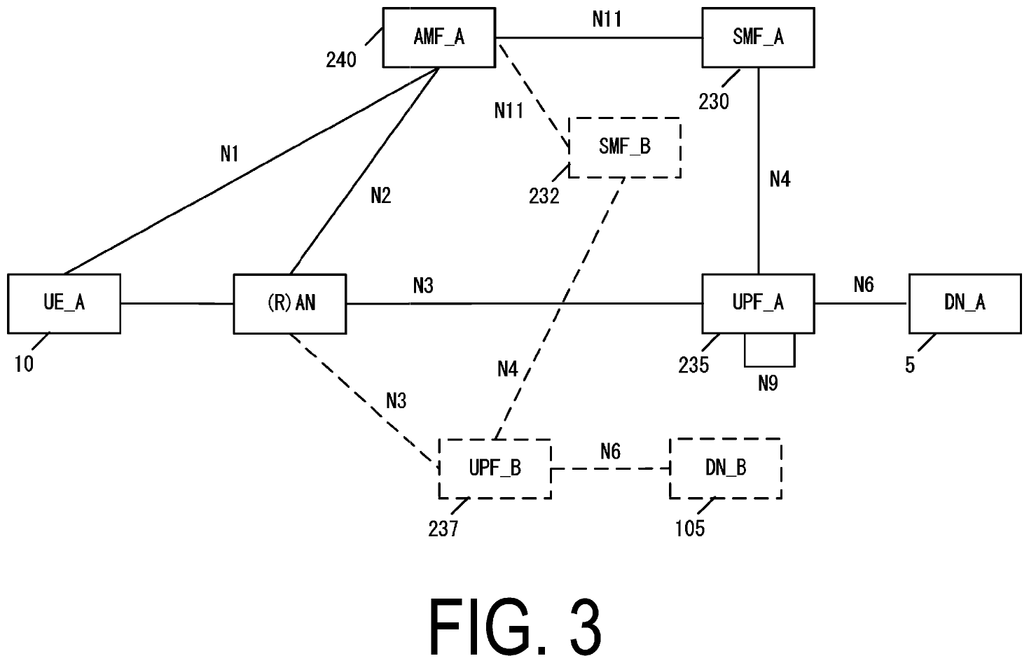

An overview of a mobile communication system according to the present embodiment will be described with reference to FIG. 1, FIG. 2, and FIG. 3. FIG. 2 is a diagram for detailing access networks of the mobile communication system of FIG. 1. FIG. 3 is a diagram mainly illustrating details of a core network in the mobile communication system of FIG. 1. As illustrated in FIG. 1, a mobile communication system 1 (also referred to as a 5GS) according to the present embodiment includes a terminal apparatus (also referred to as a user apparatus and a mobile terminal apparatus), User Equipment (UE)_A 10, an Access Network (AN)_B, a Core Network (CN)_B 190, and a Data Network (DN)_A 5 and a DN_B 105.

Here, the UE_A 10 may be an apparatus that can connect to a network service via 3GPP access (also referred to as 3GPP access or a 3GPP access network) and/or non-3GPP access (also referred to as non-3GPP access or a non-3GPP access network). The UE_A 10 may also include a Universal Integrated Circuit Card (UICC) and an embedded UICC (eUICC). The UE_A 10 may be a wirelessly connectable terminal apparatus and may be Mobile Equipment (ME), a Mobile Station (MS), a cellular Internet of Things (CIoT) terminal (CIoT UE), or the like.

The UE_A 10 can be connected to an access network and/or core network. The UE_A 10 can connect to a DN_A 5 via the access network and/or the core network. The UE_A 10 transmits and/or receives (communicates) user data to and/or from the DN_A 5 by using a Protocol Data Unit or a Packet Data Unit (PDU) session. Furthermore, the communication of the user data is not limited to Internet Protocol (IP) communication, and may be non-IP communication.

Here, IP communication is data communication using IP, and is data communication achieved by transmitting and/or receiving an IP packet including an IP header. Note that a payload section constituting the IP packet may include the user data transmitted and/or received by the UE_A 10. Non-IP communication is data communication without using IP, and is data communication achieved by transmitting and/or receiving data without IP header. For example, the non-IP communication may be the data communication achieved through transmitting and/or receiving application data not given the IP packet, or may transmit and/or receive the user data transmitted and/or received by the UE_A 10 to which another header such as a MAC header and an Ethernet (trade name) frame header is given.

Also, the PDU session is connectivity established between the UE_A 10 and the DN_A 5 and/or the DN_B 105 to provide a PDU connection service. To be more specific, the PDU session may be connectivity established between the UE_A 10 and an external gateway. Here, the external gateway may be a UPF, a Packet Data Network Gateway (PGW), and the like. The PDU session may be a communication path established for transmitting and/or receiving the user data between the UE_A 10 and the core network and/or the DN (DN_A 5 and/or DN_B 105), or may be a communication path for transmitting and/or receiving the PDU. Furthermore, the PDU session may be a session established between the UE_A 10 and the core network and/or the DN (DN_A 5 and/or DN_B 105), or may be a logical communication path including a transfer path such as one or more bearers between the respective apparatuses in the mobile communication system 1. To be more specific, the PDU session may be a connection established by the UE_A 10 between a core network_B 190 and/or the external gateway, or may be a connection established between the UE_A 10 and a UPF (a UPF_A 235 and/or a UPF_B 237). Furthermore, the PDU session may be connectivity and/or a connection between the UE_A 10 and the UPF (the UPF_A 235 and/or the UPF_B 237) via an NR node_A 122. Furthermore, the PDU session may be identified by a PDU session ID and/or an EPS bearer ID.

Note that the UE_A 10 can transmit and/or receive the user data to and/or from an apparatus, such as an application server, that is located in the DN_A 5 and/or the DN_B 105 by using the PDU session. In other words, the PDU session can transfer the user data transmitted and/or received between the UE_A 10 and the apparatus, such as the application server, that is located in the DN_A 5 and/or the DN_B 105. Furthermore, each apparatus (the UE_A 10, the apparatus in the access network, and/or the apparatus in the core network, and/or the apparatus in the data network) may correlate one or more pieces of identification information to the PDU session for management. Note that these pieces of identification information may include at least one of an Access Point Name (APN), a Traffic Flow Template (TFT), a session type, application identification information, identification information of the DN_A 5 and/or the DN_B 105, Network Slice Instance (NSI) identification information, Dedicated Core Network (DCN) identification information, or access network identification information, or may further include another piece of information. Furthermore, in a case that multiple PDU sessions are established, respective pieces of identification information correlated to the PDU sessions may be the same contents or may be different contents. Furthermore, the NSI identification information is information for identifying an NSI, and hereinafter may be an NSI ID or a Slice Instance ID.

As illustrated in FIG. 2, an access network_B may be any of Evolved Universal Terrestrial Radio Access Network (E-UTRAN)_A 80, a 5G-RAN_A 120, and a WLAN ANc 125. Note that an E-UTRAN_A 80 and/or a 5G-RAN_A 120 may be referred to as a 3GPP access network, and the WLAN ANc 125 may be referred to as a non-3GPP access network. Each radio access network includes an apparatus to which the UE_A 10 is actually connected (e.g., a base station apparatus or an access point), and the like.

For example, the E-UTRAN_A 80 is an access network for Long Term Evolution (LTE) and configured to include one or more eNBs_A 45. The eNB_A 45 is a radio base station to which the UE_A 10 connects through Evolved Universal Terrestrial Radio Access (E-UTRA). In a case that multiple eNBs are present in the E-UTRAN_A 80, the multiple eNBs may be connected to each other.

Furthermore, the 5G-RAN_A 120 is a 5G access network, and configured to include one or more New Radio Access Technology nodes (NR nodes)_A 122. The NR node_A 122 is a radio base station to which the UE_A 10 connects with 5G radio access. Also, in a case that multiple NR nodes_A 122 are present in the 5G-RAN_A 120, the respective NR nodes_A 122 may be connected to one another.

Note that the 5G-RAN_A 120 may be an access network configured in the E-UTRA and/or the 5G Radio Access. In other words, the 5G-RAN_A 120 may include the eNB_A 45, may include the NR node_A 122, or may include both. In this case, the eNB_A 45 and the NR node_A 122 may be similar apparatuses. Therefore, the NR node_A 122 can be substituted with the eNB_A 45.

The WLAN ANc 125 is a wireless LAN access network, and includes one or more WLAN Access Gateways (WAGs)_A 126. The WAG_A 126 is a radio base station to which the UE_A 10 connects in wireless LAN access. Furthermore, the WAG_A 126 may be a gateway between the core network_B 190 and the WLAN ANc 125. The WAG_A 126 may be configured such that the function unit of the radio base station and the function unit of the gateway are separate apparatuses.

Note that, in the present specification, the expression “the UE_A 10 is connected to each radio access network” is equivalent to “the UE_A 10 is connected to a base station apparatus, an access point, or the like included in each radio access network,” and is equivalent to “transmitted and/or received data, signals, and the like are also transferred through the base station apparatus and the access point.” Note that control messages transmitted and/or received between the UE_A 10 and the core network_B 190 may be the same control message, regardless of a type of the access network. Therefore, the expression “the UE_A 10 and the core network_B 190 transmit and/or receive a message to and/or from each other via the NR node_A 122” may be equivalent to “the UE_A 10 and the core network_B 190 transmit a message to each other via the eNB_A 45 and/or the WAG_A 126.”

Furthermore, the access network is a radio network connecting with the UE_A 10 and/or the core network. The access network may be a 3GPP access network, or a non-3GPP access network. Note that the 3GPP access network may be the E-UTRAN_A 80 and the 5G-Radio Access Network (RAN)_A 120, and the non-3GPP access network may be the WLAN ANc 125. Note that the UE_A 10 may connect to the access network or to the core network via the access network in order to connect to the core network.

Moreover, the DN_A 5 and the DN_B 105 are Data Networks that provide communication services to the UE_A 10, may be configured as packet data service networks, and may be configured for each service. Furthermore, the DN_A 5 and the DN_B 105 may include a connected communication terminal. Therefore, the connection with the DN_A 5 and/or the DN_B 105 may be a connection with a communication terminal or a server device deployed in the DN_A 5 and/or the DN_B 105. Furthermore, the transmission and/or reception of the user data to and/or from the DN_A 5 and/or the DN_B 105 may be a transmission and/or reception of the user data to and/or from the communication terminal or the server device deployed in the DN_A 5 and/or the DN_B 105. Although the DN_A 5 and/or the DN_B 105 are located outside the core network in FIG. 1, the DN_A 5 and/or the DN_B 105 may be located within the core network.

The core network_B 190 may be configured as one or more apparatuses in a core network. Here, the apparatuses in the core network may be apparatuses that perform part or all of processing or functions of apparatuses included in the core network_B 190. Note that the apparatuses in the core network may be referred to as core network apparatuses.

Furthermore, the core network is an IP mobile communication network, operated by a Mobile Network Operator (MNO), that connects to the access network and/or the DN_A 5. The core network may be a core network for a mobile communication operator that operates and manages the mobile communication system 1, or may be a core network for a virtual mobile communication operator such as a Mobile Virtual Network Operator (MVNO) and a Mobile Virtual Network Enabler (MVNE), or a virtual mobile communication service provider. Note that the core network_B 190 may be an Evolved Packet Core (EPC) constituting an Evolved Packet System (EPS), and may be a 5G Core Network (5GC) constituting a 5GS. Furthermore, the core network_B 190 may be a core network for a system providing the 5G communication service. Note that the core network_B 190 is not limited to the above, and may be a network for providing a mobile communication service.

Next, the core network_B 190 will be described. The core network_B 190 may include at least one of: an Authentication Server Function (AUSF), an Access and Mobility Management Function (AMF)_A 240, a Structured Data Storage network function (SDSF), an Unstructured Data Storage network function (UDSF), a Network Exposure Function (NEF), a NF Repository Function (NRF), a Policy Control Function (PCF), a Session Management Function (SMF)_A 230, a Session Management Function (SMF)_B 232, a Unified Data Management (UDM), a User Plane Function (UPF)_A 235, a User Plane Function (UPF)_B 237, an Application Function (AF), or a Non-3GPP Inter Working Function (N3IWF). Furthermore, these may also be configured as Network Functions (NFs). The NF may be a processing function included in a network.

FIG. 3 illustrates only the AMF (AMF_A 240), the SMF (SMF_A 230 and SMF_B 232), and the UPF (UPF_A 235 and UPF_B 237) among these for simplification, but this does not mean that ones (apparatus and/or NF) other than these are not included. Note that, for simplification, the UE_A 10 is referred to as the UE, the AMF_A 240 as the AMF, the SMF_A 230 and the SMF_B 232 as the SMF, the UPF_A 235 and the UPF_B 237 as the UPF, and the DN_A 5 and DN_B 105 as the DN.

FIG. 3 shows an N1 interface (hereinafter, also referred to as a reference point), an N2 interface, an N3 interface, an N4 interface, an N6 interface, an N9 interface, and an N11 interface. Here, the N1 interface is an interface between the UE and the AMF, the N2 interface is an interface between the (R) access network (AN) and the AMF, and the N3 interface is an interface between the (R) access network (AN) and the UPF, the N4 interface is an interface between the SMF and the UPF, the N6 interface is an interface between the UPF and the DN, the N9 interface is an interface between the UPF and the UPF, and the N11 interface is an interface between the AMF and the SMF. These interfaces can be used to perform communication between the apparatuses.

Note that FIG. 3 is a system configuration diagram in which a UE simultaneously accesses two DNs by using multiple PDU sessions. Two SMFs are selected for two different PDU sessions. Additionally, in FIG. 3, two SMFs_A 230 and two UPFs_A 235 are used.

The following briefly describes each apparatus included in the core network_B 190.

First, the AMF_A 240 is connected to another AMF, SMF (SMF_A 230 and/or SMF_B 232), the access network (i.e., the E-UTRAN_A 80, the 5G-RAN_A 120, and the WLAN ANc 125), the UDM, the AUSF, and the PCF. The AMF_A 240 may play roles of registration management, connection management, reachability management, mobility management of the UE_A 10 or the like, transfer of a Session Management (SM) message between the UE and the SMF, access authentication or access authorization, a Security Anchor Function (SEA), Security Context Management (SCM), support for the N2 interface for the N3IWF, support for transmission and/or reception of NAS signals to and/or from the UE via the N3IWF, authentication of the UE connected via the N3IWF, management of Registration Management (RM) states, management of Connection Management (CM) states, and the like. One or more AMF_A 240s may be deployed within the core network_B 190. The AMF_A 240 may be an NF that manages one or more Network Slice Instances (NSI). The AMF_A 240 may also be a Common Control Plane Network Function (Common CPNF, or CCNF) shared among multiple NSIs.

The RM state includes a deregistered state (RM-DEREGISTERED state) and a registered state (RM-REGISTERED state). In the RM-DEREGISTERED state, the UE is not registered in the network, and thus the AMF is not able to reach the UE because the UE context in the AMF does not have valid location information and routing information for the UE. In the RM-REGISTERED state, the UE is registered in the network, and thus the UE can receive services that requires registration with the network.

The CM state includes a disconnected state (CM-IDLE state) and a connected state (CM-CONNECTED state). In the CM-IDLE state, the UE is in the RM-REGISTERED state but does not have a NAS signaling connection established between the AMF and the UE via the N1 interface. In the CM-IDLE state, the UE does not have an N2 interface connection (N2 connection) and an N3 interface connection (N3 connection). Meanwhile, in the CM-CONNECTED state, the UE has the NAS signaling connection established between the AMF and the UE via the N1 interface. In the CM-CONNECTED state, the UE may have the N2 interface connection (N2 connection) and/or the N3 interface connection (N3 connection).

The SMF_A 230 is connected to the AMF_A 240, the UPF_A 235, the UDM, and the PCF. The SMF_B 232 is connected to the AMF_A 240, the UPF_B 237, the UDM, and the PCF. The SMF_A 230 and the SMF_B 232 may play roles as Session Management of the PDU session or the like, IP address allocation for the UE, UPF selection and control, a UPF configuration for routing a traffic to an appropriate destination, a function notifying an arrival of downlink data (Downlink Data Notification), an identifier of SM information specific to AN (for each AN) transmitted to the AN via the AMF through the N2 interface, determination of a Session and Service Continuity mode (SSC mode) for the session, a roaming function, and the like. The SMF_A 230 and SMF_B 232 have been described as separate apparatuses or NFs, but may be the same apparatus or function.

The UPF_A 235 is connected to the DN_A 5, the SMF_A 230, another UPF, and the access network (i.e., the E-UTRAN_A 80, the 5G-RAN_A 120, and the WLAN ANc 125). The UPF_B 237 is connected to the DN_B 105, the SMF_B 232, another UPF, and the access network (i.e., the E-UTRAN_A 80 and the 5G-RAN_A 120, and the WLAN ANc 125). The UPF_A 235 and UPF_B 237 may play roles of an anchor to intra-RAT mobility or inter-RAT mobility, packet routing & forwarding, an uplink classifier (UL CL) function to support routing of multiple traffic flows for one DN, a branching point function to support a multi-homed PDU session, QoS processing for a user plane, verification of uplink traffic, buffering of downlink packets, a function of triggering downlink data notification, and the like. The UPF_A 235 and the UPF_B 237 may be relay apparatuses that transfer the user data as a gateway between the DN_A 5 and the core network_B 190 and a gateway between the DN_B 105 and the core network_B 190, respectively. Note that the UPF_A 235 and the UPF_B 237 may serve as gateways for IP communication and/or non-IP communication. Furthermore, the UPF_A 235 and the UPF_B 237 may have a function of transferring IP communication or a function to perform conversion between non-IP communication and IP communication. The multiple gateways deployed may serve as gateways for connecting the core network_B 190 with a single DN. Note that the UPF_A 235 and the UPF_B 237 may have connectivity with another NF or may be connected to each apparatus via another NF.

Although the UPF_A 235 and the UPF_B 237 have been described as separate apparatuses or NFs, a common UPF_C 239 (also referred to as a branching point or an uplink classifier), which is a UPF different from the UPF_A 235 and the UPF_B 237, may be present between the UPF_A 235 and the access network and between the UPF_B 237 and the access network. With the UPF_C 239 present, the PDU session between the UE_A 10 and the DN_A 5 is established via the access network, the UPF_C 239, and the UPF_A 235, and the PDU session between the UE_A 10 and the DN_B 105 is established via the access network, the UPF_C 239, and the UPF_B 237.

Note that a User Plane (U-Plane) may be a communication path for transmitting and/or receiving user data, and may include multiple bearers. Furthermore, a Control Plane (C-Plane) may be a communication path for transmitting and/or receiving a control message, and may include multiple bearers.

Additionally, the AUSF is connected to the UDM and the AMF_A 240. The AUSF functions as an authentication server.

The SDSF provides a function for an NEF to store or retrieve information as structured data.

The UDSF provides a function for all NFs to store or retrieve information as unstructured data.

The NEF provides a means to securely provide services and capabilities provided by the 3GPP network. The NEF stores information received from another NF as structured data.

In a case that a NF discovery request is received from a NF instance, the NRF provides the NF with information of found NF instances or holds information of available NF instances or services supported by the instances.

The PCF is connected to the SMF (SMF_A 230, SMF_B 232), the AF, and the AMF_A 240. The PCF provides a policy rule and the like.

The UDM is connected to the AMF_A 240, the SMF (SMF_A 230, SMF_B 232), the AUSF, and the PCF. The UDM includes a UDM FE (application front end) and a User Data Repository (UDR). The UDM FE performs processing of authentication information (credentials), location management, subscriber management (subscription management), and the like. The UDR stores data necessary for the UDM FE for provision and the policy profile necessary for the PCF.

The AF is connected to the PCF. The AF affects traffic routing or is involved in the policy control.

The N3IWF provides functions of establishing an IPsec tunnel with the UE, relaying NAS (N1) signaling between the UE and the AMF, processing N2 signaling transmitted from the SMF and relayed by the AMF, establishing IPsec Security Association (IPsec SA), relaying user plane packets between the UE and the UPF, selecting the AMF, and the like.

### 1.2. Configuration of Each Apparatus

The configuration of each apparatus will be described below. Note that some or all of apparatuses to be described below and functions of units of the apparatuses may operate on physical hardware, or logical hardware which is virtually configured on general-purpose hardware.

### 1.2.1. Configuration of UE

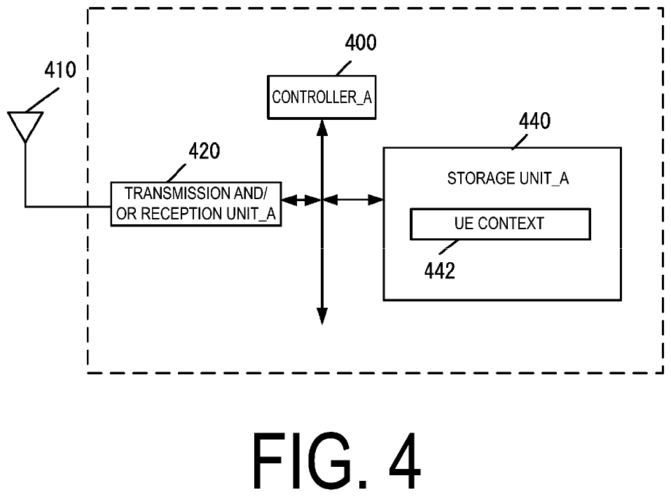

First, an example of an apparatus configuration of the UE_A 10 is illustrated in FIG. 4. As illustrated in FIG. 4, the UE_A 10 includes a controller_A 400, a transmission and/or reception unit_A 420, and a storage unit_A 440. The transmission and/or reception unit_A 420 and the storage unit_A 440 are connected to the controller_A 400 via a bus. An external antenna_A 410 is connected to the transmission and/or reception unit_A 420. The storage unit_A 440 stores a UE context 442.

The controller_A 400 is a function unit for controlling the entire UE_A 10. The controller_A 400 reads out and performs various kinds of information and programs stored in the storage unit_A 440 to achieve various processes of the entire UE_A 10.

The transmission and/or reception unit_A 420 is a function unit through which the UE_A 10 connects to the base station (E-UTRAN_A 80 and 5G-RAN_A 120) and/or the access point (WLAN ANc 125) in the access network and connects to the access network. In other words, the UE_A 10 can connect to the base station and/or the access point in the access network via the external antenna 410 connected to the transmission and/or reception unit_A 420. Specifically, the UE_A 10 can transmit and/or receive the user data and/or the control information with the base station and/or the access point in the access network via the external antenna 410 connected to the transmission and/or reception unit_A 420.

The storage unit_A 440 is a function unit that stores programs, data, and the like necessary for each operation of the UE_A 10, and includes, for example, a semiconductor memory, a Hard Disk Drive (HDD), a Solid State Drive (SSD), or the like. The storage unit_A 440 stores identification information, control information, a flag, a parameter, and the like included in the control message transmitted and/or received in a communication procedure described later. The UE context 442 stored in the storage unit_A 440 may include a UE context used in a case of connecting to the access network_B 80/120/125 and a UE context used in a case of connecting to the core network_B 190. In addition, examples of the UE context 442 may include a UE context stored for each UE, a UE context stored for each PDU session, and a UE context stored for each bearer. The UE context stored for each UE may include IMSI, EMM State, GUTI, and ME Identity. The UE context stored for each PDU session may include an APN in Use, an assigned session type, IP address(es), and a default bearer. The UE context stored for each bearer may include an EPS Bearer ID, a TI, and a TFT.

1.2.2. Configuration of eNB/NR node/WAG

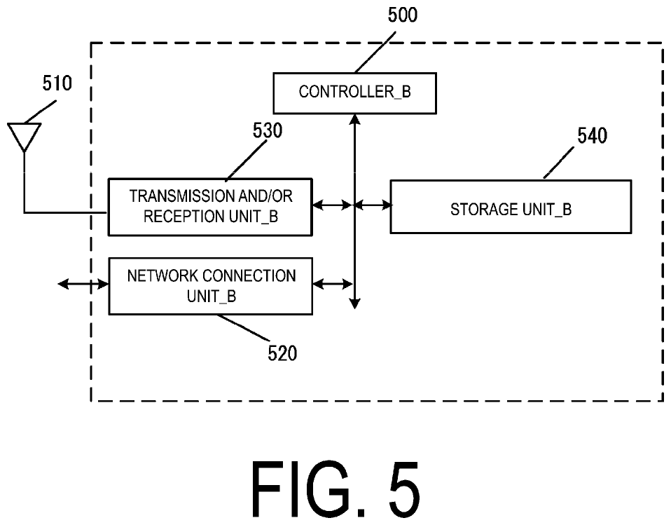

Next, FIG. 5 illustrates an apparatus configuration example of the eNB_A 45, the NR node_A 122, and the WAG_A 126. As illustrated in FIG. 5, the eNB_A 45, the NR node_A 122, and the WAG_A 126 include a controller_B 500, a network connection unit_B 520, a transmission and/or reception unit_B 530, and a storage unit_B 540. The network connection unit_B 520, the transmission and/or reception unit_B 530, and the storage unit_B 540 are connected to the controller_B 500 via a bus. An external antenna 510 is connected to the transmission and/or reception unit_B 530.

The controller_B 500 is a function unit for controlling the entire eNB_A 45, NR node_A 122, and WAG_A 126. The controller_B 500 reads out and performs various kinds of information and programs stored in the storage unit_B 540 to achieve various processes of the entire eNB_A 45, NR node_A 122, and WAG_A 126.

The network connection unit_B 520 is a function unit for the eNB_A 45, the NR node_A 122, and the WAG_A 126 to connect to the AMF_A 240 and the UPF_A 235 in the core network. In other words, the eNB_A 45, the NR node_A 122, and the WAG_A 126 are connectable to the AMF_A 240 and the UPF_A 235 in the core network via the network connection unit_B 520. Specifically, the eNB_A 45, the NR node_A 122, and the WAG_A 126 can transmit and/or receive the user data and/or the control information to and from the AMF_A 240 and/or the UPF_A 235 via the network connection unit_B 520.

The transmission and/or reception unit_B 530 is a function unit through which the eNB_A 45, the NR node_A 122, and the WAG_A 126 connect to the UE_A 10. In other words, the eNB_A 45, the NR node_A 122, and the WAG_A 126 can transmit and/or receive the user data and/or the control information to and from the UE_A 10 via the transmission and/or reception unit_B 530.

The storage unit_B 540 is a function unit for storing programs, data, and the like necessary for each operation by the eNB_A 45, the NR node_A 122, and the WAG_A 126. The storage unit_B 540 includes, for example, a semiconductor memory, an HDD, an SSD, or the like. The storage unit_B 540 stores identification information, control information, a flag, a parameter, and the like included in the control message transmitted and/or received in a communication procedure described later. The storage unit_B 540 may store these pieces of information as the contexts for each UE_A 10.

### 1.2.3. Configuration of AMF

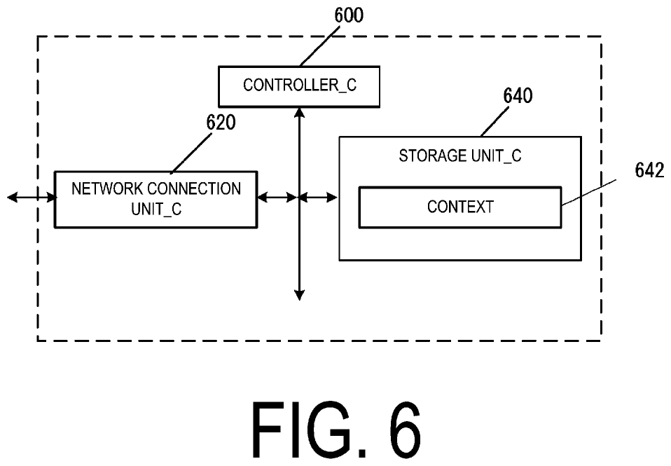

Next, FIG. 6 illustrates an apparatus configuration example of the AMF_A 240. As illustrated in FIG. 6, the AMF_A 240 includes a controller_C 600, a network connection unit_C 620, and a storage unit_C 640. The network connection unit_C 620 and the storage unit_C 640 are connected to the controller_C 600 via a bus. The storage unit_C 640 stores a context 642.

The controller_C 600 is a function unit for controlling the entire AMF_A 240. The controller_C 600 reads out and performs various kinds of information and programs stored in the storage unit_C 640 to achieve various processes of the entire AMF_A 240.

The network connection unit_C 620 is a function unit for the AMF_A 240 to connect to another AMF_240, the SMF_A 230, the base station (E-UTRAN_A 80 and 5G-RAN_A 120), and/or the access point (WLAN ANc 125) in the access network, the UDM, the AUSF, and the PCF. In other words, the AMF_A 240 can transmit and/or receive the user data and/or the control information to and/or from the base station and/or the access point in the access network, the UDM, the AUSF, and the PCF via the network connection unit_C 620.

The storage unit_C 640 is a function unit that stores programs, data, and the like necessary for each operation by the AMF_A 240. The storage unit_C 640 includes, for example, a semiconductor memory, an HDD, an SSD, or the like. The storage unit_C 640 stores identification information, control information, a flag, a parameter, and the like included in a control message which is transmitted and/or received in the communication procedure described below. The context 642 stored in the storage unit_C 640 may be a context stored for each UE, a context stored for each PDU session, and a context stored for each bearer. The context stored for each UE may include an IMSI, an MSISDN, MM State, a GUTI, a ME Identity, a UE radio access capability, a UE network capability, an MS network capability, an access restriction, an MME F-TEID, an SGW F-TEID, an eNB address, an MME UE SlAP ID, an eNB UE SlAP ID, an NR node address, an NR node ID, a WAG address, and a WAG ID. The context stored for each PDU session may include an APN in Use, an assigned session type, IP address(es), a PGW F-TEID, an SCEF ID, and a default bearer. The context stored for each bearer may include an EPS bearer ID, a TI, a TFT, an SGW F-TEID, a PGW F-TEID, an MME F-TEID, an eNB address, an NR node address, a WAG address, an eNB ID, an NR node ID, and a WAG ID.

### 1.2.4. Configuration of SMF

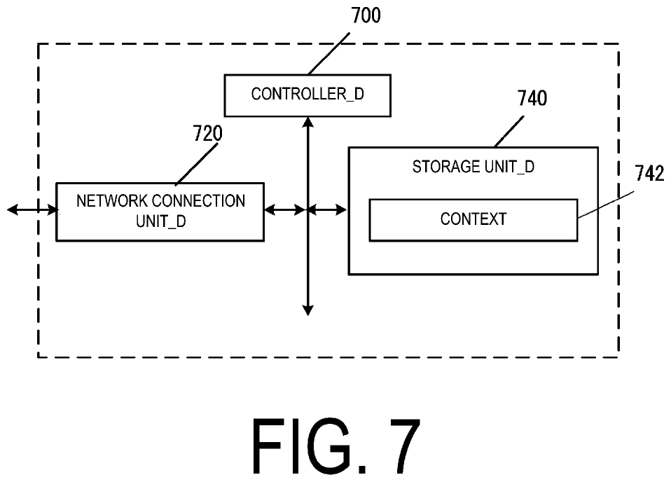

Next, FIG. 7 illustrates an example of an apparatus configuration of the SMF_A 230 and the SMF_B 232. As illustrated in FIG. 7, each of the SMFs_A 230 includes a controller_D 700, a network connection unit_D 720, and a storage unit_D 740. The network connection unit_D 720 and the storage unit_D 740 are connected to the controller_D 700 via a bus. The storage unit_D 740 stores the context 742.

The controller_D 700 in the SMF_A 230 is a function unit for controlling the entire SMF_A 230. The controller_D 700 reads out and performs various pieces of information and programs stored in the storage unit_D 740 to achieve various processes of the entire SMF_A 230.

The network connection unit_D 720 in the SMF_A 230 is a function unit for the SMF_A 230 to connect to the AMF_A 240, the UPF_A 235, the UDM, and the PCF. In other words, the SMF_A 230 can transmit and/or receive the user data and/or the control information to and from the AMF_A 240, the UPF_A 235, the UDM, and the PCF via the network connection unit_D 720.

The storage unit_D 740 in the SMF_A 230 is a function unit for storing programs, data, and the like necessary for each operation by the SMF_A 230. The storage unit_D 740 in the SMF_A 230 includes, for example, a semiconductor memory, an HDD, an SSD, or the like. The storage unit_D 740 in the SMF_A 230 stores identification information, control information, a flag, a parameter, and the like included in the control message transmitted and/or received in a communication procedure described later. The context 742 stored in the storage unit_D 740 in the SMF_A 230 may be a context stored for each UE, a context stored for each APN, a context stored for each PDU session, and a context stored for each bearer. The context stored for each UE may include an IMSI, an ME Identity, an MSISDN, and a RAT type. The context stored for each APN may include an APN in use. Note that the context stored for each APN may be stored for each data network identifier. The context stored for each PDU session may include Assigned Session Type, IP Address(es), SGW F-TEID, PGW F-TEID, and Default Bearer. The context stored for each bearer may include an EPS bearer ID, a TFT, an SGW F-TEID, and a PGW F-TEID.

Note that the SMF_B 232 is configured similarly to the SMA_A 230.

### 1.2.5. Configuration of UPF

Next, an example of an apparatus configuration of the UPF_A 235 and the UPF_B 237 is illustrated in FIG. 7. As illustrated in FIG. 7, each of the UPF_A 235 includes the controller_D 700, the network connection unit_D 720, and the storage unit_D 740. The network connection unit_D 720 and the storage unit_D 740 are connected to the controller_D 700 via a bus. The storage unit_D 740 stores the context 742.

The controller_D 700 in the UPF_A 235 is a function unit for controlling the entire UPF_A 235. The controller_D 700 reads out and performs various pieces of information and programs stored in the storage unit_D 740 to achieve various processes of the entire UPF_A 235.

The network connection unit_D 720 in the UPF_A 235 is a function unit for the UPF_A 235 to connect to the DN (that is, the DN_A 5 and/or the DN_B 105), the SMF_A 230, another UPF_A 235, and the access network (that is, the E-UTRAN_A 80, the 5G-RAN_A 120, and the WLAN ANc 125). In other words, the UPF_A 235 can transmit and/or receive the user data and/or the control information to and from the DN (that is, the DN_A 5 and/or the DN_B 105), the SMF_A 230, another UPF_A 235, and the access network (that is, the E-UTRAN_A 80, 5G-RAN_A 120, and the WLAN ANc 125) via the network connection unit_D 720.

The storage unit_D 740 in the UPF_A 235 is a function unit for storing programs, data, and the like necessary for each operation by the UPF_A 235. The storage unit_D 740 in the UPF_A 235 includes, for example, a semiconductor memory, an HDD, an SSD, or the like. The storage unit_D 740 in the UPF_A 235 stores identification information, control information, a flag, a parameter, and the like included in the control message transmitted and/or received in a communication procedure described later. The context 742 stored in the storage unit_D 740 in the UPF_A 235 may be a context stored for each UE, a context stored for each APN, a context stored for each PDU session, and a context stored for each bearer. The context stored for each UE may include an IMSI, an ME Identity, an MSISDN, and a RAT type. The context stored for each APN may include an APN in use. Note that the context stored for each APN may be stored for each data network identifier. The context stored for each PDU session may include Assigned Session Type, IP Address(es), SGW F-TEID, PGW F-TEID, and Default Bearer. The context stored for each bearer may include an EPS bearer ID, a TFT, an SGW F-TEID, and a PGW F-TEID.

Note that the UPF_B 237 is configured similarly to the UPF_A 235.

### 1.2.6. Information Stored in Storage Unit of Each Apparatus

Next, each piece of information stored in the storage unit of each of the above-described apparatuses will be described.

An International Mobile Subscriber Identity (IMSI) is permanent identification information of a subscriber (user), and is identification information assigned to a user using the UE. The IMSI stored by the UE_A 10, the MME_A 40/CPF_A 140/AMF_A 2400, and the SGW_A 35 may be the same as the IMSI stored by an HSS_A 50.

The EMM State/MM State indicates a mobility management state of the UE_A 10 or the MME_A 40/CPF_A 140/AMF_A 240. For example, the EMM State/MM State may be an EMM-REGISTERED state (registered state) in which the UE_A 10 is registered in the network, and/or an EMM-DEREGISTERD state (deregistered state) in which the UE_A 10 is not registered in the network. The EMM State/MM State may be an ECM-CONNECTED state in which a connection is maintained between the UE_A 10 and the core network, and/or an ECM-IDLE state in which the connection is released. Note that the EMM State/MM State may be information for distinguishing a state in which the UE_A 10 is registered in the EPC from a state in which the UE_A 10 is registered in the NGC or 5GC.

The Globally Unique Temporary Identity (GUTI) is temporary identification information of the UE_A 10. The GUTI includes identification information (Globally Unique MME Identifier (GUMMEI)) of the MME_A 40/CPF_A 140/AMF_A 240 and identification information (M-Temporary Mobile Subscriber Identity (M-TMSI)) of the UE_A 10 in a specific MME_A 40/CPF_A 140/AMF_A 240. The ME Identity is an ID of the UE_A 10 or the ME, and may be International Mobile Equipment Identity (IMEI) or IMEI Software Version (IMEISV), for example. The MSISDN represents a basic phone number of the UE_A 10. The MSISDN stored by the MME_A 40/CPF_A 140/AMF_A 240 may be information indicated by the storage unit of the HSS_A 50. Note that the GUTI may include information for identifying the CPF_140.

The MME F-TEID is information for identifying the MME_A 40/CPF_A 140/AMF_A 240. The MME F-TEID may include an IP address of the MME_A 40/CPF_A 140/AMF_A 240, a Tunnel Endpoint Identifier (TEID) of the MME_A 40/CPF_A 140/AMF_A 240, or both of them. The IP address of the MME_A 40/CPF_A 140/AMF_A 240 and the TEID of the MME_A 40/CPF_A 140/AMF_A 240 may be stored independently of each other. The MME F-TEID may be identification information for user data, or identification information for control information.

The SGW F-TEID is information for identifying the SGW_A 35. The SGW F-TEID may include an IP address of the SGW_A 35, a TEID of the SGW_A 35, or both of them. The IP address of the SGW_A 35 and the TEID of the SGW_A 35 may be stored independently of each other. The SGW F-TEID may be identification information for user data, or identification information for control information.

The PGW F-TEID is information for identifying the PGW_A 30/UPGW_A 130/SMF_A 230/UPF_A 235. The PGW F-TEID may include an IP address of the PGW_A 30/UPGW_A 130/SMF_A 230/UPF_A 235, a TEID of the PGW_A 30/UPGW_A 130/SMF_A 230/UPF_A 235, or both of them. The IP address of the PGW_A 30/UPGW_A 130/SMF_A 230/UPF_A 235 and the TEID of the PGW_A 30/UPGW_A 130/SMF_A 230/UPF_A 235 may be stored independently of each other. The PGW F-TEID may be identification information for user data, or identification information for control information.

The eNB F-TEID is information for identifying the eNB_A 45. The eNB F-TEID may include an IP address of the eNB_A 45, a TEID of the eNB_A 45, or both of them. The IP address of the eNB_A 45 and the TEID of the SGW_A 35 may be stored independently of each other. The eNB F-TEID may be identification information for user data, or identification information for control information.

The APN may be identification information for identifying the core network and an external network such as the DN. Furthermore, the APN can also be used as information for selecting a gateway such as the PGW_A 30/UPGW_A 130/UPF_A 235 for connecting the core network A_90. Note that the APN may be a Data Network Name (DNN). Therefore, the APN may be represented by a DNN, or the DNN may be represented by the APN.

Note that the APN may be identification information for identifying such a gateway, or identification information for identifying an external network such as the DN. Note that, in a case that multiple gateways connecting the core network and the DN are deployed, there may be multiple gateways that can be selected according to the APN. Furthermore, one gateway may be selected among such multiple gateways by another method using identification information other than the APN.

The UE Radio Access Capability is identification information indicating a radio access capability of the UE_A 10. The UE Network Capability includes an algorithm of security supported by the UE_A 10 and a key derivation function. The MS Network Capability is information including, in the UE_A 10 having a function of a GERAN_A 25 and/or a UTRAN_A 20, one or more pieces of information necessary for an SGSN_A 42. The Access Restriction is registration information for access restriction. The eNB Address is an IP address of the eNB_A 45. The MME UE SlAP ID is information for identifying the UE_A 10 in the MME_A 40/CPF_A 140/AMF_A 240. The eNB UE SlAP ID is information for identifying the UE_A 10 in the eNB_A 45.

The APN in Use is an APN recently used. The APN in Use may be Data Network Identifier. This APN may include identification information of the network and identification information of a default operator. Furthermore, the APN in Use may be information for identifying a DN with which the PDU session is established.

The Assigned Session Type is information indicating a PDU session type. The Assigned Session Type may be Assigned PDN Type. The PDU session type may be IP, or non-IP.

Furthermore, in a case that the PDU session type is IP, information indicating a PDN type assigned by the network may be further included. Note that the Assigned Session Type may be IPv4, IPv6, or IPv4v6.

Unless otherwise specifically described, the IP Address refers to the IP address assigned to the UE. The IP address may be an IPv4 address, an IPv6 address, an IPv6 prefix, or the interface ID. Note that in a case that the Assigned Session Type indicates non-IP, an element of the IP Address may not be included.

The DN ID is identification information for identifying the core network_B 190 and an external network such as the DN. Furthermore, the DN ID can also be used as information for selecting a gateway such as the UPGW_A 130 or the PF_A 235 connecting the core network_B 190.

Note that the DN ID may be identification information for identifying such a gateway, or identification information for identifying an external network such as the DN. Note that, in a case that multiple gateways connecting the core network_B 190 and the DN are deployed, there may be multiple gateways that can be selected according to the DN ID. Furthermore, one gateway may be selected among such multiple gateways by another method using identification information other than the DN ID.

Furthermore, the DN ID may be information equivalent to the APN, or different from the APN. Note that in a case that the DN ID is the information different from the APN, each apparatus may manage information indicating correspondence between the DN ID and the APN, perform a procedure to inquire the APN by using the DN ID, or perform a procedure to inquire the DN ID by using the APN.

SCEF ID is an IP address of an SCEF_A 46 used in the PDU session. The Default Bearer is information acquired and/or created in a case that a PDU session is established and is EPS bearer identification information for identifying a default bearer associated with the PDU session.

The EPS Bearer ID is identification information of the EPS bearer. The EPS Bearer ID may be identification information for identifying Signalling Radio Bearer (SRB) and/or Control-plane Radio bearer (CRB), or identification information for identifying Data Radio Bearer (DRB). The Transaction Identifier (TI) is identification information for identifying a bidirectional message flow (Transaction). Note that the EPS Bearer ID may be EPS bearer identification information for identifying a dedicated bearer. Therefore, the EPS bearer ID may be identification information for identifying the EPS bearer different from the default bearer. The TFT indicates all packet filters associated with the EPS bearer. The TFT is information for identifying some pieces of user data to be transmitted and/or received, and thus, the UE_A 10 uses the EPS bearer associated with the TFT to transmit and/or receive the user data identified by the TFT. In still other words, the UE_A 10 uses a Radio Bearer (RB) associated with the TFT to transmit and/or receive the user data identified by the TFT. The TFT may associate the user data such as application data to be transmitted and/or received with an appropriate transfer path, and may be identification information for identifying the application data. The UE_A 10 may use the default bearer to transmit and/or receive the user data which cannot be identified by the TFT. The UE_A 10 may store in advance the TFT associated with the default bearer.

The Default Bearer is EPS bearer identification information for identifying a default bearer associated with a PDU session. Note that the EPS bearer may be a logical communication path established between the UE_A 10 and the PGW_A 30/UPGW_A 130/UPF_A 235, or a communication path constituting the PDN connection/PDU session. Furthermore, the EPS bearer may be a default bearer, or a dedicated bearer. Furthermore, the EPS bearer may include an RB established between the UE_A 10 and the base station and/or the access point in the access network. Furthermore, the RB and the EPS bearer may be associated with each other on a one-to-one basis. Therefore, identification information of the RB may be associated with the identification information of the EPS bearer on a one-to-one basis, or may be the same identification information as the identification information of the EPS bearer. Note that the RB may be an SRB and/or a CRB, or a DRB. The Default Bearer may be information that the UE_A 10 and/or the SGW_A 35 and/or the PGW_A 30/UPGW_A 130/SMF_A 230/UPF_A 235 acquire from the core network in a case that the PDU session is established. Note that the default bearer is an EPS bearer first established during the PDN connection/PDU session, and is such an EPS bearer that only one bearer can be established during one PDN connection/PDU session. The default bearer may be an EPS bearer that can be used for communication of user data not associated with the TFT. The dedicated bearer is an EPS bearer established after the default bearer is established during the PDN connection/PDU session, and is such an EPS bearer that multiple bearers can be established during one PDN connection/PDU session. The dedicated bearer is an EPS bearer that can be used for communication of user data not associated with the TFT.

User Identity is information for identifying a subscriber. The User Identity may be an IMSI, or an MSISDN. Furthermore, the User Identity may also be identification information other than the IMSI or the MSISDN. Serving Node Information is information for identifying the MME_A 40/CPF_A 140/AMF_A 240 used in a PDU session, and may be an IP address of the MME_A 40/CPF_A 140/AMF_A 240.

The eNB Address is an IP address of the eNB_A 45. The eNB ID is information for identifying the UE in the eNB_A 45. MME Address is an IP address of the MME_A 40/CPF_A 140/AMF_A 240. MME ID is information for identifying the MME_A 40/CPF_A 140/AMF_A 240. The NR node Address is an IP address of the NR node_A 122. The NR node ID is information for identifying the NR node_A 122. The WAG Address is an IP address of the WAG_A 126. The WAG ID is information for identifying the WAG_A 126.

### 1.3. Description of Initial Procedure

Next, before describing detailed processes of an initial procedure in the present embodiment, in order to avoid redundant descriptions, terminology specific to the present embodiment and primary identification information used in each procedure will be described beforehand.

First, the network in the present embodiment refers to at least some of the access network_B 80/120/125, the core network_B 190, the DN_A 5, and the DN_B 105. One or more apparatuses included in at least some of the access network_B 80/120/125, the core network_B 190, the DN_A 5, and the DN_B 105 may also be referred to as a network or a network apparatus. Specifically, the expression “the network performs transmission and/or reception of a message and/or performs a procedure” signifies that “an apparatus (network apparatus) in the network performs transmission and/or reception of a message and/or performs a procedure”.

In the present embodiment, a Session Management (SM) message (also referred to as a Non-Access-Stratum (NAS) SM message) may be a NAS message used in a procedure for the SM, or may be a control message transmitted and/or received between the UE_A 10 and the SMF_A 230 or the SMF_B 232 via the AMF_A 240. Furthermore, the SM message may include a PDU session establishment request message, a PDU session establishment accept message, a PDU session complete message, a PDU session reject message, a PDU session modification request message, a PDU session modification accept message, a PDU session modification reject message, and the like. The procedure for SM may include a PDU session establishment procedure, a PDU session modification procedure, and the like.

In the present embodiment, a Tracking Area (TA) is a range that can be represented by location information of the UE_A 10 managed by the core network, and may include one or more cells, for example. The TA may be a range in which a control message such as a paging message is broadcast, or a range in which the UE_A 10 can move without performing a handover procedure.

In the present embodiment, a TA list is a list including one or more TAs allocated to the UE_A 10 by the network. Note that, while the UE_A 10 is moving within the one or more TAs included in the TA list, the UE_A 10 can move without performing the registration procedure. In other words, the TA list may be an information group indicating an area in which the UE_A 10 can move without performing the registration procedure. S1 In the present embodiment, Reflective Quality of Service (RQoS) is a QoS supported in the 5G Core (5GC). The RQoS is a QoS implemented by the UE_A 10 creating a QoS rule (Derived QoS rule) based on the received downlink packet and/or the downlink traffic. Note that each apparatus may be capable of simultaneously adapting RQoS and QoS that is not RQoS in the identical PDU session. Furthermore, in order to achieve the adaptation of the RQoS to the traffic, the same QoS as the QoS of the paired downlink packet may be adapted to the QoS of the uplink packet.

In the present embodiment, the QoS rule (Derived QoS rule) is a rule for implementing user data communication using the RQoS. The QoS rule may include Packet Filter, and/or QoS Flow Identity (QFI) and/or Precedence value. Here, the QFI may be an identifier for identifying a QoS flow. In addition, the precedence value indicates the priority, and the lower the value is, the higher the priority is. Note that the packet filter of the uplink packet may be generated based on the downlink packet. Furthermore, in a case that the RQoS via the User Plane is validated, the precedence value of the QoS rule may be configured to a standardized value. Further, in a case that the RQoS via the Control Plane is validated, the precedence value of the QoS rule may be configured to a value that is transmitted and/or received in a control messages via the Control Plane. Note that the UE_A 10 may validate the RQoS by creating the QoS rules, or may invalidate the RQoS by deleting the QoS rules.

In the present embodiment, a Reflective QoS (RQoS) Timer is a timer for managing the validation of the RQoS. Each apparatus may validate the RQoS only while the RQoS timer is running. In other words, each apparatus may validate the RQoS, based on the start of the RQoS timer and may invalidate the RQoS, based on the expiration of the RQoS timer. Furthermore, the value of the timer of the RQoS may be a value transmitted to the UE_A 10 from the network in a PDU session establishment procedure or the like, or may be a value configured in advance. Note that an RQ Timer may be used. The RQoS timer may be a timer for managing the validation of the RQoS, and is not limited thereto. The authentication and/or authorization request information in the present embodiment is information that the UE_A 10 requests activation of the DN authentication and/or authorization procedure, which may be a variable indicating whether or not the UE_A 10 wants to activate the DN authentication and/or authorization procedure, may be a name space specifying the service, may be a user identity, or may be an identifier specifying the user's profile. Note that the DN authentication and/or authorization procedure may be a PDU session establishment authentication and/or authorization procedure.

In the present embodiment, the authentication and/or authorization information is information indicating the authentication and/or authorization result in response to the DN authentication and/or authorization procedure from the 3GPP NW, which may be a variable indicating whether or not authentication and/or authorization is performed, or may be a name space specifying the service.

In the present embodiment, the DN authentication and/or authorization response information may be a name space specifying the service which is carried in a case that the UE_A 10 responds on the information responded by the UE_A 10 for the authentication and/or authorization information issued by the DN, or may be a message response to the authentication and/or authorization information from the DN.

In the present embodiment, the user ID is an identifier specifying the user in the DN authentication and/or authorization. The user ID may be information that the UE_A 10 requests the activation of the DN authentication and/or authorization procedure.

In the present embodiment, the user profile ID is an identifier specifying the user's profile in the DN authentication and/or authorization. The user profile ID may be information that the UE_A 10 requests the activation of the DN authentication and/or authorization procedure.

In the present embodiment, the DN authentication and/or authorization is a next-generation security system for a 5G mobile communication system that is a next generation mobile communication system. The DN authentication and/or authorization is a mechanism that allows authentication and/or authorization by DN during the PDU session establishment procedure, and may be a system that does not exist in conventional 4G systems. Furthermore, in the next-generation security system, authentication and authorization may be separated in relation to DN authentication and/or authorization. Further, separating authentication and authorization may allow for performing authentication and/or authorization in each responsibility of owners of authentication resources and authorization resources and may allow for flexible service deployment using mobile communication systems. T3 The first timer in the present embodiment is a timer for managing initiation of a procedure for session management, such as a PDU session establishment procedure, and/or transmission of a Session Management (SM) message such as a PDU session establishment request message. While the first timer is running, the initiation of the procedure for session management and/or the transmission and/or reception of the SM message for each apparatus may be prohibited. Note that the first timer may be configured at least in either the APN/DNN or slice units. Note that the SM message may be a NAS message used in a procedure for the session management, or may be a control message transmitted and/or received between the UE_A 10 and the SMF_A 230 via the AMF_A 240. Furthermore, the SM message may include a PDU session establishment request message, a PDU session establishment accept message, a PDU session complete message, a PDU session reject message, a PDU session modification request message, a PDU session modification accept message, a PDU session modification reject message, and the like. Furthermore, the procedure for the session management may include a PDU session establishment procedure, a PDU session modification procedure, and the like.

In the present embodiment, a Network Slice is a logical network that provides specific network capabilities and network performance. Hereinafter, the network slice may be also referred to as a NW slice.

In the present embodiment, a Network Slice Instance (NSI) is configured with an instance (entity) of a network function (NF) and a set of required resources and forms a network slice to be allocated. Here, the NF is a processing function in a network, which is adopted or defined in 3GPP. The NSI is an entity of each of one or more Network Slices configured in the core network_B 190. The NSI may include a virtual Network Function (NF) generated using a Network Slice Template (NST). Here, the NST is associated with a resource request for providing a required communication service or capability, and is a logical expression of one or more Network Functions (NFs). Specifically, the NSI may be an aggregation including multiple NFs in the core network_B 190. The NSI may be a logical network configured to classify the user data delivered through a service or the like. The network slice may include one or more NFs. The NF included in the network slice may be an apparatus shared by another network slice or otherwise. The UE_A 10 can be assigned to the one or more network slices, based on a UE usage type and/or one or more network slice type IDs and/or one or more pieces of registration information such as an NS ID and/or the APN.

The Network Slice Instance (NSI) in the present embodiment is an entity of each of one or multiple Network Slices configured in the core network_B 190. The NSI in the present embodiment may include a virtual Network Function (NF) generated using a Network Slice Template (NST). Here, the NST is associated with a resource request for providing a required communication service or capability, and is a logical expression of one or multiple Network Functions (NFs). Specifically, the NSI may be an aggregation including multiple NFs in the core network_B 190. The NSI may be a logical network configured to classify the user data delivered through a service or the like. The network slice may include at least one or more NFs. The NF included in the network slice may be an apparatus shared by another network slice or otherwise. The UE_A 10, and/or the apparatus in the network can be assigned to one or multiple network slices, based on NSSAI and/or S-NSSAI and/or UE usage type and/or one or multiple network slice type IDs and/or registration information such as one or multiple NS IDs and/or the APN.

The S-NSSAI in the present embodiment is an abbreviation for Single Network Slice Selection Assistance information, and is information for identifying a network slice. The S-NSSAI may include Slice/Service type (SST) and Slice Differentiator (SD). The S-NSSAI may be configured with only the SST, or may be configured with both the SST and the SD. Here, the SST is information indicating the operation of network slices expected in terms of function and service. The SD may be information that complements the SST in a case of selecting one NSI from multiple NSIs indicated by the SST. The S-NSSAI may be unique information for each PLMN, or may be standard information shared between PLMNs. The network may store one or multiple pieces of S-NSSAI in the registration information of the UE_A 10 as the default S-NSSAI.

The Single Network Slice Selection Assistance information (NSSAI) in the present embodiment is a group of pieces of S-NSSAI. Each S-NSSAI included in the NSSAI is information that assists the access network or the core network to select an NSI. The UE_A 10 may store the NSSAI allowed from the network for each PLMN. The NSSAI may be information used to select the AMF_A 240.

The first NW slice in the present embodiment is a NW slice to which the established PDU session belongs in a case that the UE_A 10 connects to a specific DN. The first NW slice may be a NW slice managed in the operator A network, or a NW slice that is commonly managed in the operator B network.

The second NW slice in the present embodiment is a NW slice to which another PDU session capable of connecting to the DN belongs, which is the connection destination of the PDU session belonging to the first NW slice. The first NW slice and the second NW slice can be operated by the same operator or may be operated by different operators.

The operator A network according to the present embodiment is a network operated by an operator A. The operator A may deploy a NW slice common to an operator B.

The operator B network according to the present embodiment is a network operated by an operator B. The operator B may deploy a NW slice common to the operator A.

The re-attempt information in the present embodiment is information for the NW to indicate to the UE_A 10 whether or not to allow reconnection using the identical identification information for the rejected PDU session. Note that the re-attempt information may be configured for each UTRAN access, E-UTRAN access, and NR access.

The first behavior in the present embodiment is a behavior in which the UE_A 10 stores slice information transmitted in the PDU session establishment request message in association with the transmitted PDU session identifier. In the first behavior, the UE_A 10 may store slice information transmitted in the PDU session establishment request message or may store slice information received in a case that the PDU session establishment request message is rejected.

The second behavior in the present embodiment is a behavior in which the UE_A 10 transmits a PDU session establishment request message to connect to the identical APN/DNN as the APN/DNN specified in the PDU session establishment request message transmitted before by using slice information different from the slice information specified in the PDU session establishment request message before. Specifically, the second behavior may be a behavior in which the UE_A 10 transmits a PDU session establishment request message to connect to the identical APN/DNN as the PDU session establishment request message before by using slice information different from the slice information specified in the PDU session establishment request message transmitted before in a case that the backoff timer value received from the network is zero or invalidated. Alternatively, the second behavior may be a behavior in which, in a case that the PDU session establishment request message transmitted before is rejected because the specified APN/DNN is not supported in the wireless of the specific connecting PLMN, or in a case that the PDU session establishment request message transmitted before is rejected for a temporary cause, the UE_A 10 may transmit a PDU session establishment request message to connect to the identical APN/DNN as the APN/DNN specified in the PDU session establishment request message before by using slice information different from the slice information specified in the PDU session establishment request message.

The third behavior in the present embodiment is a behavior in which the UE_A 10 does not transmit a new PDU session establishment request message with the identical identification information until the first timer expires in a case that the PDU session establishment request message is rejected. Specifically, the third behavior may be a behavior in which the UE_A 10 does not transmit a new PDU session establishment request message with the identical identification information until the first timer expires in a case that the backoff timer value received from the network is not zero nor invalidated. Alternatively, the third behavior may be a behavior in which, in a case that another PLMN is selected, or in a case that another NW slice is selected, and in a case that a reject cause for a configuration failure of network operation is received, the UE_A 10 does not transmit a new PDU session establishment request message with the identical identification information until the first timer expires in a case that the backoff timer received in a case that the PDU session establishment request message is rejected has been activated.

The fourth behavior in the present embodiment is a behavior in which the UE_A 10 does not transmit a new PDU session establishment request message that does not carry slice information and/or DNN/APN information until the first timer expires in a case that the PDU session establishment request message transmitted by being carried on the Registration procedure is rejected. Specifically, the fourth behavior may be a behavior in which the UE_A 10 does not transmit a new PDU session establishment request message that does not carry slice information and/or DNN/APN information until the first timer expires in a case that the backoff timer received from the network is not zero nor invalidated.

The fifth behavior in the present embodiment is a behavior in which the UE_A 10 does not transmit a new PDU session establishment request message with the identical identification information in a case that the PDU session establishment request message is rejected. Specifically, the fifth behavior may be a behavior in which the UE_A 10 does not transmit a new PDU session establishment request message with the identical identification information in a case that the PDU types supported by the UE_A 10 and the network are different and in a case that the UE_A 10 is in the equivalent PLMN.

The sixth behavior in the present embodiment is a behavior in which the UE_A 10 transmits a new PDU session establishment request message as an initial procedure with the identical identification information in a case that the PDU session establishment request message is rejected. Specifically, the sixth behavior may be a behavior in which, in a case that the PDU session establishment request message is rejected because the PDN session context of interest is not present in the handover from non 3GPP, the UE_A 10 transmits a new PDU session establishment request message as an initial procedure with the identical identification information.

The seventh behavior in the present embodiment is a behavior in which the UE_A 10 continues the received backoff timer in a case that the previous PDU session establishment request message is rejected in a case that the UE_A 10 selects another NW slice in the PLMN selection procedure. Specifically, the seventh behavior may be a behavior in which, in a case that the UE_A 10 selects a PLMN in a case that the PDU session establishment request message is rejected, and in a case that it is possible to specify a common NW slice with the NW slice specified in the PDU session establishment request message in the PLMN of the selection destination, the UE_A 10 continues the backoff timer received in a case that the PDU session establishment request message is rejected.

The eighth behavior in the present embodiment is a behavior in which the UE_A 10 configures the first timer value to a value notified from the network or configures to a value configured to the UE_A 10 in advance. Specifically, the eighth behavior may be a behavior in which the UE_A 10 configures the backoff timer value received in the reject notification for the PDU session establishment request message as the first timer value, or may be a behavior in which the UE_A 10 configures a value configured to or held by the UE_A 10 in advance as the first timer value. Note that the eighth behavior in the case that the UE_A 10 configures a timer configured to or held by the UE_A 10 in advance as the first timer value may be limited within the HPLMN or equivalent PLMN.

The ninth behavior in the present embodiment is a behavior in which the UE_A 10 does not transmit a new PDU session establishment request message until terminal power on/off or extraction and/or insertion of USIM in a case that the PDU session establishment request message is rejected. Specifically, the ninth behavior may be a behavior in which, in a case that the backoff timer received from the network is invalidated, or in a case that causes included in the PDU session reject message are different for the PDU types between the UE_A 10 and the NW, the UE_A 10 does not transmit a new PDU session establishment request message until terminal power on/off or extraction and/or insertion of USIM. Alternatively, the ninth behavior may be a behavior in which, in a case that the PDU session establishment request message is rejected because the specified APN/DNN is not supported in the wireless of the connecting PLMN, and in a case that there is no information element of the backoff timer from the network, and there is no Re-attempt information, or in a case that reconnection of a PDU session to the equivalent PLMN is allowed, the UE_A 10 does not transmit a new PDU session establishment request message until terminal power on/off or extraction and/or insertion of USIM in the connecting PLMN. Alternatively, the ninth behavior may be a behavior in which, in a case that the first PDU session establishment request message is rejected because the specified APN/DNN is not supported in the wireless of the connecting PLMN, and in a case that there is no information element of the backoff timer from the network, and there is no Re-attempt information, or in a case that reconnection of a PDU session to the equivalent PLMN is not allowed, the UE_A 10 does not transmit a new PDU session establishment request message until terminal power on/off or extraction and/or insertion of USIM in the connecting PLMN. Alternatively, the ninth behavior may be a behavior in which, in a case that the PDU session establishment request message is rejected because the specified APN/DNN is not supported in the wireless of the connecting PLMN, and in a case that the backoff timer from the network is not zero nor invalidated, the UE_A 10 does not transmit a new PDU session establishment request message until terminal power on/off or extraction and/or insertion of USIM. Alternatively, the ninth behavior may be a behavior in which, in a case that the PDU session establishment request message is rejected because the specified APN/DNN is not supported in the wireless of the connecting PLMN, and in a case that the backoff timer from the network is invalidated, the UE_A 10 does not transmit a new PDU session establishment request message until terminal power on/off or extraction and/or insertion of USIM.

The 10th behavior in the present embodiment is a behavior in which the UE_A 10 transmits a new PDU session establishment request message in a case that the PDU session establishment request message is rejected. Specifically, the 10th behavior may be a behavior in which the UE_A 10 transmits a new PDU session establishment request message in a case that the backoff timer received from the NW is zero, or in a case that the PDU session establishment request message is rejected for temporary causes and there is no backoff timer information element itself to be notified from the network. Alternatively, the 10th behavior may be a behavior in which the UE_A 10 transmits a new PDU session establishment request message, in a case that another PLMN is selected or in a case that another NW slice is selected, and in a case that the PDU session establishment request message is rejected for temporary causes, and in a case that the backoff timer is not activated for the APN/DNN of interest in the selected PLMN, or in a case that the backoff timer received from the network is invalidated. Alternatively, the 10th behavior may be a behavior in which the UE_A 10 transmits a new PDU session establishment request message, in a case that the PDU session establishment request message is rejected because the PDU types of the UE_A 10 and the network are different, and in a case that Re-attempt information is not received or a PLMN that is not in the equivalent PLMN list is selected in a case that selecting a different PLMN, or in a case that the PDP type is changed or in a case of terminal power on/off or extraction and/or insertion of USIM. Alternatively, the 10th behavior may be a behavior in which the UE_A 10 transmits a new PDU session establishment request message, in a case that the first PDU session is rejected because the specified APN/DNN is not supported in the wireless of the connecting PLMN, and in a case that the backoff timer notified from the network is zero.

The 11th behavior in the present embodiment is a behavior in which the UE_A 10 ignores the first timer and the Re-attempt information. Specifically, the 11th behavior may be a behavior in which the UE_A 10 ignores the first timer and the Re-attempt information in a case that the PDU session establishment request message is rejected because there is no PDN session context of interest in the handover from non 3GPP, or in a case that the PDU session establishment request message is rejected because the number of bearers deployed in the PDN connection reaches a maximum number.

In the present embodiment, an equivalent PLMN is a PLMN treated to be the same PLMN as the same HPLMN in the network.

Next, identification information according to the present embodiment will be described. The first identification information in the present embodiment is information indicating whether or not the UE_A 10 supports Reflective Quality of Service (RQoS). The first identification information may indicate whether or not the UE_A 10 supports RQoS to be controlled initiatively by UE and/or whether or not the UE_A 10 supports RQoS to be controlled initiatively by network. Note that the RQoS to be controlled initiatively by UE may be an RQoS validated in the UE initiated RQoS validation procedure, or may be an RQoS that is invalidated in the first RQoS deactivation procedure. Furthermore, the RQoS to be controlled initiatively by network may be an RQoS validated in the network initiated RQoS validation procedure, or may be an RQoS that is invalidated in the second RQoS deactivation procedure. The first identification information may correspond to the fourth identification information or the fifth identification information. In other words, the first identification information may refer to information indicating whether or not the UE_A 10 supports the RQoS for the user data communication with the DN identified by the fourth identification information or for the PDU session identified by the fifth identification information. The first identification information may be information that includes the meanings of the second identification information and/or the third identification information. In other words, the first identification information may refer to information indicating whether or not the UE_A 10 supports the RQoS controlled via the Control Plane and/or the User Plane. Note that the RQoS controlled via the Control Plane may be an RQoS validated and/or invalidated via the Control Plane, and the RQoS controlled via the User Plane may be an RQoS validated and/or invalidated via the User Plane. The first identification information may be information that includes the meaning of the sixth identification information. In other words, the first identification information may be information indicating whether the UE_A 10 supports the RQoS, and that the UE_A 10 requests the RQoS.

The second identification information in the present embodiment is information indicating whether or not the UE_A 10 supports the RQoS controlled via the Control Plane. The second identification information may indicate whether or not the UE_A 10 supports the RQoS controlled via the Control Plane initiated by the UE, and/or whether or not the UE_A 10 supports the RQoS controlled via the Control Plane initiated by the network. The second identification information may correspond to the fourth identification information or the fifth identification information. In other words, the second identification information may refer to information indicating whether or not the UE_A 10 supports the RQoS controlled via the Control Plane for the user data communication with the DN identified by the fourth identification information or for the PDU session identified by the fifth identification information. The second identification information may be information that includes the meaning of the seventh identification information. In other words, the second identification information may be information indicating whether or not the UE_A 10 supports the RQoS controlled via the Control Plane, and indicating that the UE_A 10 requests the RQoS controlled via the Control Plane.

The third identification information in the present embodiment is information indicating whether or not the UE_A 10 supports the RQoS controlled via the User Plane. The third identification information may indicate whether or not the UE_A 10 supports the RQoS controlled via the User Plane initiated by the UE, and/or whether or not the UE_A 10 supports the RQoS controlled via the User Plane initiated by the network. The third identification information may correspond to the fourth identification information or the fifth identification information. In other words, the third identification information may refer to information indicating whether or not the UE_A 10 supports the RQoS controlled via the User Plane for the user data communication with the DN identified by the fourth identification information or for the PDU session identified by the fifth identification information. The third identification information may be information that includes the meaning of the eighth identification information. In other words, the third identification information may be information indicating whether or not the UE_A 10 supports the RQoS controlled via the User Plane, and indicating that the UE_A 10 requests the RQoS controlled via the User Plane.

The fourth identification information in the present embodiment is a Data Network Name (DNN). The DNN may be information used to identify a Data Network (DN).

The fifth identification information in the present embodiment is a PDU Session ID. The PDU session ID may be information used to identify a PDU Session.

The sixth identification information in the present embodiment is information indicating that the UE_A 10 requests to change the state of the RQoS to enabled state (available state). The sixth identification information may indicate that the UE_A 10 requests to change the state of the RQoS to be controlled initiatively by UE to enabled state and/or that the UE_A 10 requests to change the state of the RQoS to be controlled initiatively by network to enabled state. Note that requesting to change the state of the RQoS to enabled state may be a request to allow the use of the RQoS. The sixth identification information may correspond to the fourth identification information and/or the fifth identification information. In other words, the sixth identification information may refer to information indicating that the UE_A 10 requests to change the state of the RQoS to enabled state for the user data communication with the DN identified by the fourth identification information or for the PDU session identified by the fifth identification information. The sixth identification information may be information that includes the meanings of the seventh identification information and/or the eighth identification information. In other words, the sixth identification information may refer to information indicating that the UE_A 10 requests to change the state of the RQoS controlled via the Control Plane and/or the User Plane to enabled state.

The seventh identification information in the present embodiment is information indicating that the UE_A 10 requests to change the state of the RQoS controlled via the Control Plane to enabled state. The seventh identification information may indicate that the UE_A 10 requests to change the state of the RQoS controlled via the Control Plane initiated by the UE to enabled state and/or that the UE_A 10 requests to change the state of the RQoS controlled via the Control Plane initiated by the network to enabled state. The seventh identification information may correspond to the fourth identification information or the fifth identification information. In other words, the seventh identification information may refer to information indicating that the UE_A 10 requests to change the state of the RQoS controlled via the Control Plane to enabled state for the user data communication with the DN identified by the fourth identification information or for the PDU session identified by the fifth identification information.

The eighth identification information in the present embodiment is information indicating that the UE_A 10 requests to change the state of the RQoS controlled via the User Plane to enabled state. The eighth identification information may indicate that the UE_A 10 requests to change the state of the RQoS controlled via the User Plane initiated by the UE to enabled state and/or that the UE_A 10 requests to change the state of the RQoS controlled via the User Plane initiated by the network to enabled state. The eighth identification information may correspond to the fourth identification information or the fifth identification information. In other words, the eighth identification information may refer to information indicating that the UE_A 10 requests to change the state of the RQoS controlled via the User Plane to enabled state for the user data communication with the DN identified by the eighth identification information or for the PDU session identified by the fifth identification information.

The 61st identification information in the present embodiment is information requesting service authentication and/or authorization by the DN via the 3GPP interface in the DN connection. Furthermore, the 61st identification information may be information requesting the implementation of the PDU session establishment authentication and/or authorization procedure in the registration procedure and/or the PDU session establishment procedure. In other words, the 61st identification information may be information requesting service authentication and/or authorization by the DN via the 3GPP interface in the registration procedure and/or the PDU session establishment procedure. As a specific example, the 61st identification information may be a flag requesting DN service authentication and/or authorization, may be a service name that identifies a specific DN service, may be a user identity (referred to as a DN-specific identity), or may be a user profile identifier. Furthermore, the 61st identification information may be authentication and/or authorization request information.

The 71st identification information in the present embodiment is information for identifying belonging to the first NW slice. In other words, the 71st identification information may be information indicating that the UE_A 10 expects an establishment of a PDU session belonging to the first NW slice. As a specific example, the 71st identification information may be NSSAI identifying the first NW slice. Note that the 71st identification information may be information for identifying a specific NW slice in the operator A network, or may be information for identifying the identical NW slice in common in the operator B (other operators other than the operator A). Furthermore, the 71st identification information may be information indicating a first NW slice configured from the HPLMN, may be information indicating a first NW slice acquired from the AMF_A 240 in a registration procedure, or may be information indicating a first NW slice that is granted from the network. In addition, the 71st identification information may be information indicating a first NW slice stored for each PLMN.

The 11th identification information in the present embodiment is information indicating whether or not the network supports RQoS. The 11th identification information may indicate whether or not the network supports RQoS to be controlled initiatively by UE and/or whether or not the network supports RQoS to be controlled initiatively by network. The 11th identification information may correspond to the 14th identification information or the 15th identification information. In other words, the 11th identification information may refer to information indicating whether or not the network supports the RQoS for the user data communication with the DN identified by the 14th identification information or for the PDU session identified by the 15th identification information. The 11th identification information may be information that includes the meanings of the 12th identification information and/or the 13th identification information. In other words, the 11th identification information may refer to information indicating whether or not the network supports the RQoS controlled via the Control Plane and/or the User Plane. The 11th identification information may be information that includes the meaning of the 17th identification information. In other words, the 11th identification information may be information indicating whether or not the network supports the RQoS and indicating that the network accepts the RQoS.

The 12th identification information in the present embodiment is information indicating whether or not the network supports the RQoS controlled via the Control Plane. The 12th identification information may indicate whether or not the network supports the RQoS controlled via the Control Plane initiated by the UE, and/or whether or not the network supports the RQoS controlled via the Control Plane initiated by the network. The 12th identification information may correspond to the 14th identification information or the 15th identification information. In other words, the 12th identification information may refer to information indicating whether or not the network supports the RQoS controlled via the Control Plane for the user data communication with the DN identified by the 14th identification information or for the PDU session identified by the 15th identification information. The 12th identification information may be information that includes the meaning of the 18th identification information. In other words, the 12th identification information may be information indicating whether or not the network supports the RQoS controlled via the Control Plane, and indicating that the network accepts the RQoS controlled via the Control Plane.

The 13th identification information in the present embodiment is information indicating whether or not the network supports the RQoS controlled via the User Plane. The 13th identification information may indicate whether or not the network supports the RQoS controlled via the User Plane initiated by the UE, and/or whether or not the network supports the RQoS controlled via the User Plane initiated by the network. The 13th identification information may correspond to the 14th identification information or the 15th identification information. In other words, the 13th identification information may refer to information indicating whether or not the network supports the RQoS controlled via the User Plane for the user data communication with the DN identified by the 14th identification information or for the PDU session identified by the 15th identification information. The 13th identification information may be information that includes the meaning of the 19th identification information. In other words, the 13th identification information may be information indicating whether or not the network supports the RQoS controlled via the User Plane, and indicating that the network accepts the RQoS controlled via the User Plane.

The 14th identification information in the present embodiment is a DNN. The 14th identification information may be a DNN allowed by the network or may be a DNN selected by the network. Furthermore, the 14th identification information may be the same DNN as the fourth identification information, or may be a different DNN.

The 15th identification information in the present embodiment is a PDU session ID. The 15th identification information may be a PDU session ID allowed by the network or a PDU session ID selected by the network. Furthermore, the 15th identification information may be the same PDU session ID as the fifth identification information, or may be a different PDU session ID.

The 16th identification information in the present embodiment is a timer value of a timer of the RQoS. The value indicated by the 16th identification information may be a value determined by an apparatus in the core network, may be a value determined by an operator, or may be a value determined by a service operator other than the operator. Note that the 16th identification information may be transmitted and/or received in association with one or more pieces of identification information of the 11th to 13th identification information and the 17th to 19th identification information.

The 17th identification information in the present embodiment is information indicating that the network accepts the change of the state of the RQoS to enabled state. The 17th identification information may indicate that the network accepts the change of the state of the RQoS to be controlled initiatively by UE to enabled state and/or that the network accepts the change of the state of the RQoS to be controlled initiatively by network to enabled state. Note that accepting the change of the state of the RQoS to enabled state may be to allow for the use of the RQoS. The 17th identification information may correspond to the 14th identification information or the 15th identification information. In other words, the 17th identification information may refer to information indicating that the network allows the change of the state of the RQoS to enabled state for the user data communication with the DN identified by the 14th identification information or for the PDU session identified by the 15th identification information. The 17th identification information may be information that includes the meanings of the 18th identification information and/or the 19th identification information. In other words, the 17th identification information may be information indicating that the network accepts the change of the state of the RQoS controlled via the Control Plane and/or the User Plane to enabled state.

The 18th identification information in the present embodiment is information indicating that the network accepts the change of the state of the RQoS controlled via the Control Plane to enabled state. The 18th identification information may indicate that the network accepts the change of the state of the RQoS controlled via the Control Plane initiated by the UE to enabled state and/or that the network accepts the change of the state of the RQoS controlled via the Control Plane initiated by the network to enabled state. The 18th identification information may correspond to the 14th identification information or the 15th identification information. In other words, the 18th identification information may refer to information indicating that the network allows the change of the state of the RQoS controlled via the Control Plane to enabled state for the user data communication with the DN identified by the 14th identification information or for the PDU session identified by the 15th identification information.

The 19th identification information in the present embodiment is information indicating that the network accepts the change of the state of the RQoS controlled via the User Plane to enabled state. The 19th identification information may indicate that the network accepts the change of the state of the RQoS controlled via the User Plane initiated by the UE to enabled state and/or that the network accepts the change of the state of the RQoS controlled via the User Plane initiated by the network to enabled state. The 19th identification information may correspond to the 14th identification information or the 15th identification information. In other words, the 19th identification information may refer to information indicating that the network allows the state of the RQoS controlled via the User Plane to be changed to enabled state for the user data communication with the DN identified by the 14th identification information or for the PDU session identified by the 15th identification information.

The 21st identification information in the present embodiment is a Cause value. The Cause value indicates a cause for rejection, and specifically, may indicate at least one of the fact that the service requested in the PDU session establishment request message is rejected by an external DN for user authentication failure, removed by an external DN, or cancelled by an external packet data network (which is referred to as User authentication or authorization failed), not allowing (rejecting) the state of the RQoS to be changed to enabled state, not allowing (rejecting) the state of the RQoS controlled via the Control Plane and the User Plane to be changed to enabled state, not allowing (rejecting) the state of only the RQoS controlled via the Control Plane to be changed to enabled state, and not allowing (rejecting) the state of only the RQoS controlled via the User Plane to be changed to enabled state. Note that rejecting the change of the state of the RQoS to enabled state may be not to allow for the use of the RQoS. Furthermore, the 21st identification information may be information indicating that part of the request has been rejected. The 21st identification information may be information including the meanings indicated by one or more pieces of identification information of the 22nd to 29th identification information. The 21st identification information may correspond to the 25th identification information or the 26th identification information. In other words, the 21st identification information may refer to a Cause value for the DN identified by the 25th identification information, or a Cause value for the PDU session identified by the 26th identification information. The 21st identification information may correspond to a Registration Area (RA), a Tracking Area (TA), or an Access Network (AN). In other words, the 21st identification information may refer to a Cause value for the registration area, the tracking area, or the access network. Specifically, the 21st identification information may be a Cause value indicating that RQoS is not allowed by the DN identified by the 25th identification information, or may be a Cause value indicating that RQoS is not allowed in the PDU session identified by the 26th identification information. In addition, the 21st identification information may be a Cause value indicating that the RQoS is not allowed in a registration area and/or a tracking area to which the UE_A 10 is currently belonging, or may be a Cause value indicating that the RQoS is not allowed in an access network to which the UE_A 10 is connected. Note that the Cause value indicated by the 21st identification information need not be limited to these.

The 22nd identification information in the present embodiment is information indicating that the network does not support RQoS. The 22nd identification information may indicate that the network does not support RQoS to be controlled initiatively by UE and/or that the network does not support RQoS to be controlled initiatively by network. The 22nd identification information may correspond to the 25th identification information or the 26th identification information. In this case, the 22nd identification information may refer to information indicating that the network does not support the RQoS for the user data communication with the DN identified by the 25th identification information or for the PDU session identified by the 26th identification information. The 22nd identification information may correspond to a registration area, a tracking area, or an access network. In this case, the 22nd identification information may refer to information indicating that the network does not support the RQoS for the registration area, the tracking area, or the access network. The 22nd identification information may be information that includes the meanings of the 23rd identification information and/or the 24th identification information. In other words, the 22nd identification information may be information indicating that the network does not support the RQoS controlled via the Control Plane and/or the User Plane. The 22nd identification information may be information that includes the meaning of the 27th identification information. In other words, the 22nd identification information may be information indicating that the network does not support the RQoS and indicating that the network does not allow (reject) the RQoS.

The 23rd identification information in the present embodiment is information indicating that the network does not support the RQoS controlled via the Control Plane. The 23rd identification information may indicate that the network does not support the RQoS controlled via the Control Plane initiated by the UE, and/or that the network does not support the RQoS controlled via the Control Plane initiated by the network. The 23rd identification information may correspond to the 25th identification information or the 26th identification information. In other words, the 23rd identification information may refer to information indicating that the network does not support the RQoS controlled via the Control Plane for the user data communication with the DN identified by the 25th identification information or for the PDU session identified by the 26th identification information. The 23rd identification information may correspond to a registration area, a tracking area, or an access network. In other words, the 23rd identification information may refer to information indicating that the network does not support the RQoS controlled via the Control Plane for the registration area, the tracking area, or the access network. The 23rd identification information may be information that includes the meaning of the 28th identification information. In other words, the 23rd identification information may be information indicating that the network does not support the RQoS controlled via the Control Plane, and indicating that the network does not allow (reject) the RQoS controlled via the Control Plane.

The 24th identification information in the present embodiment is information indicating that the network does not support the RQoS controlled via the User Plane. The 24th identification information may indicate that the network does not support the RQoS controlled via the User Plane initiated by the UE, and/or that the network does not support the RQoS controlled via the User Plane initiated by the network. The 24th identification information may correspond to the 25th identification information or the 26th identification information. In other words, the 24th identification information may refer to information indicating that the network does not support the RQoS controlled via the User Plane for the user data communication with the DN identified by the 25th identification information or for the PDU session identified by the 26th identification information. The 24th identification information may correspond to a registration area, a tracking area, or an access network. In other words, the 24th identification information may refer to information indicating that the network does not support the RQoS controlled via the User Plane for the registration area, the tracking area, or the access network. The 24th identification information may be information that includes the meaning of the 29th identification information. In other words, the 24th identification information may be information indicating that the network does not support the RQoS controlled via the User Plane, and indicating that the network does not allow (reject) the RQoS controlled via the User Plane.

The 25th identification information in the present embodiment is a DNN. The 25th identification information may be a DNN that is not allowed by the network, or may be information indicating that the DNN identified by the fourth identification information is not allowed. In addition, the 25th identification information may be the same DNN as the fourth identification information.

The 26th identification information in the present embodiment is a PDU Session ID. The 26th identification information may be a PDU session ID not allowed by the network, or may be information indicating that the PDU session ID identified by the fifth identification information is not allowed. Furthermore, the 26th identification information may be the same PDU session ID as the fifth identification information.

The 27th identification information in the present embodiment is information indicating that the network does not allow (reject) the state of the RQoS to be changed to enabled state. The 27th identification information may indicate that the network does not allow (reject) the state of the RQoS to be controlled initiatively by UE to be changed to enabled state, and/or that the network does not allow (reject) the state of the RQoS to be controlled initiatively by network to be changed to enabled state. The 27th identification information may correspond to the 25th identification information or the 26th identification information. In other words, the 27th identification information may refer to information indicating that the network does not allow (reject) the state of the RQoS to be changed to enabled state for the user data communication with the DN identified by the 25th identification information or for the PDU session identified by the 26th identification information. The 27th identification information may correspond to a registration area, a tracking area, or an access network. In other words, the 27th identification information may refer to information indicating that the network does not allow (reject) the state of the RQoS to be changed to enabled state for the registration area, the tracking area, or the access network. The 27th identification information may be information that includes the meanings of the 28th identification information and/or the 29th identification information. In other words, the 27th identification information may be information indicating that the network does not allow (reject) the state of the RQoS controlled via the Control Plane and/or the User Plane to be changed to enabled state.

The 28th identification information in the present embodiment is information indicating that the network does not allow (reject) the state of the RQoS controlled via the Control Plane to be changed to enabled state. The 28th identification information may indicate that the network does not allow (reject) the state of the RQoS controlled via the Control Plane initiated by the UE to be changed to enabled state and/or that the network does not allow (reject) the state of the RQoS controlled via the Control Plane initiated by the network to be changed to enabled state. The 28th identification information may correspond to the 25th identification information or the 26th identification information. In other words, the 28th identification information may refer to information indicating that the network does not allow (reject) the state of the RQoS controlled via the Control Plane to be changed to enabled state for the user data communication with the DN identified by the 25th identification information or for the PDU session identified by the 26th identification information. The 28th identification information may correspond to a registration area, a tracking area, or an access network. In other words, the 28th identification information may refer to information indicating that the network does not allow (reject) the state of the RQoS controlled via the Control Plane to be changed to enabled state for the registration area, the tracking area, or the access network.

The 29th identification information in the present embodiment is information indicating that the network does not allow (reject) the state of the RQoS controlled via the User Plane to be changed to enabled state. The 29th identification information may indicate that the network does not allow (reject) the state of the RQoS controlled via the User Plane initiated by the UE to be changed to enabled state and/or that the network does not allow (reject) the state of the RQoS controlled via the User Plane initiated by the network to be changed to enabled state. The 29th identification information may correspond to the 25th identification information or the 26th identification information. In other words, the 29th identification information may refer to information indicating that the network does not allow (reject) the state of the RQoS controlled via the User Plane to be changed to enabled state for the user data communication with the DN identified by the 25th identification information or for the PDU session identified by the 26th identification information. The 29th identification information may correspond to a registration area, a tracking area, or an access network. In other words, the 29th identification information may refer to information indicating that the network does not allow (reject) the state of the RQoS controlled via the User Plane to be changed to enabled state for the registration area, the tracking area, or the access network.

The 72nd identification information in the present embodiment is information indicating a cause value indicating that the present procedure has been rejected. The 72nd identification information may be information indicating that the request for the PDU session establishment to connect to the DN has been rejected. In other words, the 72nd identification information may be information indicating that a request for establishment of a PDU session belonging to a first slice has been rejected, or may be information indicating that establishment of a PDU session belonging to the first slice is not allowed. Here, the first slice may be a slice indicated by the 71st identification information, or may be a different slice. In addition, the 72nd identification information may be information indicating that establishment of a PDU session belonging to the first slice is not allowed by the DN identified by the 25th identification information, or may be information indicating that establishment of a PDU session belonging to the first slice is not allowed in the PDU session identified by the 26th identification information. In addition, the 72nd identification information may be information indicating that establishment of a PDU session belonging to the first slice is not allowed in a registration area and/or a tracking area to which the UE_A 10 is currently belonging, or may be information indicating that establishment of a PDU session belonging to the first slice is not allowed in an access network to which the UE_A 10 is connected. Note that the cause value indicating that the present procedure indicated by the 72nd identification information is rejected may not be limited to these. In addition, the 72nd identification information may be information indicating the value of the first timer. The UE_A 10 may configure the value indicated by the 72nd identification information to the first timer, may configure a timer value configured in another manner, or may configure a random value, based on the reception of the 72nd identification information. Further, the 72nd identification information may be an identifier identifying NW slice information to which the rejected PDU session request belongs. Note that the NW slice indicated by the 72nd identification information may be the same NW slice as the NW slice indicated by the 71st identification information, or may be a different NW slice. Furthermore, the 72nd identification information may be an identifier that the NW indicates the reconnection after the PDU session has been rejected. Furthermore, the UE_A 10 may start running of the configured timer based on the reject cause value, the NW slice information, and the identifier indicating reconnection from the NW.

The 31st identification information in the present embodiment is a Reflective QoS Indication (RQI). The RQI may be information indicating that the RQoS has been validated, or may be information indicating that the RQoS is to be validated. More specifically, the 31st identification information may be information indicating that the RQoS has been validated for the user data communication of the downlink packet, or may be information indicating that the RQoS is to be validated for the user data communication of the uplink packet. Furthermore, the 31st identification information may be information requesting creation of QoS rules for the user data communication of the uplink packet.

The 32nd identification information in the present embodiment is a QFI. The 32nd identification information may be information identifying the QoS flow. Furthermore, the 32nd identification information may be information indicating a flow in which the downlink packet for which the RQoS has been validated is transferred, or may be information indicating a flow in which the uplink packet is transferred after the validation of the RQoS. Furthermore, the 32nd identification information may be information requesting that the user data communication of the uplink packet use the QoS flow indicated by the 32nd identification information. Furthermore, the 32nd identification information may be information requesting the creation of the QoS rules for the user data communication of the uplink packet using the QoS flow indicated by the 32nd identification information.

The 41st identification information in the present embodiment is information indicating that the RQoS is requested initiated by the UE, or information indicating that the validation of the RQoS is requested initiated by the UE. More specifically, the 41st identification information may be information requesting the validation of the RQoS for the user data communication of the uplink packet and/or the downlink packet. Furthermore, the 41st identification information may be information requesting the creation of QoS rules for the user data communication of the uplink packet and/or the downlink packet. Furthermore, the 41st identification information may be information requesting the initiation of the network initiated RQoS validation procedure.

The 42nd identification information in the present embodiment is a QoS Flow ID (QFI). The QFI is information used to identify the flow in which the RQoS is applied. The 42nd identification information may be information identifying the QoS flow. Furthermore, the 42nd identification information may be information indicating the flow in which the uplink packet and/or the downlink packet is transferred after the validation of the RQoS. Furthermore, the 42nd identification information may be information requesting that the user data communication of the uplink packet and/or the downlink packet use the QoS flow indicated by the 42nd identification information. Furthermore, the 42nd identification information may be information requesting the creation of the QoS rules for the user data communication of the uplink packet and/or the downlink packet using the QoS flow indicated by the 42nd identification information. Furthermore, the 42nd identification information may be information requesting the initiation of the network initiated RQoS validation procedure, or may be information requesting that the QoS flow used in the network initiated RQoS validation procedure be an RQoS flow indicated by the 42nd identification information.

The 51st identification information in the present embodiment is information indicating that the RQoS is not allowed (rejected), or information indicating that the request for the validation of the RQoS is not allowed (rejected). Furthermore, the 51st identification information may be information indicating the cause that the request of the UE_A 10 has been rejected. Note that the cause that the request of the UE_A 10 has been rejected may be information indicating that the validation of the RQoS is not allowed in an access network, and/or a registration area, and/or a tracking area to which the UE_A 10 is currently connecting, or may be information indicating that the validation of the RQoS is not allowed in the uplink packet in which the UE_A 10 has requested the validation of the RQoS. Furthermore, the cause that the request of the UE_A 10 has been rejected may be information indicating that the validation of the RQoS is temporarily prohibited, or may be information indicating that the UE initiated RQoS validation procedure is prohibited. Note that the cause that the request of the UE_A 10 has been rejected may be information indicating that the network is unable to accept the UE initiated RQoS validation procedure, but not limited to this.

The 62nd identification information in the present embodiment is the authentication and/or authorization information issued by the DN acquired by the SMF_A 230 in the authentication and/or authorization procedure with the DN. As a specific example, the 62nd identification information may be a service name for which the DN authenticates/authorizes, or may be an authorization flag. Furthermore, the 62nd identification information may be information indicating that the DN_A 5 performs authentication and/or authorization to the PDU session and/or the UE_A 10 and/or the application. Furthermore, the 62nd identification information may be information requesting confirmation of the authentication and/or authorization information issued by the DN indicated by the 62nd identification information, of the UE_A 10, and/or the application, and/or the user. Furthermore, the 62nd identification information may be information requesting a service usage selection from among service names for which the DN indicated by the 62nd identification information authenticates/authorizes, of the UE_A 10, and/or the application, and/or the user.

The 63rd identification information in the present embodiment is information indicating the response to the authentication and/or authorization information issued by the DN acquired by the SMF_A 230 in the authentication and/or authorization procedure with the DN. As a specific example, the 63rd identification information may be information indicating a message response to the 62nd identification information, may be information indicating the same contents as the information indicated by the 62nd identification information, or may be information indicating the service name which the UE_A 10 has selected for the service usage from among service names in the 62nd identification information. Furthermore, the 63rd identification information may be information indicating that the confirmation of the authentication and/or authorization information issued by the DN indicated by the 62nd identification information, of the UE_A 10, and/or the application, and/or the user, has been performed. Furthermore, the 63rd identification information may be information indicating that the service usage selection from among service names for which the DN indicated by the 62nd identification information authenticates/authorizes, of the UE_A 10, and/or the application, and/or the user, has been performed. Further, the 63rd identification information may be DN authentication and/or authorization response information.

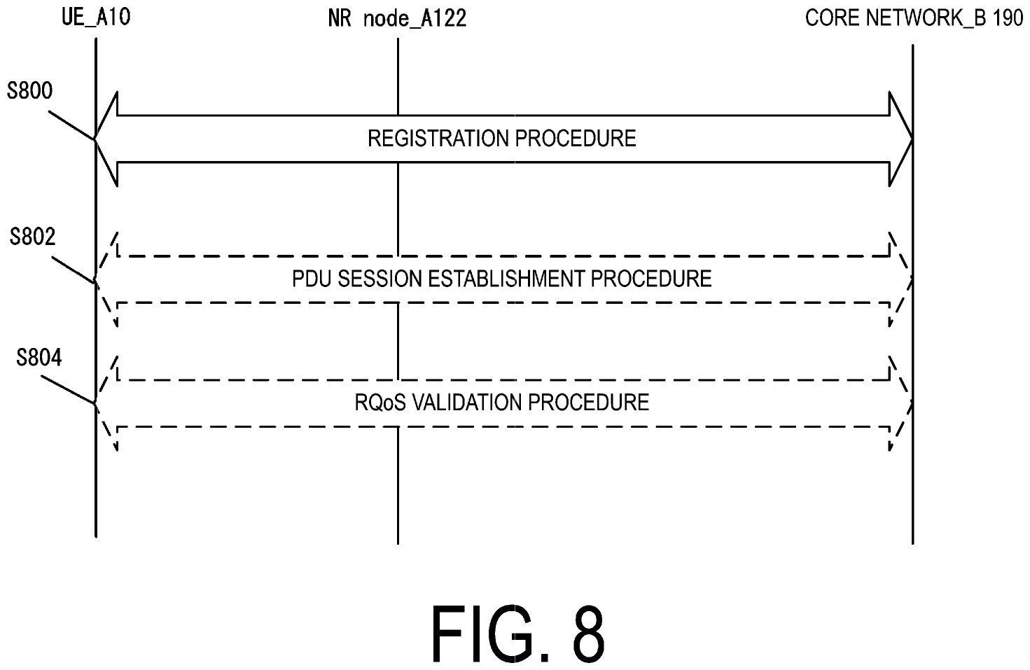

Next, the initial procedure according to the present embodiment will be described with reference to FIG. 8. Hereinafter, the initial procedure is also referred to as the present procedure, and the initial procedure (the present procedure) includes the Registration procedure, the PDU session establishment procedure, and Reflective Quality of Service (QoS) (RQoS) validation procedure. Details of the registration procedure, the PDU session establishment procedure, and the RQoS validation procedure will be described later.

Specifically, by performing the registration procedure by each apparatus (S800), the UE_A 10 transitions to a state registered with the network (RM-REGISTERED state). Next, by performing the PDU session establishment procedure by each apparatus (S802), the UE_A 10 establishes the PDU session with the DN_A 5 that provides the PDU connection service via the core network_B 190 and transitions to a state in which a PDU session is established between each apparatus. Note that, although this PDU session is assumed to be established via the access network and the UPF_A 235, this PDU session is not limited thereto. That is, a UPF (UPF_C 239) different from the UPF_A 235 may be present between the UPF_A 235 and the access network. At this time, the PDU session is established via the access network, the UPF_C 239, and the UPF_A 235.

Next, each apparatus creates a specific QoS rule for specific user data by performing an RQoS validation procedure (S804). In addition, each apparatus transitions to a state in which user data communication using a specific QoS flow associated with a specific QoS rule is executable for the specific user data, based on the creation of the specific QoS rule.

Next, each apparatus performs an RQoS deactivation procedure after transitioning to the state in which the user data communication using the specific QoS flow is executable, and deletes the specific QoS rule for the specific user data. In addition, each apparatus transitions to a state in which user data communication using a specific QoS flow associated with a specific QoS rule is not executable for the specific user data, based on the deletion of the specific QoS rule. According to the above, the present procedure is completed.

Note that each apparatus may exchange various pieces of capability information and/or various pieces of request information of each apparatus in the registration procedure and/or the PDU session establishment procedure. Note that in a case that each apparatus performs the exchange of various pieces of information and/or negotiation of various requests in the registration procedure, each apparatus need not perform the exchange of various pieces of information and/or the negotiation of various requests in the PDU session establishment procedure. In a case that each apparatus does not perform the exchange of various pieces of information and/or the negotiation of various requests in the registration procedure, each apparatus may perform the exchange of various pieces of information and/or the negotiation of various requests in the PDU session establishment procedure. Even in a case that each apparatus performs the exchange of various pieces of information and/or the negotiation of various requests in the registration procedure, each apparatus may perform the exchange of various pieces of information and/or the negotiation of various requests in the PDU session establishment procedure.

Each apparatus may perform the PDU session establishment procedure in the registration procedure or after the registration procedure is completed. In a case that the PDU session establishment procedure is performed in the registration procedure, the PDU session establishment request message included in the registration request message may be transmitted and/or received, and the PDU session establishment accept message included in the registration accept message may be transmitted and/or received, a PDU session establishment complete message included in a registration complete message may be transmitted and/or received, and a PDU session establishment reject message included in a registration reject message may be transmitted and/or received. In a case that the PDU session establishment procedure is performed in the registration procedure, each apparatus may establish a PDU session based on the completion of the registration procedure, or may transition to a state in which the PDU session is established between each apparatus.

Each apparatus involved in the present procedure may transmit and/or receive each control message described in the present procedure to transmit and/or receive one or more pieces of identification information included in each control message and store each piece of identification information transmitted and/or received as a context.

### 1.3.1. Overview of Registration Procedure

First, the following describes the overview of the registration procedure. The registration procedure is a procedure initiated by the UE_A 10 to perform registration in a network (the access network and/or the core network_B 190 and/or the DN (DN_A 5). In a state in which the UE_A 10 is not registered in the network, the UE_A 10 can perform the present procedure at any timing such as the timing of turning on power. In other words, the UE_A 10 may initiate the present procedure at any timing in a non-registered state (RM-DEREGISTERED state). Each apparatus may transition to a registered state (RM-REGISTERED state), based on the completion of the registration procedure.

Furthermore, the present procedure may be a procedure for updating location registration information of the UE_A 10 in the network, for regularly notifying a state of the UE_A 10 from the UE_A 10 to the network, and/or for updating specific parameters related to the UE_A 10 in the network.

The UE_A 10 may initiate the present procedure in a case that the UE_A 10 applies mobility across TAs. In other words, the UE_A 10 may initiate the present procedure in a case that the UE_A 10 moves to a TA different from a TA indicated in a TA list that the UE_A 10 holds. Furthermore, the UE_A 10 may initiate the present procedure in a case that a running timer expires. Furthermore, the UE_A 10 may initiate the present procedure in a case that a context of each apparatus needs to be updated due to disconnection or invalidation (also referred to as deactivation) of a PDU session. Furthermore, the UE_A 10 may initiate the present procedure in a case that a change occurs in capability information and/or preference concerning PDU session establishment of the UE_A 10. Furthermore, the UE_A 10 may initiate the present procedure regularly. Note that, besides the above, the UE_A 10 can perform the present procedure at any timing as long as a PDU session is established.

### 1.3.1.1. Example of Registration Procedure

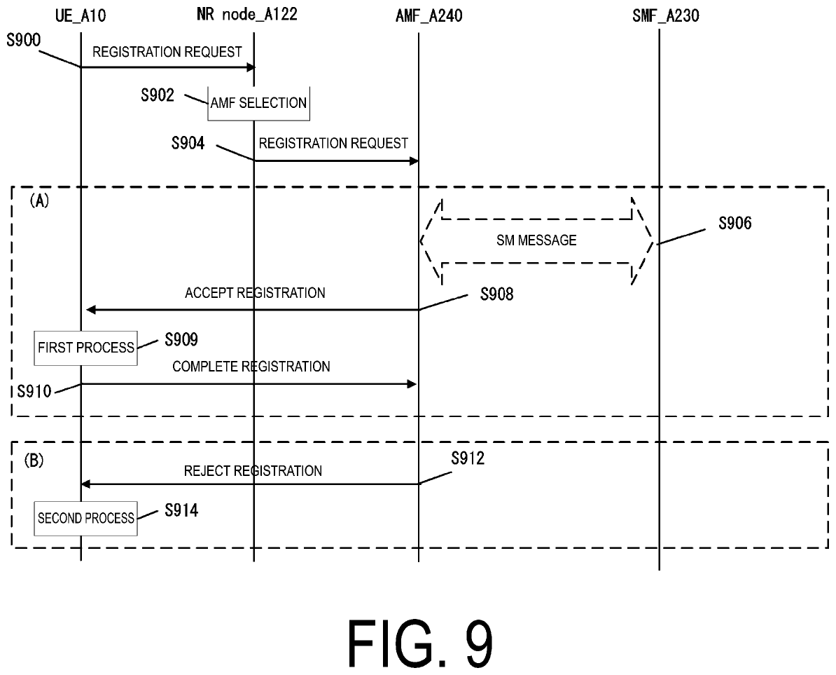

The following describes an example of a procedure to perform the registration procedure with reference to FIG. 9. In this section, the present procedure refers to the registration procedure. Each step of the present procedure will be described below.

First, the UE_A 10 transmits a Registration Request message to the AMF_A 240 via a NR node (also referred to as gNB)_A 122 (S900), (S902), and (S904) to initiate the registration procedure. In addition, the UE_A 10 transmits a Session Management (SM) message (e.g., a PDU session establishment request message) included in the registration request message, or transmits the SM message (e.g., the PDU session establishment request message) along with the registration request message to initiate a procedure for SM, such as a PDU session establishment procedure, during the registration procedure.

Specifically, the UE_A 10 transmits a Radio Resource Control (RRC) message including the registration request message to the NR node_A 122 (S900). In a case that the RRC message including the registration request message is received, the NR node_A 122 retrieves the registration request message from the RRC message, and selects the AMF_A 240 as a NF or a common CP function to which the registration request message is routed (S902). Here, the NR node_A 122 may select the AMF_A 240 based on information included in the RRC message. The NR node_A 122 transmits or transfers the registration request message to the selected AMF_A 240 (S904).

Note that, the registration request message is a Non-Access-Stratum (NAS) message transmitted and/or received on the N1 interface. In addition, the RRC message is a control message transmitted and/or received between the UE_A 10 and the NR node_A 122. The NAS message is processed in a NAS layer, the RRC message is processed in a RRC layer, and the NAS layer is a higher layer than the RRC layer.

In a case that there are multiple NSIs requesting registration, the UE_A 10 may transmit a registration request message for each of the NSIs, or may transmit multiple registration request messages included in one or more RRC messages. The above-described multiple registration request messages included in one or more RRC messages may be transmitted as one registration request message.

Here, the UE_A 10 may include one or more pieces of identification information of the first to eighth identification information, the 61st identification information, and the 71st identification information in the registration request message and/or the RRC message. Note that two or more pieces of identification information of these pieces of identification information may be configured as one or more pieces of identification information.

Furthermore, by transmitting one or more pieces of identification information of the first to eighth identification information included in the registration request message and/or the RRC message, the UE_A 10 may indicate that the UE_A 10 supports the RQoS or may request to transition to a state in which the RQoS is available.

Furthermore, by transmitting one or more pieces of identification information of the first to eighth identification information included in the registration request message and/or the RRC message, the UE_A 10 may indicate that the UE_A 10 does not support the RQoS or may indicate not to request to transition to a state in which the RQoS is available.

More particularly, by transmitting the first identification information and/or the second identification information and/or the sixth identification information and/or the seventh identification information included in the registration request message and/or the RRC message, the UE_A 10 may indicate that the UE_A 10 supports the RQoS controlled via the Control Plane, or may request to transition to a state in which the RQoS controlled via the Control Plane is available. In this case, by transmitting the third identification information and/or the eighth identification information not included in the registration request message and/or the RRC message, the UE_A 10 may indicate that the UE_A 10 does not support the RQoS controlled via the User Plane, or may indicate not to request to transition to a state in which the RQoS controlled via the User Plane is available.

By transmitting the first identification information and/or the second identification information and/or the sixth identification information and/or the seventh identification information included in the registration request message and/or the RRC message, the UE_A 10 may indicate that the UE_A 10 does not support the RQoS controlled via the Control Plane, or may indicate not to request to transition to a state in which the RQoS controlled via the Control Plane is available.

Furthermore, by transmitting the first identification information and/or the third identification information and/or the sixth identification information and/or the eighth identification information included in the registration request message and/or the RRC message, the UE_A 10 may indicate that the UE_A 10 supports the RQoS controlled via the User Plane, or may request to transition to a state in which the RQoS controlled via the User Plane is available. In this case, by transmitting the second identification information and/or the seventh identification information not included in the registration request message and/or the RRC message, the UE_A 10 may indicate that the UE_A 10 does not support the RQoS controlled via the Control Plane, or may indicate not to request to transition to a state in which the RQoS controlled via the Control Plane is available.

By transmitting the first identification information and/or the third identification information and/or the sixth identification information and/or the eighth identification information included in the registration request message and/or the RRC message, the UE_A 10 may indicate that the UE_A 10 does not support the RQoS controlled via the User Plane, or may indicate not to request to transition to a state in which the RQoS controlled via the User Plane is available.

Furthermore, by transmitting one or more pieces of identification information of the first to third identification information and the sixth to eight identification information in association with the fourth identification information, the UE_A 10 may indicate whether or not the UE_A 10 supports the RQoS for the PDU session established for the DN identified with the fourth identification information, or may indicate whether or not to request to transition to a state in which the RQoS is available.

Furthermore, by transmitting one or more pieces of identification information of the first to third identification information and the sixth to eight identification information in association with the fifth identification information, the UE_A 10 may indicate whether or not the UE_A 10 supports the RQoS for the PDU session identified with the fifth identification information, or may indicate whether or not to request to transition to a state in which the RQoS is available.

Furthermore, by transmitting one or more pieces of identification information of the first to eighth identification information included in the registration request message and/or the RRC message, the UE_A 10 may indicate whether or not the UE_A 10 supports the RQoS to be controlled initiatively by UE or may indicate whether or not to request to transition to a state in which the RQoS to be controlled initiatively by UE is available.

Furthermore, by transmitting one or more pieces of identification information of the first to eighth identification information included in the registration request message and/or the RRC message, the UE_A 10 may indicate whether or not the UE_A 10 supports the RQoS to be controlled initiatively by network or may indicate whether or not request to transition to a state in which the RQoS to be controlled initiatively by network is available.

Alternatively, by transmitting the first identification information, or by transmitting the second identification information and the third identification information, or by transmitting the sixth identification information, or by transmitting the seventh identification information and the eighth identification information, or by transmitting one or more pieces of identification information of these pieces of identification information in a case that two or more pieces of identification information of these pieces of identification information are configured as one or more pieces of identification information, the UE_A 10 may indicate that the UE_A 10 supports the RQoS controlled via the Control Plane and the UE_A 10 supports the RQoS controlled via the User Plane, or may request to transition to a state in which the RQoS controlled via the User Plane is available and transition to a state in which the RQoS controlled via the User Plane is available.

Furthermore, by transmitting the 61st identification information and/or the fourth identification information and/or the fifth identification information included in the registration request message and/or the RRC message, the UE_A 10 may request service authentication and/or authorization by the DN via a 3GPP interface (N6 interface, etc.) or request to perform a PDU session establishment authentication and/or authorization procedure in the present procedure.

More specifically, by transmitting the 61st identification information and the fourth identification information in association with each other, the UE_A 10 may request service authentication and/or authorization by the DN_A 5 via the 3GPP interface in the PDU session established for the DN identified by the fourth identification information, or may request to perform the PDU session establishment authentication and/or authorization procedure in the present procedure.

Furthermore, by transmitting the 61st identification information and the fifth identification information in association with each other, the UE_A 10 may request service authentication and/or authorization by the DN_A 5 via the 3GPP interface in the PDU session identified by the fifth identification information, or may request to perform the PDU session establishment authentication and/or authorization procedure in the present procedure.

Furthermore, by transmitting the 71st identification information and/or the fourth identification information and/or the fifth identification information included in the registration request message and/or RRC message, the UE_A 10 may request establishment of a PDU session belonging to a network slice, may indicate a network slice to which the PDU session belongs which is requested by the UE_A 10, or may indicate a network slice to which the PDU session will belong.

More particularly, by transmitting the 71st identification information and the fourth identification information in association with each other, the UE_A 10 may request establishment of a PDU session belonging to a network slice in a PDU session established for a DN identified by the fourth identification information, may indicate a network slice to which the PDU session belongs which is requested by the UE_A 10, or may indicate a network slice to which the PDU session will belong.

Furthermore, by transmitting the 71st identification information and the fifth identification information in association with each other, the UE_A 10 may request establishment of a PDU session belonging to a network slice in a PDU session identified by the fifth identification information, may indicate a network slice to which the PDU session belongs which is requested by the UE_A 10, or may indicate a network slice to which the PDU session will belong.

Furthermore, the UE_A 10 may combine and transmit two or more pieces of identification information of the first to eighth identification information, the 61st identification information, and the 71st identification information, thereby making a request in which the above-described matters are combined. Note that the matters indicated by the UE_A 10 transmitting each identification information may not be limited thereto.

Note that the UE_A 10 may determine which piece of identification information of the first identification information to the eighth identification information, the 61st identification information, and the 71st identification information is to be included in the registration request message, based on the capability information of the UE_A 10, and/or the policy such as the UE policy, and/or the preference of the UE_A 10, and/or the application (higher layer). Note that the determination performed by the UE_A 10 as to which piece of identification information is to be included in the registration request message is not limited to the determination described above.

The UE_A 10 may transmit these pieces of identification information while being included in a control message (e.g., a NAS message or an RRC message) different from the registration request message.

The AMF_A 240 receives the registration request message and/or the control message different from the registration request message and then performs first determination of whether condition is satisfied. The first determination of whether condition is satisfied is intended to determine whether or not the AMF_A 240 accepts a request of the UE_A 10. In the first determination of whether condition is satisfied, the AMF_A 240 determines whether the result of the first determination of whether condition is satisfied is true or false. The AMF_A 240 initiates the procedure of (A) in the present procedure in a case that the result of the first determination of whether condition is satisfied is true (in other words, in a case that the network accepts the request of the UE_A 10), and initiates the procedure of (B) in the present procedure in a case that the result of the first determination of whether condition is satisfied is false (in other words, in a case that the network does not accept the request of the UE_A 10).

As follows, steps in a case that the result of the first determination of whether condition is satisfied is true, in other words, each step of the procedure of (A) in the present procedure will be described. The AMF_A 240 performs a fourth determination of whether condition is satisfied, and initiates the procedure of (A) in the present procedure. The fourth determination of whether condition is satisfied is to determine whether the AMF_A 240 transmits and/or receives the SM message to and/or from the SMF_A 230. In other words, the fourth determination of whether condition is satisfied may be intended to determine whether or not the AMF_A 240 performs a PDU session establishment procedure in the present procedure. In a case that the fourth condition determination is true (in other words, in a case that the AMF_A 240 performs the transmission and/or reception of the SM message to and/or from the SMF_A 230), the AMF_A 240 select the SMF_A 230 and transmits and/or receive the SM message to and/or from the selected SMF_A 230. In a case that the fourth condition determination is false (in other words, in a case that the AMF_A 240 does not perform the transmission and/or reception of the SM message to and/or from the SMF_A 230), the AMF_A 240 skips such processes (S906). Note that in a case that the AMF_A 240 receives an SM message indicating rejection from the SMF_A 230, the AMF_A 240 may terminate the procedure of (A) in the present procedure, and may initiate the procedure of (B) in the present procedure.

In addition, the AMF_A 240 transmits the Registration Accept message to the UE_A 10 via the NR node_A 122, based on the reception of the registration request message from the UE_A 10 and/or the completion of the transmission and/or reception of the SM message to and/or from the SMF_A 230 (S908). For example, in a case that the result of the fourth determination of whether condition is satisfied is true, the AMF_A 240 may transmit the registration accept message based on the reception of the registration request message from the UE_A 10. In a case that the fourth determination of whether condition is satisfied is false, the AMF_A 240 may transmit the registration accept message based on the completion of the transmission and/or reception of the SM message to and/or from the SMF_A 230. Here, the registration accept message may be transmitted as a response message to the registration request message. The registration accept message is a NAS message transmitted and/or received on the N1 interface. For example, the AMF_A 240 may transmit the registration accept message as a control message of the N2 interface to the NR node_A 122, and the NR node_A 122 receiving this may transmit the message included in the RRC message to the UE_A 10.

Further, in a case that the result of the fourth determination of whether condition is satisfied is true, the AMF_A 240 may transmit the SM message (e.g., a PDU session establishment accept message) included in the registration accept message, or transmit the SM message (e.g., a PDU session establishment accept message) along with the registration accept message. This transmission method may be performed in a case that the SM message (e.g., the PDU session establishment request message) is included in the registration request message and the result of the fourth determination of whether condition is satisfied is true. The transmission method may be performed in a case that the registration request message and the SM message (e.g., the PDU session establishment request message) are included and the result of the fourth determination of whether condition is satisfied is true. The AMF_A 240 may indicate that the procedure for SM has been accepted by performing such a transmission method.

Here, the AMF_A 240 may include one or more pieces of identification information among the 11th identification information to the 19th identification information in the registration accept message, or may include these pieces of identification information to indicate that the request of the UE_A 10 has been accepted. Note that two or more pieces of identification information of these pieces of identification information may be configured as one or more pieces of identification information.

Furthermore, by transmitting one or more pieces of identification information of the 11th to 19th identification information included in the registration accept message, the AMF_A 240 may indicate that the network supports the RQoS or may indicate that the request to transition to a state in which the RQoS is available has been accepted.

More particularly, by transmitting the 11th identification information and/or the 12th identification information and/or the 17th identification information and/or the 18th identification information included in the registration accept message, the AMF_A 240 may indicate that the network supports the RQoS controlled via the Control Plane, or may indicate that the request to transition to a state in which the RQoS controlled via the Control Plane is available has been accepted. In this case, by transmitting the 13th identification information and/or the 19th identification information not included in the registration accept message, the AMF_A 240 may indicate that the network does not support the RQoS controlled via the User Plane, or may indicate that the request to transition to a state in which the RQoS controlled via the User Plane is available has been rejected.

By transmitting the 11th identification information and/or the 12th identification information and/or the 17th identification information and/or the 18th identification information included in the registration accept message, the AMF_A 240 may indicate that the network does not support the RQoS controlled via the Control Plane, or may indicate that the request to transition to a state in which the RQoS controlled via the Control Plane is available has been rejected.

Furthermore, by transmitting the 11th identification information and/or the 13th identification information and/or the 17th identification information and/or the 19th identification information included in the registration accept message, the AMF_A 240 may indicate that the network supports the RQoS controlled via the User Plane, or may indicate that the request to transition to a state in which the RQoS controlled via the User Plane is available has been accepted. In this case, by transmitting the 12th identification information and/or the 18th identification information not included in the registration accept message, the AMF_A 240 may indicate that the network does not support the RQoS controlled via the Control Plane, or may indicate that the request to transition to a state in which the RQoS controlled via the Control Plane is available has been rejected.

By transmitting the 11th identification information and/or the 13th identification information and/or the 17th identification information and/or the 19th identification information included in the registration accept message, the AMF_A 240 may indicate that the network does not support the RQoS controlled via the User Plane, or may indicate that the request to transition to a state in which the RQoS controlled via the User Plane is available has been rejected.

Furthermore, by transmitting one or more pieces of identification information of the 11th to 13th identification information and the 17th to 19th identification information in association with the 14th identification information, the AMF_A 240 may indicate whether or not the network supports the RQoS for the PDU session established for the DN identified with the 14th identification information, or may indicate whether or not the request to transition to a state in which the RQoS is available has been accepted.

Furthermore, by transmitting one or more pieces of identification information of the 11th to 13th identification information and the 17th to 19th identification information in association with the 15th identification information, the AMF_A 240 may indicate whether or not the network supports the RQoS for the PDU session identified with the 15th identification information, or may indicate whether or not the request to transition to a state in which the RQoS is available has been accepted.

Furthermore, by transmitting one or more pieces of identification information of the 11th to 19th identification information included in the registration accept message, the AMF_A 240 may indicate whether or not the network supports the RQoS to be controlled initiatively by UE or may indicate whether or not the request to transition to a state in which the RQoS to be controlled initiatively by UE is available has been accepted.

Furthermore, by transmitting one or more pieces of identification information of the 11th to 19th identification information included in the registration accept message, the AMF_A 240 may indicate whether or not the network supports the RQoS to be controlled initiatively by network or may indicate whether or not the request to transition to a state in which the RQoS to be controlled initiatively by network is available has been accepted.

Furthermore, by transmitting one or more pieces of identification information of the 11th to 15th identification information and the 17th to 19th identification information in association with the 16th identification information, the AMF_A 240 may indicate an effective period of the RQoS to be applied to the user data communication, may indicate a period in which the RQoS is effective after the validation of the RQoS for the user data communication, or may indicate a period until the RQoS timer started in a case that the RQoS for the user data communication is validated expires.

Alternatively, by transmitting the 11th identification information, or by transmitting the 12th identification information and the 13th identification information, or by transmitting the 17th identification information, or by transmitting the 18th identification information and the 19th identification information, or by transmitting one or more pieces of identification information of these pieces of identification information in a case that two or more pieces of identification information of these pieces of identification information are configured as one or more pieces of identification information, the UE_A 10 may indicate that the network supports the RQoS controlled via the Control Plane and the network supports the RQoS controlled via the User Plane, or may indicate that the request to transition to a state in which the RQoS controlled via the Control Plane is available has been accepted and the request to transition to a state in which the RQoS controlled via the User Plane is available has been accepted.

Furthermore, the AMF_A 240 may combine and transmit two or more pieces of identification information of the 11th to 19th identification information, thereby making a request in which the above-described matters are combined. Note that the matters indicated by the AMF_A 240 transmitting each identification information may not be limited thereto.

Note that the AMF_A 240 may determine which piece of identification information among the 11th identification information to the 19th identification information is included or not included in the registration accept message, based on the received identification information, and/or the capability information of the network, and/or the operator policy, and/or the state of the network, and/or the registration information of the user (user subscription), and the like.

For example, the 11th identification information and/or the 17th identification information may be information transmitted in a case that the network supports the RQoS and/or in a case that the first to third identification information and/or the sixth to eighth identification information are received. Furthermore, the 12th identification information and/or the 18th identification information may be information transmitted in a case that the network supports the RQoS controlled via the Control Plane and/or in a case that the first to third identification information and/or the sixth to eighth identification information are received. Furthermore, the 13th identification information and/or the 19th identification information may be information transmitted in a case that the network supports the RQoS controlled via the User Plane and/or in a case that the first to third identification information and/or the sixth to eighth identification information are received.

Furthermore, the 14th identification information may be information indicating the same DNN as the DNN indicated by the fourth identification information, or may be information indicating a different DNN. Furthermore, the 15th identification information may be information indicating the same PDU session ID as the PDU session ID indicated by the fifth identification information, or may be information indicating a different PDU session ID. Note that determination performed by the AMF_A 240 as to which piece of identification information is to be included in the registration accept message is not limited to the determination described above.

The UE_A 10 receives the registration accept message via the NR node_A 122 (S908). The UE_A 10 receives the registration accept message and recognizes the contents of various types of identification information included in the registration accept message.

The UE_A 10 further performs the first process, based on the reception of the registration accept message (S909). Note that the UE_A 10 may perform the first process based on the transmission of the registration complete message, or may perform the first process based on the completion of the present procedure.

Here, the first process may be a process in which the UE_A 10 recognizes a matter indicated by the AMF_A 240. Furthermore, the first process may be a process in which the UE_A 10 stores the received identification information as a context, or may be a process in which the UE_A 10 transfers the received identification information to a higher layer and/or a lower layer. Furthermore, the first process may be a process in which the UE_A 10 recognizes that the request for the present procedure has been accepted.

In addition, in a case that the UE_A 10 receives one or more pieces of identification information of the 11th to 19th identification information, the first process may be a process in which the UE_A 10 transitions to a state in which the RQoS validation procedure is executable at any timing after the PDU session has been established, or may be a process to initiate the RQoS validation procedure after the PDU session has been established.

More specifically, in a case that the UE_A 10 receives the 11th identification information and/or the 12th identification information and/or the 17th identification information and/or the 18th identification information, the first process may be a process to transition to a state in which the RQoS validation procedure controlled via the Control Plane is executable at any timing after the PDU session has been established. Furthermore, in a case that the UE_A 10 receives the 11th identification information and/or the 13th identification information and/or the 17th identification information and/or the 19th identification information, the first process may be a process to transition to a state in which the RQoS validation procedure controlled via the User Plane is executable at any timing after the PDU session has been established.

Furthermore, in a case that the UE_A 10 receives one or more pieces of identification information of the 11th to 19th identification information, as well as the 16th identification information, the first process may be a process in which the UE_A 10 configures the value indicated by the 16th identification information to the timer value of the RQoS. Note that the first process may not be limited to these processes.

Next, the UE_A 10 transmits a Registration Complete message to the AMF_A 240, based on the reception of the registration accept message and/or the completion of the first process (S910). Note that, in a case that the UE_A 10 has received an SM message such as a PDU session establishment accept message, the UE_A 10 may transmit the SM message such as the PDU session establishment complete message included in the registration complete message, or may include the SM message therein to indicate that the procedure for SM is completed. Here, the registration complete message may be transmitted as a response message to the registration accept message. The registration complete message is a NAS message transmitted and/or received on the N1 interface. For example, the UE_A 10 may transmit the registration complete message included in the RRC message to the NR node_A 122, and the NR node_A 122 receiving this may transmit the message as a control message of the N2 interface to the AMF_A 240.

The AMF_A 240 receives the registration complete message (S910). In addition, each apparatus completes the procedure of (A) in the present procedure based on the transmission and/or reception of the registration accept message and/or the registration complete message.

Next, steps in a case that the first determination of whether condition is satisfied is false, in other words, each step of the procedure of (B) in the present procedure will be described. The AMF_A 240 transmits the Registration Reject message to the UE_A 10 via the NR node_A 122 (S912) to initiate the procedure of (B) in the present procedure. Here, the registration reject message may be transmitted as a response message to the registration request message. The registration reject message is a NAS message transmitted and/or received on the N1 interface. For example, the AMF_A 240 may transmit the registration reject message as a control message of the N2 interface to the NR node_A 122, and the NR node_A 122 receiving this may transmit the message included in the RRC message to the UE_A 10. The registration reject message transmitted by the AMF_A 240 is not limited thereto as long as it is a message for rejecting the request of the UE_A 10.

Note that the procedure of (B) in the present procedure may be initiated in a case that the procedure of (A) in the present procedure is canceled. In the procedure of (A), in a case that the result of the fourth determination of whether condition is satisfied is true, the AMF_A 240 may transmit an SM message such as a PDU session establishment reject message indicating rejection in the registration reject message, or may include the SM message indicating rejection therein to indicate that the procedure for SM has been rejected. In that case, the UE_A 10 may further receive the SM message, such as the PDU session establishment reject message, that indicates rejection, or may recognize that the procedure for SM has been rejected.

Here, the AMF_A 240 may include one or more pieces of identification information among the 21st identification information to the 29th identification information, and the 72nd identification information in the registration reject message, or may include these pieces of identification information to indicate that the request of the UE_A 10 has been rejected. Note that two or more pieces of identification information of these pieces of identification information may be configured as one or more pieces of identification information.

Furthermore, by transmitting one or more pieces of identification information of the 21st to 29th identification information included in the registration reject message, the AMF_A 240 may indicate that the network does not support the RQoS or may indicate that the request to transition to a state in which the RQoS is available has been rejected.

More particularly, by transmitting the 21st identification information and/or the 22nd identification information and/or the 23rd identification information and/or the 27th identification information and/or the 28th identification information included in the registration reject message, the AMF_A 240 may indicate that the network does not support the RQoS controlled via the Control Plane, or may indicate that the request to transition to a state in which the RQoS controlled via the Control Plane is available has been rejected. In this case, by transmitting the 24th identification information and/or the 29th identification information not included in the registration reject message, the AMF_A 240 may indicate that the network supports the RQoS controlled via the User Plane, or may indicate that the request to transition to a state in which the RQoS controlled via the User Plane is available has been accepted.

Furthermore, by transmitting the 21st identification information and/or the 22nd identification information and/or the 24th identification information and/or the 27th identification information and/or the 29th identification information included in the registration reject message, the AMF_A 240 may indicate that the network does not support the RQoS controlled via the User Plane, or may indicate that the request to transition to a state in which the RQoS controlled via the User Plane is available has been rejected. In this case, by transmitting the 23rd identification information and/or the 28th identification information not included, the AMF_A 240 may indicate that the network supports the RQoS controlled via the Control Plane, or may indicate that the request to transition to a state in which the RQoS controlled via the Control Plane is available has been accepted.

Furthermore, by transmitting the 21st identification information, and/or by transmitting one or more pieces of identification information of the 22nd to 24th identification information and the 27th to 29th identification information in association with the 25th identification information, the AMF_A 240 may indicate that the network does not support the RQoS for the PDU session established for the DN identified with the fourth identification information and/or the 25th identification information received by the AMF_A 240, or may indicate that the request to transition to a state in which the RQoS is available has been rejected.

Furthermore, by transmitting the 21st identification information, and/or by transmitting one or more pieces of identification information of the 22nd to 24th identification information and the 27th to 29th identification information in association with the 26th identification information, the AMF_A 240 may indicate that the network does not support the RQoS for the PDU session identified with the fifth identification information and/or the 26th identification information received by the AMF_A 240, or may indicate that the request to transition to a state in which the RQoS is available has been rejected.

Furthermore, by transmitting one or more pieces of identification information of the 21st to 29th identification information included in the registration reject message, the AMF_A 240 may indicate that the network does not support the RQoS or may indicate that the request to transition to a state in which the RQoS is available has been rejected, for the Registration Area (RA) and/or the Tracking Area (TA) to which the UE_A 10 is currently belonging.

Furthermore, by transmitting one or more pieces of identification information of the 21st to 29th identification information included in the registration reject message, the AMF_A 240 may indicate that the network does not support the RQoS or may indicate that the request to transition to a state in which the RQoS is available has been rejected, for the access network to which the UE_A 10 is currently connecting.

Furthermore, by transmitting one or more pieces of identification information of the 21st to 29th identification information included in the registration reject message, the AMF_A 240 may indicate that the network does not support the RQoS to be controlled initiatively by UE or may indicate that the request to transition to a state in which the RQoS to be controlled initiatively by UE is available has been rejected.

Furthermore, by transmitting one or more pieces of identification information of the 21st to 29th identification information included in the registration reject message, the AMF_A 240 may indicate that the network does not support the RQoS to be controlled initiatively by network or may indicate that the request to transition to a state in which the RQoS to be controlled initiatively by network is available has been rejected.

Alternatively, by transmitting the 21st identification information, or by transmitting the 22nd identification information, or by transmitting the 23rd identification information and the 24th identification information, or by transmitting the 27th identification information, or by transmitting the 28th identification information and the 29th identification information, or by transmitting one or more pieces of identification information of these pieces of identification information in a case that two or more pieces of identification information of these pieces of identification information are configured as one or more pieces of identification information, the UE_A 10 may indicate that the network does not support the RQoS controlled via the Control Plane and the network does not support the RQoS controlled via the User Plane, or may indicate that the request to transition to a state in which the RQoS controlled via the Control Plane is available has been rejected and the request to transition to a state in which the RQoS controlled via the User Plane is available has been rejected.

Furthermore, by transmitting the 72nd identification information and/or the 25th identification information and/or the 26th identification information included in the registration reject message, the AMF_A 240 may indicate that the request for the establishment of a PDU session belonging to a network slice has been rejected, may indicate a network slice to which the PDU session has not been allowed to belong, or may indicate a network slice to which the PDU session has been rejected to belong.

More particularly, by transmitting the 72nd identification information and the 25th identification information in association with each other, the AMF_A 240 may indicate that a request for establishment of a PDU session belonging to a network slice has been rejected in a PDU session established for a DN identified by the 25th identification information, or may indicate a network slice to which the PDU session is not allowed to belong.

Furthermore, by transmitting the 61st identification information and the 26th identification information in association with each other, the AMF_A 240 may indicate that a request for establishment of a PDU session belonging to a network slice has been rejected in a PDU session identified by the 26th identification information, or may indicate a network slice to which the PDU session is not allowed to belong.

Furthermore, by transmitting the 72nd identification information included in the registration reject message, the AMF_A 240 may indicate that a request for establishment of a PDU session belonging to a network slice has been rejected in a registration area and/or a tracking area to which the UE_A 10 is currently belonging, or may indicate a network slice to which the PDU session is not allowed to belong.

Furthermore, by transmitting the 72nd identification information included in the registration reject message, the AMF_A 240 may indicate that a request for establishment of a PDU session belonging to a network slice has been rejected in an access network to which the UE_A 10 is currently connecting, or may indicate a network slice to which the PDU session is not allowed to belong.

Furthermore, by transmitting the 72nd identification information included in the registration reject message, the AMF_A 240 may indicate the value of the first timer, or may indicate whether or not the same procedure as the present procedure should be performed again after the completion of the present procedure.

Furthermore, the AMF_A 240 may combine and transmit two or more pieces of identification information of the 21st to 29th identification information and/or the 72nd identification information, thereby making a request in which the above-described matters are combined. Note that the matters indicated by the AMF_A 240 transmitting each identification information may not be limited thereto.

Note that the AMF_A 240 may determine which piece of identification information among the 21st to 29th identification information, and the 72nd identification information is included in the registration reject message, based on the received identification information, and/or the capability information of the network, and/or the policy such as the operator policy, and/or the state of the network.

For example, the 21st identification information may be information transmitted in a case that the network does not support the RQoS and/or in a case that one or more pieces of identification information of the first to eighth identification information are received. Furthermore, the 22nd identification information and/or the 27th identification information may be information transmitted in a case that the network does not support the RQoS and/or in a case that the first to third identification information and/or the sixth to eighth identification information are received. Furthermore, the 23rd identification information and/or the 28th identification information may be information transmitted in a case that the network supports the RQoS controlled via the Control Plane and/or in a case that the first to third identification information and/or the sixth to eighth identification information are received. Furthermore, the 24th identification information and/or the 29th identification information may be information transmitted in a case that the network supports the RQoS controlled via the User Plane and/or in a case that the first to third identification information and/or the sixth to eighth identification information are received.

Furthermore, the 25th identification information may be information indicating the same DNN as the DNN indicated by the fourth identification information. Furthermore, the 26th identification information may be information indicating the same PDU session ID as the PDU session ID indicated by the fifth identification information. Further, the 72nd identification information may be information transmitted in a case that the 71st identification information is received and/or in a case that the network slice indicated by the 71st identification information is not allowed by the network. Note that determination performed by the AMF_A 240 as to which piece of identification information is to be included in the registration reject message is not limited to the determination described above.

The UE_A 10 receives the registration reject message. The UE_A 10 performs the second process, based on the reception of the registration reject message (S914). The UE_A 10 may perform the second process based on the completion of the present procedure.

Here, the second process may be a process in which the UE_A 10 recognizes a matter indicated by the AMF_A 240. Furthermore, the second process may be a process in which the UE_A 10 stores the received identification information as a context, or may be a process in which the UE_A 10 transfers the received identification information to a higher layer and/or a lower layer. Furthermore, the second process may be a process in which the UE_A 10 recognizes that the request for the present procedure has been rejected.

Furthermore, in a case that the UE_A 10 receives one or more pieces of identification information of the 21st to 29th identification information, the second process may be a process in which UE_A 10 transitions to a state in which the RQoS validation procedure is executable or that the UE_A 10 maintains the state in which the UE_A 10 does not apply the RQoS.

More specifically, in a case that the UE_A 10 receives the 22nd identification information and/or the 23rd identification information and/or the 27th identification information and/or the 28th identification information, the second process may be a process to transition to a state in which the RQoS validation procedure controlled via the Control Plane is not executable. Furthermore, in a case that the UE_A 10 receives the 22nd identification information and/or the 24th identification information and/or the 27th identification information and/or the 29th identification information, the second process may be a process to transition to a state in which the RQoS validation procedure controlled via the User Plane is not executable.

Furthermore, in a case that the UE_A 10 receives the 72nd identification information, the second process may be a process in which the UE_A 10 configures the value indicated by the 72nd identification information to the first timer value, or may be a process for initiating the first timer with the timer value configured. Furthermore, in a case that the UE_A 10 receives the 72nd identification information, the second process may be a process for performing one or more behaviors of the first to 11th behaviors.

Furthermore, the second process may be a process in which the UE_A 10 initiates the present procedure again after a certain period of time, or may be a process in which the request of the UE_A 10 is to transition to a limited state. Note that the second process may not be limited to these processes.

Furthermore, the UE_A 10 may recognize that a request of the UE_A 10 has been rejected by receiving the registration reject message or not receiving the registration accept message. Each apparatus completes the procedure of (B) in the present procedure based on the transmission and/or reception of the registration reject message.

Each apparatus completes the present procedure (registration procedure), based on the completion of the procedure of (A) or (B) in the present procedure. Note that each apparatus may transition to a state in which the UE_A 10 is registered with the network (RM_REGISTERED state) based on the completion of the procedure of (A) in the present procedure, or may maintain a state in which the UE_A 10 is not registered with the network (RM_DEREGISTERED state) based on the completion of the procedure of (B) in the present procedure. Transition to each state of each apparatus may be performed based on completion of the present procedure, or may be performed based on an establishment of a PDU session.

Furthermore, each apparatus may perform processing based on identification information transmitted and/or received in the present procedure, based on completion of the present procedure. In other words, the UE_A 10 may perform the first process or may perform the second process, based on the completion of the present procedure.

The first determination of whether condition is satisfied may be performed based on identification information, and/or subscriber information, and/or an operator policy included in the registration request message. For example, the first determination of whether condition is satisfied may be true in a case that the network allows a request of the UE_A 10. The first determination of whether condition is satisfied may be false in a case that the network does not allow a request of the UE_A 10. Furthermore, the first determination of whether condition is satisfied may be true in a case that the network of a destination of registration of the UE_A 10 and/or an apparatus in the network supports a function requested by the UE_A 10, and may be false in a case that the network and/or the apparatus does not support the function. Furthermore, the first determination of whether condition is satisfied may be true in a case that it is determined that the network is congested, or may be false in a case that it is determined that the network is not congested. Note that conditions for determining whether the first determination of whether condition is satisfied is true or false may not be limited to the above-described conditions.

The fourth determination of whether condition is satisfied may also be performed based on whether AMF_A 240 has received an SM and may be performed based on whether a SM message is included in the registration request message. For example, the fourth determination of whether condition is satisfied may be true in a case that the AMF_A 240 has received the SM and/or the SM message is included in the registration request message, and may be false in a case that the AMF_A 240 has not received the SM and/or the SM message is not included in the registration request message. Note that conditions for determining whether the fourth determination of whether condition is satisfied is true or false may not be limited to the above-described conditions.

### 1.3.2. Overview of PDU Session Establishment Procedure

Next, an overview of the PDU session establishment procedure performed to establish a PDU session with the DN_A 5 will be described. The PDU session establishment procedure is also referred to as a present procedure below. The present procedure is a procedure for each apparatus to establish the PDU session. Note that each apparatus may perform the present procedure in a state in which the registration procedure is completed or during the registration procedure. In addition, each apparatus may initiate the present procedure in a registered state, or may initiate the present procedure at any timing after the registration procedure. Each apparatus may establish the PDU session, based on completion of the PDU session establishment procedure. Furthermore, each apparatus may perform the present procedure multiple times to establish multiple PDU sessions.

### 1.3.2.1. Example of PDU Session Establishment Procedure

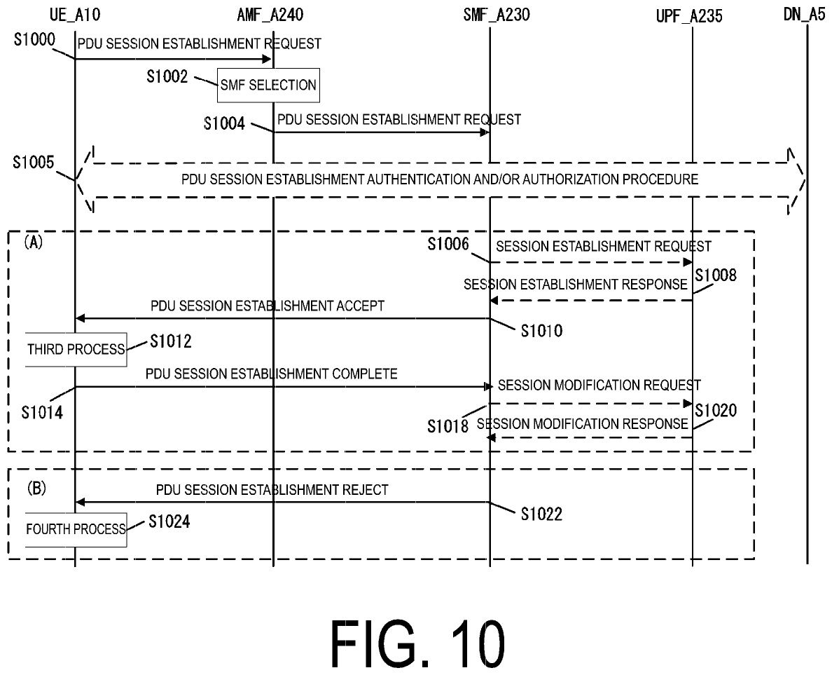

With reference to FIG. 10, an example of a procedure of performing a PDU session establishment procedure will be described. Each step of the present procedure will be described below. First, the UE_A 10 transmits the PDU Session Establishment Request message to the SMF_A 230 via the NR node_A 122 and the AMF_A 240 (S1000), (S1002), and (S1004) to initiate the PDU session establishment procedure.

Specifically, the UE_A 10 transmits the PDU session establishment request message to the AMF_A 240 via the NR node_A 122 using the N1 interface (S1000). In a case that the AMF_A 240 receives the PDU session establishment request message, the AMF_A 240 selects the SMF_A 230 as an NF of a routing destination of the PDU session establishment request message (S1002) and transmits or forwards the PDU session establishment request message to the selected SMF_A 230 using the N11 interface (S1004). Here, the AMF_A 240 may select the SMF_A 230 of the routing destination based on the information included in the PDU session establishment request message. More specifically, the AMF_A 240 may select the SMF_A 230 of the routing destination based on each piece of identification information acquired based on the reception of the PDU session establishment request message, and/or the subscriber information, and/or the capability information of the network, and/or the operator policy, and/or the state of the network, and/or the context already held by the AMF_A 240.

The PDU session establishment request message may be a NAS message. The PDU session establishment request message only needs to be a message requesting the PDU session establishment and not limited to this.

Here, the UE_A 10 may include one or more pieces of identification information of the first identification information to the eighth identification information, the 61st identification information, and the 71st identification information in a PDU session establishment request message, or may indicate a request of the UE_A 10, by including these pieces of identification information. Note that two or more pieces of identification information of these pieces of identification information may be configured as one or more pieces of identification information.

Furthermore, by transmitting one or more pieces of identification information of the first to eighth identification information included in the PDU session establishment request message, the UE_A 10 may indicate that the UE_A 10 supports the RQoS or may request to transition to a state in which the RQoS is available.

Furthermore, by transmitting one or more pieces of identification information of the first to eighth identification information included in the PDU session establishment request message, the UE_A 10 may indicate that the UE_A 10 does not support the RQoS or may indicate not to request to transition to a state in which the RQoS is available.

More particularly, by transmitting the first identification information and/or the second identification information and/or the sixth identification information and/or the seventh identification information included in the PDU session establishment request message, the UE_A 10 may indicate that the UE_A 10 supports the RQoS controlled via the Control Plane, or may request to transition to a state in which the RQoS controlled via the Control Plane is available. In this case, by transmitting the third identification information and/or the eighth identification information not included in the PDU session establishment request message, the UE_A 10 may indicate that the UE_A 10 does not support the RQoS controlled via the User Plane, or may indicate not to request to transition to a state in which the RQoS controlled via the User Plane is available.

By transmitting the first identification information and/or the second identification information and/or the sixth identification information and/or the seventh identification information included in the PDU session establishment request message, the UE_A 10 may indicate that the UE_A 10 does not support the RQoS controlled via the Control Plane, or may indicate not to request to transition to a state in which the RQoS controlled via the Control Plane is available.

Furthermore, by transmitting the first identification information and/or the third identification information and/or the sixth identification information and/or the eighth identification information included in the PDU session establishment request message, the UE_A 10 may indicate that the UE_A 10 supports the RQoS controlled via the User Plane, or may request to transition to a state in which the RQoS controlled via the User Plane is available. In this case, by transmitting the second identification information and/or the seventh identification information not included in the PDU session establishment request message, the UE_A 10 may indicate that the UE_A 10 does not support the RQoS controlled via the Control Plane, or may indicate not to request to transition to a state in which the RQoS controlled via the Control Plane is available.

By transmitting the first identification information and/or the third identification information and/or the sixth identification information and/or the eighth identification information included in the PDU session establishment request message, the UE_A 10 may indicate that the UE_A 10 does not support the RQoS controlled via the User Plane, or may indicate not to request to transition to a state in which the RQoS controlled via the User Plane is available.

Furthermore, by transmitting one or more pieces of identification information of the first to third identification information and the sixth to eight identification information in association with the fourth identification information, the UE_A 10 may indicate whether or not the UE_A 10 supports the RQoS for the PDU session established for the DN identified with the fourth identification information, or may indicate whether or not to request to transition to a state in which the RQoS is available.

Furthermore, by transmitting one or more pieces of identification information of the first to third identification information and the sixth to eight identification information in association with the fifth identification information, the UE_A 10 may indicate whether or not the UE_A 10 supports the RQoS for the PDU session identified with the fifth identification information, or may indicate whether or not to request to transition to a state in which the RQoS is available.

Furthermore, by transmitting one or more pieces of identification information of the first to eighth identification information included in the PDU session establishment request message, the UE_A 10 may indicate whether or not the UE_A 10 supports the RQoS to be controlled initiatively by UE or may indicate whether or not to request to transition to a state in which the RQoS to be controlled initiatively by UE is available.

Furthermore, by transmitting one or more pieces of identification information of the first to eighth identification information included in the PDU session establishment request message, the UE_A 10 may indicate whether or not the UE_A 10 supports the RQoS to be controlled initiatively by network or may indicate whether or not request to transition to a state in which the RQoS to be controlled initiatively by network is available.

Alternatively, by transmitting the first identification information, or by transmitting the second identification information and the third identification information, or by transmitting the sixth identification information, or by transmitting the seventh identification information and the eighth identification information, or by transmitting one or more pieces of identification information of these pieces of identification information in a case that two or more pieces of identification information of these pieces of identification information are configured as one or more pieces of identification information of identification information, the UE_A 10 may indicate that the UE_A 10 supports the RQoS controlled via the Control Plane and the UE_A 10 supports the RQoS controlled via the User Plane, or may request to transition to a state in which the RQoS controlled via the User Plane is available and transition to a state in which the RQoS controlled via the User Plane is available.

Furthermore, by transmitting the 61st identification information and/or the fourth identification information and/or the fifth identification information included in the PDU session establishment request message, the UE_A 10 may request service authentication and/or authorization by the DN via a 3GPP interface (N6 interface, etc.) or request to perform a PDU session establishment authentication and/or authorization procedure in the present procedure.

More specifically, by transmitting the 61st identification information and the fourth identification information in association with each other, the UE_A 10 may request service authentication and/or authorization by the DN_A 5 via the 3GPP interface in the PDU session established for the DN identified by the fourth identification information, or may request to perform the PDU session establishment authentication and/or authorization procedure in the present procedure.

Furthermore, by transmitting the 61st identification information and the fifth identification information in association with each other, the UE_A 10 may request service authentication and/or authorization by the DN_A 5 via the 3GPP interface in the PDU session identified by the fifth identification information, or may request to perform the PDU session establishment authentication and/or authorization procedure in the present procedure.

Furthermore, by transmitting the 71st identification information and/or the fourth identification information and/or the fifth identification information included in the PDU session establishment request message, the UE_A 10 may request establishment of a PDU session belonging to a network slice, may indicate a network slice to which the PDU session belongs which is requested by the UE_A 10, or may indicate a network slice to which the PDU session will belong.

More particularly, by transmitting the 71st identification information and the fourth identification information in association with each other, the UE_A 10 may request establishment of a PDU session belonging to a network slice in a PDU session established for a DN identified by the fourth identification information, may indicate a network slice to which the PDU session belongs which is requested by the UE_A 10, or may indicate a network slice to which the PDU session will belong.

Furthermore, by transmitting the 61st identification information and the fifth identification information in association with each other, the UE_A 10 may request establishment of a PDU session belonging to a network slice in a PDU session identified by the fifth identification information, may indicate a network slice to which the PDU session belongs which is requested by the UE_A 10, or may indicate a network slice to which the PDU session will belong.

Furthermore, the UE_A 10 may combine and transmit two or more pieces of identification information of the first to eighth identification information, the 61st identification information, and the 71st identification information, thereby making a request in which the above-described matters are combined. Note that the matters indicated by the UE_A 10 transmitting each identification information may not be limited thereto.

Note that the UE_A 10 may determine which piece of identification information of the first identification information to the eighth identification information, the 61st identification information, and the 71st identification information is to be included in the PDU session establishment request message, based on the capability information of the UE_A 10, and/or the policy such as the UE policy, and/or the preference of the UE_A 10, and/or the application (higher layer). Note that the determination performed by the UE_A 10 as to which piece of identification information is to be included in the PDU session establishment request message is not limited to the determination described above.

The SMF_A 230 receives the PDU session establishment request message, and performs the third condition determination. The third determination of whether condition is satisfied is to determine whether the SMF_A 230 accepts the request of the UE_A 10. In the third condition determination, the SMF_A 230 determines whether the third condition determination is true or false. In a case that the result of the third determination of whether condition is satisfied is true, the SMF_A 230 initiates the procedure of (A) in the present procedure, and in a case that the result of the third determination of whether condition is satisfied is false, the SMF_A 230 initiates the procedure of (B) in the present procedure. Note that steps in the case that the third determination of whether condition is satisfied is false will be described later.

As follows, steps in a case that the result of the third determination of whether condition is satisfied is true, in other words, each step of the procedure of (A) in the present procedure will be described.

Here, in a case that the SM PDU DN Request Container including the 61st identification information is included in the PDU session establishment request message, and the 61st identification information complies with the local policy and/or the user subscriber information, the SMF_A 230 initiates the PDU session establishment authentication and/or authorization procedure (S1005). On the other hand, in a case that the SM PDU DN Request Container is not included in the PDU session establishment request message, the PDU session establishment authentication and/or authorization procedure is omitted. Note that details of the PDU session establishment authentication and/or authorization procedure will be described later.

Next, the SMF_A 230 that has initiated the PDU session establishment authentication and/or authorization procedure (S1005) transmits the Session Establishment request message to the selected UPF_A 235 (S1006), and initiates the procedure of (A) in the present procedure. Note that the SMF_A 230 may initiate the procedure of (B) in the present procedure without initiating the procedure of (A) in the present procedure, based on the completion of the PDU session establishment authentication and/or authorization procedure.

Here, the SMF_A 230 may select one or more UPFs_A 235 based on each piece of identification information acquired based on the reception of the PDU session establishment request message, and/or the capability information of the network, and/or the subscriber information, and/or the operator policy, and/or the state of the network, and/or the context already held by the SMF_A 230. Note that in a case that multiple UPFs_A 235 are selected, the SMF_A 230 may transmit the session establishment request message to each UPF_A 235.

The UPF_A 235 receives the session establishment request message and creates a context for the PDU session. In addition, the UPF_A 235 transmits the Session Establishment response message to the SMF_A 230 based on the reception of the session establishment request message and/or the creation of the context for the PDU session (S1008). Furthermore, the SMF_A 230 receives a session establishment response message. Note that the session establishment request message and the session establishment response message may be control messages transmitted and/or received on the N4 interface. Further, the session establishment response message may be a response message to the session establishment request message.

Further, the SMF_A 230 may assign an address to be assigned to the UE_A 10 based on the reception of the PDU session establishment request message and/or the selection of the UPF_A 235 and/or the reception of the session establishment response message. Note that the SMF_A 230 may assign the address to be assigned to the UE_A 10 during the PDU session establishment procedure, or may assign the address after the completion of the PDU session establishment procedure.

Specifically, in a case that the SMF_A 230 assigns the IPv4 address without using the DHCPv4, the SMF_A 230 may assign the address during the PDU session establishment procedure or may transmit the assigned address to the UE_A 10. In addition, in a case that the SMF_A 230 assigns the IPv4 address, and/or the IPv6 address, and/or the IPv6 prefix using the DHCPv4 or the DHCPv6 or Stateless Address Autoconfiguration (SLAAC), the SMF_A 230 may assign the address after the PDU session establishment procedure or may transmit the assigned address to the UE_A 10. Note that the address allocation performed by SMF_A 230 is not limited to these.

Furthermore, the SMF_A 230 may transmit the assigned address included in the PDU session establishment accept message to the UE_A 10, or may transmit the assigned address to the UE_A 10 after completion of the PDU session establishment procedure, based on the completion of the address allocation of the address to assign to the UE_A 10.

The SMF_A 230 transmits the PDU session establishment accept message to the UE_A 10 via the AMF_A 240, based on the reception of the PDU session establishment request message, and/or the selection of the UPF_A 235, and/or the reception of the session establishment response message, and/or the completion of the address assignment of the address to be assigned to the UE_A 10 (S1010).

Specifically, the SMF_A 230 transmits the PDU session establishment accept message to the AMF_A 240 using the N11 interface. The AMF_A 240 that has received the PDU session establishment accept message transmits the PDU session establishment accept message to the UE_A 10 using the N1 interface.

Note that in a case that the PDU session is PDN connection, the PDU session establishment accept message may be a PDN connectivity accept message. Furthermore, the PDU session establishment accept message may be a NAS message transmitted and/or received on the N11 interface and the N1 interface. The PDU session establishment accept message is not limited to the PDU session establishment accept message described above, and only needs to be a message indicating the acceptance of the establishment of the PDU session.

Here, the SMF_A 230 may include one or more pieces of identification information among the 11th identification information to the 19th identification information in the PDU session establishment accept message, or the inclusion of these pieces of identification information may indicate the acceptance of the request of the UE_A 10. Note that two or more pieces of identification information of these pieces of identification information may be configured as one or more pieces of identification information.

Furthermore, by transmitting one or more pieces of identification information of the 11th to 19th identification information included in the PDU session establishment accept message, the SMF_A 230 may indicate that the network supports the RQoS or may indicate that the request to transition to a state in which the RQoS is available has been accepted.

More particularly, by transmitting the 11th identification information and/or the 12th identification information and/or the 17th identification information and/or the 18th identification information included in the PDU session establishment accept message, the SMF_A 230 may indicate that the network supports the RQoS controlled via the Control Plane, or may indicate that the request to transition to a state in which the RQoS controlled via the Control Plane is available has been accepted. In this case, by transmitting the 13th identification information and/or the 19th identification information not included in the PDU session establishment accept message, the SMF_A 230 may indicate that the network does not support the RQoS controlled via the User Plane, or may indicate that the request to transition to a state in which the RQoS controlled via the User Plane is available has been rejected.

By transmitting the 11th identification information and/or the 12th identification information and/or the 17th identification information and/or the 18th identification information included in the PDU session establishment accept message, the SMF_A 230 may indicate that the network does not support the RQoS controlled via the Control Plane, or may indicate that the request to transition to a state in which the RQoS controlled via the Control Plane is available has been rejected.

Furthermore, by transmitting the 11th identification information and/or the 13th identification information and/or the 17th identification information and/or the 19th identification information included in the PDU session establishment accept message, the SMF_A 230 may indicate that the network supports the RQoS controlled via the User Plane, or may indicate that the request to transition to a state in which the RQoS controlled via the User Plane is available has been accepted. In this case, by transmitting the 12th identification information and/or the 18th identification information not included in the registration accept message, the SMF_A 230 may indicate that the network does not support the RQoS controlled via the Control Plane, or may indicate that the request to transition to a state in which the RQoS controlled via the Control Plane is available has been rejected.

By transmitting the 11th identification information and/or the 13th identification information and/or the 17th identification information and/or the 19th identification information included in the PDU session establishment accept message, the SMF_A 230 may indicate that the network does not support the RQoS controlled via the User Plane, or may indicate that the request to transition to a state in which the RQoS controlled via the User Plane is available has been rejected.

Furthermore, by transmitting one or more pieces of identification information of the 11th to 13th identification information and the 17th to 19th identification information in association with the 14th identification information, the SMF_A 230 may indicate whether or not the network supports the RQoS for the PDU session established for the DN identified with the 14th identification information, or may indicate whether or not the request to transition to a state in which the RQoS is available has been accepted.

Furthermore, by transmitting one or more pieces of identification information of the 11th to 13th identification information and the 17th to 19th identification information in association with the 15th identification information, the SMF_A 230 may indicate whether or not the network supports the RQoS for the PDU session identified with the 15th identification information, or may indicate whether or not the request to transition to a state in which the RQoS is available has been accepted.

Furthermore, by transmitting one or more pieces of identification information of the 11th to 19th identification information included in the PDU session establishment accept message, the SMF_A 230 may indicate whether or not the network supports the RQoS to be controlled initiatively by UE or may indicate whether or not the request to transition to a state in which the RQoS to be controlled initiatively by UE is available has been accepted.

Furthermore, by transmitting one or more pieces of identification information of the 11th to 19th identification information included in the PDU session establishment accept message, the SMF_A 230 may indicate whether or not the network supports the RQoS to be controlled initiatively by network or may indicate whether or not the request to transition to a state in which the RQoS to be controlled initiatively by network is available has been accepted.

Furthermore, by transmitting one or more pieces of identification information of the 11th to 15th identification information and the 17th to 19th identification information in association with the 16th identification information, the SMF_A 230 may indicate an effective period of the RQoS to be applied to the user data communication, may indicate a period in which the RQoS is effective after the validation of the RQoS for the user data communication, or may indicate a period until the RQoS timer started in a case that the RQoS for the user data communication is validated expires.

Alternatively, by transmitting the 11th identification information, or by transmitting the 12th identification information and the 13th identification information, or by transmitting the 17th identification information, or by transmitting the 18th identification information and the 19th identification information, or by transmitting one or more pieces of identification information of these pieces of identification information in a case that two or more pieces of identification information of these pieces of identification information are configured as one or more pieces of identification information of identification information, the UE_A 10 may indicate that the network supports the RQoS controlled via the Control Plane and the network supports the RQoS controlled via the User Plane, or may indicate that the request to transition to a state in which the RQoS controlled via the Control Plane is available has been accepted and the request to transition to a state in which the RQoS controlled via the User Plane is available has been accepted.

Furthermore, the SMF_A 230 may combine and transmit two or more pieces of identification information of the 11th to 19th identification information, thereby making a request in which the above-described matters are combined. Note that the matters indicated by the SMF_A 230 transmitting each identification information may not be limited thereto.

Note that the SMF_A 230 may determine which piece of identification information among the 11th identification information to the 19th identification information is to be included in the PDU session establishment accept message, based on the received identification information, and/or the capability information of the network, and/or the policy such as the operator policy, and/or the state of the network.

For example, the 11th identification information and/or the 17th identification information may be information transmitted in a case that the network supports the RQoS and/or in a case that the first to third identification information and/or the sixth to eighth identification information are received. Furthermore, the 12th identification information and/or the 18th identification information may be information transmitted in a case that the network supports the RQoS controlled via the Control Plane and/or in a case that the first to third identification information and/or the sixth to eighth identification information are received. Furthermore, the 13th identification information and/or the 19th identification information may be information transmitted in a case that the network supports the RQoS controlled via the User Plane and/or in a case that the first to third identification information and/or the sixth to eighth identification information are received.

Furthermore, the 14th identification information may be information indicating the same DNN as the DNN indicated by the fourth identification information, or may be information indicating a different DNN. Furthermore, the 15th identification information may be information indicating the same PDU session ID as the PDU session ID indicated by the fifth identification information, or may be information indicating a different PDU session ID. Note that determination performed by the SMF_A 230 as to which piece of identification information is to be included in the PDU session establishment accept message is not limited to the determination described above.

The UE_A 10 receives a PDU session establishment accept message. The UE_A 10 receives the PDU session establishment accept message and recognizes the contents of various types of identification information included in the PDU session establishment accept message.

The UE_A 10 further performs the third process, based on the reception of the PDU session establishment accept message (S1012). Note that the UE_A 10 may perform the third process based on the transmission of the PDU session establishment complete message, or may perform the third process based on the completion of the present procedure.

Here, the third process may be a process in which the UE_A 10 recognizes a matter indicated by the SMF_A 230. Furthermore, the third process may be a process in which the UE_A 10 stores the received identification information as a context, or may be a process in which the UE_A 10 transfers the received identification information to a higher layer and/or a lower layer. Furthermore, the third process may be a process in which the UE_A 10 recognizes that the request for the present procedure has been accepted.

In addition, in a case that the UE_A 10 receives one or more pieces of identification information of the 11th to 19th identification information, the third process may be a process in which the UE_A 10 transitions to a state in which the RQoS validation procedure is executable at any timing, or may be a process to initiate the RQoS validation procedure.

More specifically, in a case that the UE_A 10 receives the 11th identification information and/or the 12th identification information and/or the 17th identification information and/or the 18th identification information, the third process may be a process to transition to a state in which the RQoS validation procedure controlled via the Control Plane is executable at any timing. Furthermore, in a case that the UE_A 10 receives the 11th identification information and/or the 13th identification information and/or the 17th identification information and/or the 19th identification information, the third process may be a process to transition to a state in which the RQoS validation procedure controlled via the User Plane is executable at any timing.

Furthermore, in a case that the UE_A 10 receives one or more pieces of identification information of the 11th to 19th identification information, as well as the 16th identification information, the third process may be a process in which the UE_A 10 configures the value indicated by the 16th identification information to the timer value of the RQoS. Note that the third process may not be limited to these processes.

Next, the UE_A 10 transmits the PDU session establishment complete message to the SMF_A 230 via the AMF_A 240, based on the reception of the PDU session establishment accept message and/or the completion of the third process (S1014). Furthermore, the SMF_A 230 receives the PDU session establishment complete message, and performs the second determination of whether condition is satisfied.

Specifically, the UE_A 10 transmits the PDU session establishment complete message to the AMF_A 240 using the N1 interface. The AMF_A 240 that has received the PDU session establishment complete message transmits the PDU session establishment complete message to the SMF_A 230 using the N11 interface.

Note that in a case that the PDU session is PDN connection, the PDU session establishment complete message may be a PDN Connectivity complete message, or may be an Activate default EPS bearer context accept message. Furthermore, the PDU session establishment complete message may be a NAS message transmitted and/or received on the N1 interface and the N11 interface. The PDU session establishment complete message only needs to be a response message to the PDU session establishment accept message. However, the PDU session establishment complete message is not limited to this, and only needs to be a message indicating that the PDU session establishment procedure is completed.

The second condition determination is for the SMF_A 230 to determine a type of the message on the N4 interface to be transmitted and/or received. In a case that the second condition determination is true, the SMF_A 230 transmits a Session Modification request message to the UPF_A 235 (S1018). In addition, the SMF_A 230 receives a Session Modification response message transmitted from the UPF_A 235 that has received the Session Modification request message (S1020). In a case that the second condition determination is false, the SMF_A 230 transmits a session establishment request message to the UPF_A 235 (S1018), and further receives the session modification accept message transmitted from the UPF_A 235 that has received the session establishment request message (S1020).

Each apparatus completes the procedure of (A) in the present procedure, based on the transmission and/or reception of the PDU session establishment complete message, and/or the transmission and/or reception of a session modification response message, and/or the transmission and/or reception of the session establishment response message, and/or the transmission and/or reception of the RA.

Next, steps in a case that the third determination of whether condition is satisfied is false, in other words, each step of the procedure of (B) in the present procedure will be described. The SMF_A 230 transmits the PDU session establishment reject message to the UE_A 10 via the AMF_A 240 (S1022), and initiates the procedure of (B) in the present procedure.

Specifically, the SMF_A 230 transmits the PDU session establishment reject message to the AMF_A 240 using the N11 interface, and the AMF_A 240 that has received the PDU session establishment request message transmits the PDU session establishment reject message to the UE_A 10 using the N1 interface.

Note that in a case that the PDU session is PDN connection, the PDU session establishment reject message may be a PDN Connectivity reject message. Furthermore, the PDU session establishment reject message may be a NAS message transmitted and/or received on the N11 interface and the N1 interface. The PDU session establishment reject message is not limited to the PDU session establishment reject message described above, and only needs to be a message indicating that the PDU session establishment has been rejected.

Here, the SMF_A 230 may include one or more pieces of identification information among the 21st identification information to the 29th identification information, and the 72nd identification information in the PDU session establishment reject message, or may indicate that the request of the UE_A 10 has been rejected by including these pieces of identification information. Note that two or more pieces of identification information of these pieces of identification information may be configured as one or more pieces of identification information.

Furthermore, by transmitting one or more pieces of identification information of the 21st to 29th identification information included in the PDU session establishment reject message, the SMF_A 230 may indicate that the network does not support the RQoS or may indicate that the request to transition to a state in which the RQoS is available has been rejected.

More particularly, by transmitting the 21st identification information and/or the 22nd identification information and/or the 23rd identification information and/or the 27th identification information and/or the 28th identification information included in the PDU session establishment reject message, the SMF_A 230 may indicate that the network does not support the RQoS controlled via the Control Plane, or may indicate that the request to transition to a state in which the RQoS controlled via the Control Plane is available has been rejected. In this case, by transmitting the 24th identification information and/or the 29th identification information not included in the registration reject message, the SMF_A 230 may indicate that the network supports the RQoS controlled via the User Plane, or may indicate that the request to transition to a state in which the RQoS controlled via the User Plane is available has been accepted.

Furthermore, by transmitting the 21st identification information and/or the 22nd identification information and/or the 24th identification information and/or the 27th identification information and/or the 29th identification information included in the PDU session establishment reject message, the SMF_A 230 may indicate that the network does not support the RQoS controlled via the User Plane, or may indicate that the request to transition to a state in which the RQoS controlled via the User Plane is available has been rejected. In this case, by transmitting the 23rd identification information and/or the 28th identification information not included, the SMF_A 230 may indicate that the network supports the RQoS controlled via the Control Plane, or may indicate that the request to transition to a state in which the RQoS controlled via the Control Plane is available has been accepted.

Furthermore, by transmitting the 21st identification information, and/or by transmitting one or more pieces of identification information of the 22nd to 24th identification information and the 27th to 29th identification information in association with the 25th identification information, the SMF_A 230 may indicate that the network does not support the RQoS for the PDU session established for the DN identified with the fourth identification information and/or the 25th identification information received by the SMF_A 230, or may indicate that the request to transition to a state in which the RQoS is available has been rejected.

Furthermore, by transmitting the 21st identification information, and/or by transmitting one or more pieces of identification information of the 22nd to 24th identification information and the 27th to 29th identification information in association with the 26th identification information, the SMF_A 230 may indicate that the network does not support the RQoS for the PDU session identified with the fifth identification information or the 26th identification information received by the SMF_A 230, or may indicate that the request to transition to a state in which the RQoS is available has been rejected.

Furthermore, by transmitting one or more pieces of identification information of the 21st to 29th identification information included in the PDU session establishment reject message, the SMF_A 230 may indicate that the network does not support the RQoS or may indicate that the request to transition to a state in which the RQoS is available has been rejected, for the registration area and/or the tracking area to which the UE_A 10 is currently belonging.

Furthermore, by transmitting one or more pieces of identification information of the 21st to 29th identification information included in the PDU session establishment reject message, the SMF_A 230 may indicate that the network does not support the RQoS or may indicate that the request to transition to a state in which the RQoS is available has been rejected, for the access network to which the UE_A 10 is currently connecting.

Furthermore, by transmitting one or more pieces of identification information of the 21st to 29th identification information included in the PDU session establishment reject message, the SMF_A 230 may indicate that the network does not support the RQoS to be controlled initiatively by UE or may indicate that the request to transition to a state in which the RQoS to be controlled initiatively by UE is available has been rejected. Furthermore, by transmitting one or more pieces of identification information of the 21st to 29th identification information included in the PDU session establishment reject message, the SMF_A 230 may indicate that the network does not support the RQoS to be controlled initiatively by network or may indicate that the request to transition to a state in which the RQoS to be controlled initiatively by network is available has been rejected.

Alternatively, by transmitting the 21st identification information, or by transmitting the 22nd identification information, or by transmitting the 23rd identification information and the 24th identification information, or by transmitting the 27th identification information, or by transmitting the 28th identification information and the 29th identification information, or by transmitting one or more pieces of identification information of these pieces of identification information in a case that two or more pieces of identification information of these pieces of identification information are configured as one or more pieces of identification information of identification information, the UE_A 10 may indicate that the network does not support the RQoS controlled via the Control Plane and the network does not support the RQoS controlled via the User Plane, or may indicate that the request to transition to a state in which the RQoS controlled via the Control Plane is available has been rejected and the request to transition to a state in which the RQoS controlled via the User Plane is available has been rejected.

Furthermore, by transmitting the 72nd identification information and/or the 25th identification information and/or the 26th identification information included in the PDU session establishment reject message, the SMF_A 230 may indicate that the request for the establishment of a PDU session belonging to a network slice has been rejected, or may indicate a network slice to which the PDU session has not been allowed to belong.

More particularly, by transmitting the 72nd identification information and the 25th identification information in association with each other, the SMF_A 230 may indicate that a request for establishment of a PDU session belonging to a network slice has been rejected in a PDU session established for a DN identified by the 25th identification information, or may indicate a network slice to which the PDU session is not allowed to belong.

Furthermore, by transmitting the 61st identification information and the 26th identification information in association with each other, the SMF_A 230 may indicate that a request for establishment of a PDU session belonging to a network slice has been rejected in a PDU session identified by the 26th identification information, or may indicate a network slice to which the PDU session is not allowed to belong.

Furthermore, by transmitting the 72nd identification information included in the PDU session establishment reject message, the SMF_A 230 may indicate that a request for establishment of a PDU session belonging to a network slice has been rejected in a registration area and/or a tracking area to which the UE_A 10 is currently belonging, or may indicate a network slice to which the PDU session is not allowed to belong.

Furthermore, by transmitting the 72nd identification information included in the PDU session establishment reject message, the SMF_A 230 may indicate that a request for establishment of a PDU session belonging to a network slice has been rejected in an access network to which the UE_A 10 is currently connecting, or may indicate a network slice to which the PDU session is not allowed to belong.

Furthermore, by transmitting the 72nd identification information included in the PDU session establishment reject message, the SMF_A 230 may indicate the value of the first timer, or may indicate whether or not the same procedure as the present procedure should be performed again after the completion of the present procedure.

Furthermore, the SMF_A 230 may combine and transmit two or more pieces of identification information of the 21st to 29th identification information and/or the 72nd identification information, thereby making a request in which the above-described matters are combined. Note that the matters indicated by the SMF_A 230 transmitting each identification information may not be limited thereto.

Note that the SMF_A 230 may determine which piece of identification information among the 21st identification information to the 29th identification information, and the 72nd identification information is to be included in the PDU session establishment reject message, based on the received identification information, and/or the capability information of the network, and/or the policy such as the operator policy, and/or the state of the network.

For example, the 21st identification information may be information transmitted in a case that the network does not support the RQoS and/or in a case that one or more pieces of identification information of the first to eighth identification information are received. Furthermore, the 22nd identification information and/or the 27th identification information may be information transmitted in a case that the network does not support the RQoS and/or in a case that the first to third identification information and/or the sixth to eighth identification information are received. Furthermore, the 23rd identification information and/or the 28th identification information may be information transmitted in a case that the network supports the RQoS controlled via the Control Plane and/or in a case that the first to third identification information and/or the sixth to eighth identification information are received. Furthermore, the 24th identification information and/or the 29th identification information may be information transmitted in a case that the network supports the RQoS controlled via the User Plane and/or in a case that the first to third identification information and/or the sixth to eighth identification information are received.

Furthermore, the 25th identification information may be information indicating the same DNN as the DNN indicated by the fourth identification information. Furthermore, the 26th identification information may be information indicating the same PDU session ID as the PDU session ID indicated by the fifth identification information. Further, the 72nd identification information may be information transmitted in a case that the 71st identification information is received and/or in a case that the network slice indicated by the 71st identification information is not allowed by the network. Note that determination performed by the SMF_A 230 as to which piece of identification information is to be included in the PDU session establishment reject message is not limited to the determination described above.

The UE_A 10 receives a PDU session establishment reject message. The UE_A 10 performs the fourth process, based on the reception of the PDU session establishment reject message (S1024). The UE_A 10 may perform the fourth process based on the completion of the present procedure.

Here, the fourth process may be a process in which the UE_A 10 recognizes a matter indicated by the SMF_A 230. Furthermore, the fourth process may be a process in which the UE_A 10 stores the received identification information as a context, or may be a process in which the UE_A 10 transfers the received identification information to a higher layer and/or a lower layer. Furthermore, the fourth process may be a process in which the UE_A 10 recognizes that the request for the present procedure has been rejected.

Furthermore, in a case that the UE_A 10 receives one or more pieces of identification information of the 21st to 29th identification information, the fourth process may be a process in which UE_A 10 transitions to a state in which the RQoS validation procedure is executable or that the UE_A 10 maintains the state in which the UE_A 10 does not apply the RQoS.

More specifically, in a case that the UE_A 10 receives the 22nd identification information and/or the 23rd identification information and/or the 27th identification information and/or the 28th identification information, the fourth process may be a process to transition to a state in which the RQoS validation procedure controlled via the Control Plane is not executable. Furthermore, in a case that the UE_A 10 receives the 22nd identification information and/or the 24th identification information and/or the 27th identification information and/or the 29th identification information, the fourth process may be a process to transition to a state in which the RQoS validation procedure controlled via the User Plane is not executable.

Furthermore, in a case that the UE_A 10 receives the 72nd identification information, the fourth process may be a process in which the UE_A 10 configures the value indicated by the 72nd identification information to the first timer value, or may be a process for initiating the first timer with the timer value configured. Furthermore, in a case that the UE_A 10 receives the 72nd identification information, the fourth process may be a process for performing one or more behaviors of the first to 11th behaviors.

Furthermore, the fourth process may be a process in which the UE_A 10 initiates the present procedure again after a certain period of time, or may be a process in which the request of the UE_A 10 to transition to a limited state.

Furthermore, in a case that the 21st identification information indicates User authentication or authorization failed, the fourth process may be a process for inhibiting the process of performing the reconnection of the PDU session using the same information as the DNN and/or the S-NSSAI/or the user identity used in the PDU session establishment procedure rejected for the reject cause indicated by the 21st identification information.

For example, in a case that the UE_A 10 transmits a first PDU session establishment request message (S1000) using user identity #A indicated by the 61st identification information, for DNN #A and/or S-NSSAI #A and/or mapped configured S-NSSAI #A from the configured NSSAI for the HPLMN, and receives the PDU session establishment reject message (S1002) including the 21st identification information indicating User authentication or authorization failed from the network, the UE_A 10 may recognize that the establishment request of the PDU session has been rejected for the cause of User authentication or authorization failed.

Note that the condition determination that the SMF_A 230 rejects by User authentication or authorization failed may be determined based on the third condition determination.

At this time, the UE_A 10 may be configured to be restricted for the transmission of the second PDU session establishment request message using the 61st identification information indicating the user identity #A, for the DNN #A and/or the S-NSSAI #A and/or the mapped configured S-NSSAI #A from the configured NSSAI for the HPLMN.

Furthermore, the fourth process may be a procedure in which the UE_A 10 does not automatically perform reconnection using another PDU session establishment request message intended for the DNN #A and/or the S-NSSAI #A and/or the mapped configured S-NSSAI #A from the configured NSSAI for the HPLMN transmitted in the first PDU session establishment request message (1000), until the user identity indicated by the 61st identification information used in the first PDU session establishment request message (1000) is changed and/or terminal power on/off and/or extraction and/or insertion of Universal Subscriber Identity Module (USIM).

The condition of reconnection by the UE_A 10 is not limited to these conditions.

For example, in a case that the UE_A 10 transmits a first PDU session establishment request message (S1000) using user identity #A indicated by the 61st identification information, for DNN #A and/or S-NSSAI #A and/or mapped configured S-NSSAI #A from the configured NSSAI for the HPLMN, and receives the PDU session establishment reject message (S1002) including the 21st identification information indicating User authentication or authorization failed from the network, the UE_A 10 may be configured to be restricted for the transmission of the second PDU session establishment request message using the 61st identification information indicating the user identity #A, and in a case of changing to a user identity different from the user identity #A, during restriction of the transmission of the second PDU session establishment request message, the UE_A 10 may be configured to be allowed for the transmission of another PDU session establishment request message using the 61st identification information indicating a user identity different from the user identity #A intended for the DNN #A and/or the S-NSSAI #A and/or the mapped configured S-NSSAI #A from the configured NSSAI for the HPLMN transmitted in the first PDU session establishment request message (1000).

In a case that the UE_A 10 transmits a first PDU session establishment request message (S1000) using user identity #A indicated by the 61st identification information, for DNN #A and/or S-NSSAI #A and/or mapped configured S-NSSAI #A from the configured NSSAI for the HPLMN, and receives the PDU session establishment reject message (S1002) including the 21st identification information indicating User authentication or authorization failed from the network, the UE_A 10 may be configured to be restricted for the transmission of the second PDU session establishment request message using the 61st identification information indicating the user identity #A, and in a case that terminal power is turned on/off, during restriction of the transmission of the second PDU session establishment request message, the UE_A 10 may be configured to be allowed for the transmission of another PDU session establishment request message using the 61st identification information intended for the DNN #A and/or the S-NSSAI #A and/or the mapped configured S-NSSAI #A from the configured NSSAI for the HPLMN transmitted in the first PDU session establishment request message (1000). At this time, the user identity indicated by the 61st identification information may be the user identity #A or may be a user identity different from the user identity #A.

In a case that the UE_A 10 transmits a first PDU session establishment request message (S1000) using user identity #A indicated by the 61st identification information, for DNN #A and/or S-NSSAI #A and/or mapped configured S-NSSAI #A from the configured NSSAI for the HPLMN, and receives the PDU session establishment reject message (S1002) including the 21st identification information indicating User authentication or authorization failed from the network, the UE_A 10 may be configured to be restricted for the transmission of the second PDU session establishment request message using the 61st identification information indicating the user identity #A, and in a case that extraction and/or insertion of Universal Subscriber Identity Module (USIM) is performed, during restriction of the transmission of the second PDU session establishment request message, the UE_A 10 may be configured to be allowed for the transmission of another PDU session establishment request message using the 61st identification information intended for the DNN #A and/or the S-NSSAI #A and/or the mapped configured S-NSSAI #A from the configured NSSAI for the HPLMN transmitted in the first PDU session establishment request message (1000). At this time, the user identity indicated by the 61st identification information may be the user identity #A or may be a user identity different from the user identity #A.

Note that the user identity indicated by the 61st identification information included in the reconnection using the PDU session establishment request message described above is not limited to the user identity indicated by the 61st identification information used in the first PDU session establishment request message (1000). For example, even in a case that user identity #B different from the user identity #A is used in the 61st identification information, the reconnection using the PDU session establishment request message may be configured to be restricted.

Note that the fourth process may not be limited to these processes.

Furthermore, the UE_A 10 may recognize that a request of the UE_A 10 has been rejected by receiving the PDU session establishment reject message or not receiving the PDU session establishment accept message. Each apparatus completes the procedure of (B) in the present procedure, based on transmission and/or reception of the PDU session establishment reject message.

Each apparatus completes the present procedure, based on completion of the procedure of (A) or (B) in the present procedure. Note that each apparatus may transition to a state in which the PDU session is established, based on the completion of the procedure of (A) in the present procedure. Each apparatus may recognize that the present procedure has been rejected, or may transition to a state in which the PDU session is not established, based on the completion of the procedure of (B) in the present procedure.

Furthermore, each apparatus may perform processing based on identification information transmitted and/or received in the present procedure, based on completion of the present procedure. In other words, the UE_A 10 may perform the third process or may perform the fourth process, based on the completion of the present procedure.

The third determination of whether condition is satisfied may be performed based on the identification information included in the PDU session establishment request message, and/or the subscriber information, and/or the operator policy. For example, the third condition determination may be true in a case that the network allows authentication and/or authorization by the DN_A 5 to be performed during the present procedure. The third condition determination may be false in a case that the network does not allow authentication and/or authorization by the DN_A 5 to be performed during the present procedure. Furthermore, in a case that the network as the connection destination of the UE_A 10 and/or the apparatus in the network supports to perform authentication and/or authorization by the DN_A 5 in the present procedure, the third condition determination may be true, and in a case that it is not supported, the third condition determination may be false. Furthermore, the third condition determination may be true in a case that the SM PDU DN Request Container including the 61st identification information is included in the PDU session establishment request message, and the 61st identification information complies with the local policy and/or the user subscriber information. The third condition determination may also be true in a case that the SM PDU DN Request Container is not included in the PDU session establishment request message. On the other hand, the third condition determination may be false in a case that the SM PDU DN Request Container including the 61st identification information is included in the PDU session establishment request message, and the 61st identification information does not comply with the local policy and/or the user subscriber information. Note that conditions for determining whether the third determination of whether condition is satisfied is true or false may not be limited to the above-described conditions. Note that conditions for determining whether the third determination of whether condition is satisfied is true or false may not be limited to the above-described conditions.

The second condition determination may be performed based on whether the session on the N4 interface for the PDU session has been established. For example, in a case that the session on the N4 interface for the PDU session has been established, the second condition determination may be true, and in a case that the session on the N4 interface for the PDU session is not established, the second condition determination may be false. Conditions for determining true or false of the second determination of whether condition is satisfied need not be limited to the above-described conditions.

1.3.3. Overview of PDU Session Establishment Authentication and/or Authorization Procedure

Next, an overview of the PDU session establishment authentication and/or authorization procedure performed by the DN_A 5 to implement authentication and/or authorization for the PDU session will be described. The PDU session establishment authentication and/or authorization procedure is also referred to as a present procedure below. The procedure is a procedure for the DN_A 5 and/or an apparatus in the DN_A 5 to perform authentication and/or authorization for the PDU session. Note that each apparatus may perform the present procedure in a state in which the PDU session is established or during the PDU session establishment procedure. For example, the SMF_A 230 may initiate the present procedure at least in a case that the PDU session establishment request message including the 61st identification information is received in the registration procedure and/or the PDU session establishment procedure. The SMF_A 230 may initiate the present procedure in case that the 21st condition determination is true in the registration procedure and/or the PDU session establishment procedure.

Each apparatus may initiate the present procedure in a state in which the PDU session establishment procedure is completed, or may initiate the present procedure at any timing after the PDU session establishment procedure. Each apparatus may transition to a state in which the PDU session is authenticated and/or authorized by the DN_A 5 and/or the apparatus in the DN_A 5, based on the completion of the PDU session establishment authentication and/or authorization procedure.

1.3.3.1. PDU Session Establishment Authentication and/or Authorization Procedure Example

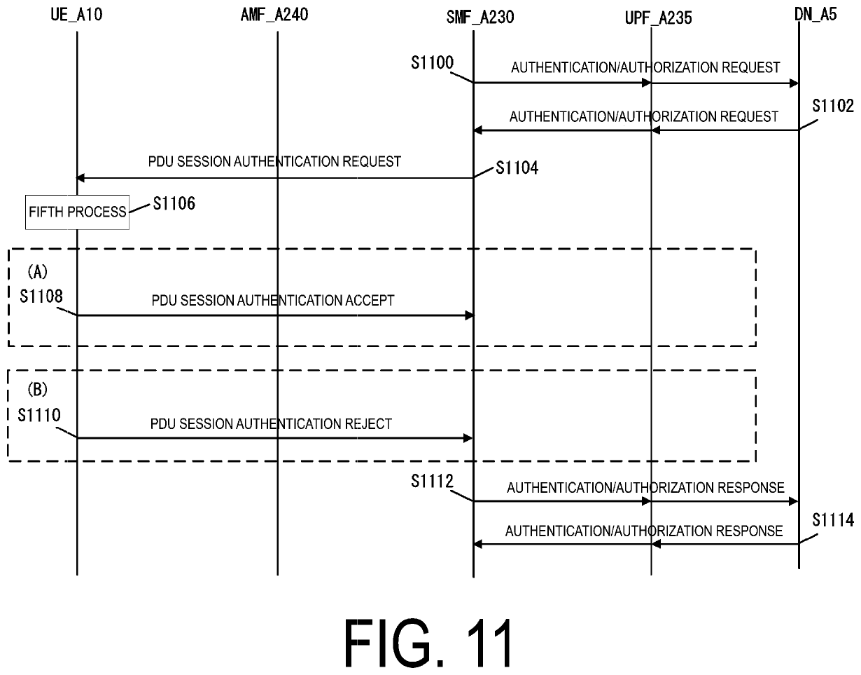

With reference to FIG. 11, an example of a procedure of performing the PDU session establishment authentication and/or authorization procedure will be described. Each step of the present procedure will be described below. First, the SMF_A 230 initiates the PDU session establishment authentication and/or authorization procedure by transmitting an Authentication and/or authorization Request message (S1100) to the DN_A 5 and/or the apparatus in the DN_A 5 via the UPF_A 235.

Specifically, the SMF_A 230 selects the UPF_A 235 and/or the DN_A 5 and/or the apparatus in the DN_A 5, and transmits the authentication and/or authorization request message to the selected UPF_A 235 using the N4 interface. In a case that the UPF_A 235 receives the authentication and/or authorization request message, the UPF_A 235 transmits or forwards the authentication and/or authorization request message to the DN_A 5 and/or the apparatus in the DN_A 5 using the N6 interface. Here, the SMF_A 230 may select the UPF_A 235 and/or the DN_A 5 and/or the apparatus in the DN_A 5, based on information received from the UE_A 10 and/or the apparatus in the core network and/or information held by the SMF_A 230. More specifically, the SMF_A 230 may select the DN_A 5 and/or the DN_A 5, based on each piece of identification information acquired based on the reception of the PDU session establishment request message, information acquired by inquiry to the apparatus in the core network, and/or the subscriber information, and/or the capability information of the network, and/or the operator policy, and/or the state of the network, and/or the context already held by the AMF_A 240.

The PDU session establishment request message may be a NAS message. The PDU session establishment request message only needs to be a message requesting the PDU session establishment and not limited to this.

Furthermore, the authentication and/or authorization resource public release for the DN_A 5 including the authentication and/or authorization request message exchange may be an Application Programming Interface (API) that the operator provides to the DN_A 5 and/or a service operator providing service on the DN_A 5. Note that the authentication and/or authorization request message may be a message that is transmitted and/or received between the SMF_A 230 and/or the UPF_A 235 and the DN_A 5 and/or the apparatus included in the DN_A 5, and that requests authentication and/or authorization by the DN_A 5, but not limited to this.

Here, the SMF_A 230 may transmit the information received from the UE_A 10 and/or the apparatus in the core network and/or information held by the SMF_A 230 included in the authentication and/or authorization request message, or may include these pieces of identification information to indicate the request of the UE_A 10 and/or the SMF_A 230.

The DN_A 5 and/or the apparatus in the DN_A 5 receive the authentication and/or authorization request message. The DN_A 5 and/or the apparatus in the DN_A 5 may perform the 21st condition determination, based on the reception of the authentication and/or authorization request message. The 21st condition determination is for determining whether the DN_A 5 and/or the apparatus in the DN_A 5 performs the authentication and/or authorization procedure of the PDU session by the DN_A 5. In the 21st condition determination, the DN_A 5 and/or the apparatus in the DN_A 5 determines whether the 21st condition determination is true or false. The DN_A 5 and/or the apparatus in the DN_A 5 may continue the present procedure in a case that the 21st condition determination is true, or may not continue the present procedure in a case that the 21st condition determination is false, and may transmit a message indicating the rejection to the SMF_A 230 via the UPF_A 235.

Next, the DN_A 5 and/or the apparatus in the DN_A 5 transmits an authentication and/or authorization Request message to the SMF_A 230 via the UPF_A 235, based on the reception of the authentication and/or authorization request message and/or the 21st condition determination (S1102).

Specifically, the DN_A 5 and/or the apparatus in the DN_A 5 transmit the authentication and/or authorization request message to the UPF_A 235 using the N6 interface. In a case that the UPF_A 235 receives the authentication and/or authorization request message, the UPF_A 235 transmits or forwards the authentication and/or authorization request message to the SMF_A 230 using the N4 interface.

The SMF_A 230 transmits a PDU session authentication request message to the UE_A 10 via the AMF_A 240, based on the reception of the authentication and/or authorization request message (S1104).

Specifically, the SMF_A 230 transmits the PDU session authentication request message to the AMF_A 240 using the N11 interface, and the AMF_A 240 that has received the PDU session authentication request message transmits the PDU session authentication request message to the UE_A 10 using the N1 interface.

Note that the PDU session authentication request message is not limited thereto, and may be a message indicating to request the authentication and/or authorization of the PDU session by the DN_A 5.

Here, the SMF_A 230 may include the 62nd identification information in the PDU session authentication request message, or may indicate the request of the DN_A 5 and/or the apparatus in the DN_A 5, by including these pieces of identification information.

In addition, by transmitting the 62nd identification information included in the PDU session authentication request message, the SMF_A 230 may indicate that the DN_A 5 performs the authentication and/or authorization to the PDU session and/or the UE_A 10 and/or the application, or may indicate that the DN_A 5 requires confirmation and/or selection of the authentication and/or authorization information of the DN_A 5 by the UE_A 10 and/or the application and/or the user.

Note that the SMF_A 230 may determine whether or not the 62nd identification information is to be included in the PDU session authentication request message, based on the received identification information, and/or the capability information of the network, and/or the policy such as the operator policy, and/or the state of the network.

For example, the SMF_A 230 may transmit the 62nd identification information included in the PDU session authentication request message. in a case that the PDU session establishment request message including the 61st identification information is received in the registration procedure and/or the PDU session establishment procedure. Note that determination performed by the SMF_A 230 as to which piece of identification information is to be included in the PDU session authentication request message is not limited to the determination described above.

The UE_A 10 receives a PDU session authentication request message. The UE_A 10 receives the PDU session authentication request message and recognizes the contents of various types of identification information included in the PDU session authentication request message.

The UE_A 10 further performs the fifth process, based on the reception of the PDU session authentication request message (S1106). Note that the UE_A 10 may perform the fifth process, based on the transmission of the PDU session authentication accept message, or based on the transmission of the PDU session authentication reject message, or based on the completion of the procedure.

Here, the fifth process may be a process in which the UE_A 10 recognizes a matter indicated by the SMF_A 230. Furthermore, the fifth process may be a process in which the UE_A 10 stores the received identification information as a context, or may be a process in which the UE_A 10 transfers the received identification information to a higher layer and/or a lower layer.

Furthermore, the fifth process may be a process in which the UE_A 10 determines whether or not the authentication and/or authorization information indicated by the 62nd identification information is appropriate, or may be process for placing information indicating whether or not the authentication and/or authorization information indicated by the received 62nd identification information is appropriate in the 63rd identification information.

Furthermore, the fifth process may be a process in which the UE_A 10 recognizes that the authentication and/or authorization information indicated by the 62nd identification information is the authentication/allowance information of the DN, may be a process for placing information indicating the response to the received 62nd identification information in the 63rd identification information, or may be a process for placing the same authentication and/or authorization information as the received 62nd identification information in the 63rd identification information.

Furthermore, the fifth process may be a process in which the UE_A 10 selects the appropriate authentication and/or authorization information from among the authentication and/or authorization information indicated by the 62nd identification information, or may be a process for placing the authentication and/or authorization information selected based on the 62nd identification information in the 63rd identification information.

Furthermore, the fifth process may be a process in which the UE_A 10 notifies a higher layer and/or the user of the 62nd identification information, or may be a process in which the higher layer and/or the user notified of the 62nd identification information selects appropriate authentication and/or authorization information from among the authentication and/or authorization information indicated by the 62nd identification information.

Furthermore, the fifth process may be a process in which the UE_A 10 acquires the authentication and/or authorization information selected based on the notified 62nd identification information from the higher layer and/or the user, or may be a process for placing the authentication and/or authorization information acquired from the higher layer and/or the user in the 63rd identification information.

Furthermore, the fifth process may be a process in which the UE_A 10 performs the 22nd condition determination. Note that the fifth process may not be limited to these processes.

The UE_A 10 performs the 22nd condition determination, based on the reception of the PDU session authentication and/or authorization request message and/or the completion of the fifth process. The 22nd condition determination is for determining whether or not the UE_A 10 accepts the authentication and/or authorization procedure of the PDU session by the DN_A 5. In the 22nd condition determination, the UE_A 10 determines whether the 22nd condition determination is true or false. In a case that the 22nd condition determination is true, the UE_A 10 initiates the procedure of (A) in the present procedure, and in a case that the 22nd condition determination is false, the UE_A 10 initiates the procedure of (B) in the present procedure. Note that steps in the case that the 22nd condition determination is false will be described later.

As follows, steps in a case that the 22nd condition determination is true, in other words, each step of the procedure of (A) in the present procedure will be described. The UE_A 10 transmits the PDU session authentication accept message to the SMF_A 230 via the AMF_A 240, based on the reception of the PDU session authentication and/or authorization request message, and/or the completion of the fifth process, and/or the 22nd condition determination (S1108).

Specifically, the UE_A 10 transmits the PDU session authentication accept message to the AMF_A 240 using the N1 interface. The AMF_A 240 that has received the PDU session authentication accept message transmits the PDU session authentication accept message to the SMF_A 230 using the N11 interface.

Note that the PDU session authentication accept message may be a NAS message transmitted and/or received on the N1 interface and the N11 interface. The PDU session authentication accept message only needs to be a response message to the PDU session authentication request message. However, the PDU session authentication accept message is not limited to this, and only needs to be a message indicating that the PDU session establishment authentication and/or authorization procedure has been accepted.

Here, the UE_A 10 may include the 63rd identification information in the PDU session authentication accept message, or the inclusion of the identification information may indicate the acceptance of the request of the network.

Furthermore, the UE_A 10 may indicate that the UE_A 10 and/or the application and/or the user have confirmed, accepted, or selected the authentication and/or authorization information of the DN_A 5 by transmitting the 63rd identification information included in the PDU session authentication accept message.

Note that the UE_A 10 may determine whether or not the 63rd identification information is to be included in the PDU session authentication accept message, based on the received identification information, the capability information of the UE_A 10, and/or the policy of the UE_A 10, and/or the state of the UE_A 10.

For example, the UE_A 10 may transmit the 63rd identification information included in the PDU session authentication accept message in a case that the 62nd identification information is received and/or the received 62nd identification information can be accepted. Note that the determination performed by the UE_A 10 as to which piece of identification information is to be included in the PDU session authentication accept message is not limited to the determination described above.

The SMF_A 230 receives a PDU session authentication accept message. Furthermore, each apparatus completes the procedure of (A) in the present procedure, based on transmission and/or reception of the PDU session authentication accept message.

Next, steps in a case that the 22nd condition determination is false, in other words, each step of the procedure of (B) in the present procedure will be described. The UE_A 10 transmits the PDU session authentication reject message to the SMF_A 230 via the AMF_A 240, based on the reception of the PDU session authentication and/or authorization request message, and/or the completion of the fifth process, and/or the 22nd condition determination (S1110).

Specifically, the UE_A 10 transmits the PDU session authentication reject message to the AMF_A 240 using the N1 interface. The AMF_A 240 that has received the PDU session authentication reject message transmits the PDU session authentication reject message to the SMF_A 230 using the N11 interface.

Note that the PDU session authentication reject message may be a NAS message transmitted and/or received on the N1 interface and the N11 interface. The PDU session authentication reject message only needs to be a response message to the PDU session authentication request message. However, the PDU session authentication reject message is not limited to this, and only needs to be a message indicating that the PDU session establishment authentication and/or authorization procedure has been rejected.

Here, the UE_A 10 may include information indicating a cause that the PDU session authentication request message has been rejected in the PDU session authentication reject message, or the inclusion of the identification information may indicate the reject of the request of the network.

Furthermore, the UE_A 10 may indicate that the UE_A 10 and/or the application and/or the user cannot accept or select the authentication and/or authorization information of the DN_A 5 by transmitting information indicating the cause that the PDU session authentication request message has been rejected included in the PDU session authentication accept message.

Note that the UE_A 10 may determine which identification information of causes that the PDU session authentication request message has been rejected is to be included in the PDU session authentication reject message, based on the received identification information, the capability information of the UE_A 10, and/or the policy of the UE_A 10, and/or the state of the UE_A 10. Note that the determination performed by the UE_A 10 as to which piece of identification information is to be included in the PDU session authentication reject message is not limited to the determination described above.

The SMF_A 230 receives a PDU session authentication reject message. Furthermore, each apparatus completes the procedure of (B) in the present procedure, based on transmission and/or reception of the PDU session authentication reject message.

The SMF_A 230 transmits an Authentication and/or authorization Response message to the DN_A 5 and/or the apparatus in the DN_A 5 via the UPF_A 235, based on the completion of the procedure of (A) in the present procedure and/or the completion of the procedure of (B) in the present procedure (S1112). In other words, the SMF_A 230 transmits the authentication and/or authorization response message to the DN_A 5 and/or the apparatus in the DN_A 5 via the UPF_A 235, based on the reception of the PDU session authentication accept message and/or the reception of the PDU session authentication reject message.

Specifically, the SMF_A 230 transmits the authentication and/or authorization response message to the UPF_A 235 using the N4 interface. In a case that the UPF_A 235 receives the authentication and/or authorization response message, the UPF_A 235 transmits or forwards the authentication and/or authorization response message to the DN_A 5 and/or the apparatus in the DN_A 5 using the N6 interface.

Note that the authentication and/or authorization resource public release for the DN_A 5 including the authentication and/or authorization response message exchange may be an Application Programming Interface (API) that the operator provides to the DN_A 5 and/or a service operator providing service on the DN_A 5. The authentication and/or authorization response message may be a response message for the authentication and/or authorization request message that is transmitted and/or received between the SMF_A 230 and/or the UPF_A 235 and the DN_A 5 and/or the apparatus included in the DN_A 5, but not limited to this.

Here, the SMF_A 230 may transmit the information received from the UE_A 10 and/or the apparatus in the core network and/or information held by the SMF_A 230 included in the authentication and/or authorization response message, or may include these pieces of identification information to indicate the request of the UE_A 10 and/or the SMF_A 230.

Here, in a case that the SMF_A 230 receives the 63rd identification information, the SMF_A 230 may include the 63rd identification information in the authentication and/or authorization response message, or may include these pieces of identification information to indicate that the request of the DN_A 5 and/or the apparatus in the DN_A 5 has been accepted. In a case that the SMF_A 230 receives the cause that the PDU session authentication request message has been rejected, the SMF_A 230 may include the cause that the PDU session authentication request message has been rejected in the authentication and/or authorization response message, or may include these pieces of identification information to indicate that the request of the DN_A 5 and/or the apparatus in the DN_A 5 has been rejected.

Note that the SMF_A 230 may determine which identification information to be placed in the authentication and/or authorization response message based on each identification information acquired based on the reception of the PDU session authentication accept message and/or the PDU session authentication reject message. Note that determination performed by the SMF_A 230 as to which piece of identification information is to be included in the authentication and/or authorization response message is not limited to the determination described above.

The DN_A 5 and/or the apparatus in the DN_A 5 receive the authentication and/or authorization response message. Furthermore, each apparatus completes the present procedure, based on the transmission and/or reception of the PDU session authentication accept message, and/or the transmission and/or reception of the PDU session authentication reject message, and/or the transmission and/or reception of the authentication and/or authorization response message. Note that each apparatus may transition to a state in which the PDU session is authenticated and/or authorized by the DN_A 5, based on the completion of the procedure of (A) in the present procedure. Each apparatus may recognize that the present procedure has been rejected, or may transition to a state in which the PDU session is not authenticated and/or authorized by the DN_A 5, based on the completion of the procedure of (B) in the present procedure.

Furthermore, each apparatus may perform processing based on identification information transmitted and/or received in the present procedure, based on completion of the present procedure. In other words, the UE_A 10 may adapt the authentication and/or authorization information acquired and/or issued by the selected DN_A 5, based on the completion of the present procedure.

The 21st condition determination may be performed based on identification information included in the authentication and/or authorization request message, and/or subscriber information, and/or a policy of the DN_A 5. For example, the 21st condition determination may be true in a case that the DN_A 5 and/or the apparatus in the DN_A 5 allows a request of the UE_A 10. The 21st condition determination may be false in a case that the DN_A 5 and/or the apparatus in the DN_A 5 does not allow a request of the UE_A 10. Furthermore, in a case that the DN_A 5 as the connection destination of the UE_A 10 and/or the apparatus in the DN_A 5 supports a function for authentication and/or authorization of the PDU session by the DN_A 5, the 21st condition determination may be true, and in a case that it is not supported, the 21st condition determination may be false. Note that conditions for determining whether the 21st condition determination is true or false may not be limited to the above-described conditions.

The 22nd condition determination may be performed based on the identification information included in the PDU session authentication request message, and/or the capability information of the UE_A 10, and/or the policy of the UE_A 10, and/or the state of the UE_A 10. For example, the 22nd condition determination may be true in a case that the UE_A 10 allows the request for authentication and/or authorization of the PDU session by the DN_A 5. The 22nd condition determination may be false in a case that the UE_A 10 does not allow the request for authentication and/or authorization of the PDU session by the DN_A 5. Conditions for determining true or false of the 22nd condition determination need not be limited to the above-described conditions.

### 1.3.4. Overview of RQoS Validation (Activation) Procedure

Next, an overview of the RQoS validation (activation) procedure performed to validate (activate) the RQoS for user data communication will be described. In this section, the RQoS validation procedure is also referred to as the present procedure. The present procedure is a procedure for each apparatus to validate the RQoS for user data communication. The present procedure includes a RQoS to be controlled initiatively by UE validation procedure, which is initiated by the UE_A 10, and a RQoS to be controlled initiatively by network validation procedure, which is initiated by an apparatus in the core network.

Note that each apparatus may perform the present procedure in a state in which the PDU session is established or during the user data communication. In addition, each apparatus may initiate the present procedure at any timing after the PDU session establishment procedure. Each apparatus may validate the RQoS for user data communication or may implement user data communication using the RQoS, based on the completion of the RQoS validation procedure. Note that the validation of the RQoS for user data communication may be to control the RQoS for user data communication, or may validate the RQoS for a specific user data flow. Furthermore, the validation of the RQoS for the user data communication may be for the UE_A 10 to create a QoS rule (also referred to as a Derived QoS Rule) for the uplink traffic and/or the uplink packet, based on the received downlink packet and/or the identification information included in the downlink packet, and start the use of the created QoS rule.

Here, the present procedure may be a procedure in which each apparatus validates the RQoS for user data communication via the User plane, and may be referred to as an RQoS validation procedure controlled via the User Plane.

### 1.3.4.1. RQoS to be Controlled Initiatively by UE Validation Procedure Example

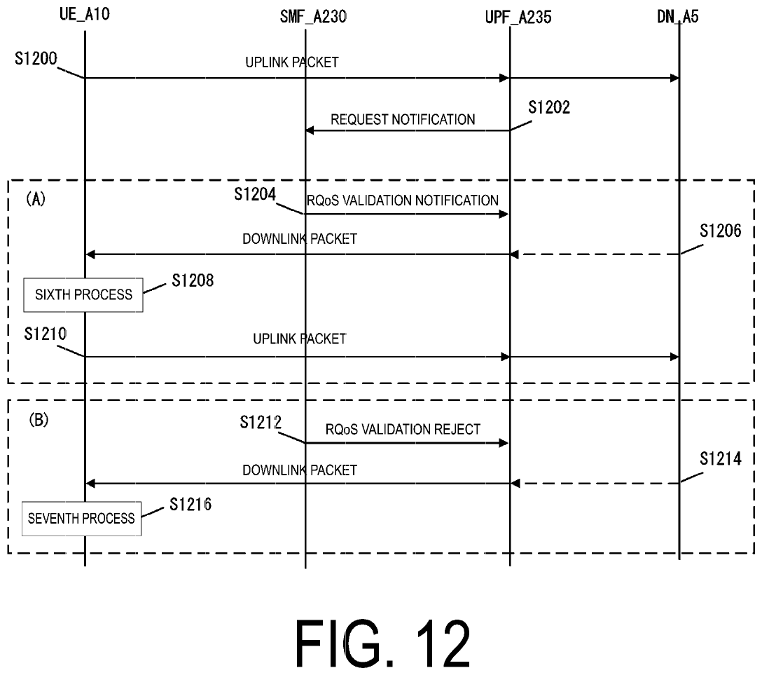

An example of an order of the RQoS to be controlled initiatively by UE validation procedure will be described with reference to FIG. 12. In this section, the RQoS to be controlled initiatively by UE validation procedure is also referred to as the present procedure. Note that the present procedure may be referred to as the RQoS validation procedure controlled via the User Plane initiated by the UE. Each step of the present procedure will be described. First, the UE_A 10 transmits the uplink packet to the UPF_A 235 via the NR node_A 122 (S1200), to initiate the RQoS to be controlled initiatively by UE validation procedure.

Specifically, the UE_A 10 transmits an uplink packet to the UPF_A 235 using the radio bearer and/or the N3 interface and/or the N9 interface. Here, the UE_A 10 may select the UPF_A 235 in a routing direction based on the information held by the UE_A 10. More specifically, the UE_A 10 may select the QoS flow and/or the UPF_A 235 used for the transmission of the uplink packet by comparing the routing information of the uplink packet with the routing rules held by the UE_A 10 and/or the QoS rules. Note that in a case that the routing rules and/or the QoS rules that match the routing information of the uplink packet are not present, the UE_A 10 may select the QoS flow and/or the UPF_A 235 used for the transmission of the uplink packet using the default routing rules and/or the default QoS rules. The default QoS rules include a QoS rule identifier (QoS rule ID), a QFI of the QoS flow, one or more packet filters, and a precedence value. However, the default QoS rules may be configured of these components without including packet filters, and in this case, the precedence value is configured to the maximum value. In other words, the priority is the lowest.

Here, the routing information of the uplink packet may be information identifying the application or may be five tuples. More specifically, the routing information of the uplink packet may be an IP address of the transmission destination (target IP address), and/or an IP address of the transmission source (source IP address), and/or a protocol number, and/or a port number of the transmission destination (target port number), and/or a port number of the transmission source (source port number), or may be information of these combined. Note that the routing information of the uplink packet is not limited to these.

Furthermore, the uplink packet may be a message transmitted from the UE_A 10 to the access network and/or the core network and/or the DN_A 5 in the user data communication. Accordingly, the inclusion of the identification information in the uplink packet may be to include the identification information in the header of the uplink packet, may be to include the identification information in the header of the message of the uplink packet, or may be to include the identification information in the message of the uplink packet. Note that in a case that there is no uplink packet to be transmitted to the DN_A 5 and/or the apparatus in the DN_A 5, the UE_A 10 may transmit a dummy uplink packet to the UPF_A 235.

Here, the UE_A 10 may include the 41st identification information and/or the 42nd identification information in the uplink packet, or may indicate that the validation of the RQoS for the user data communication is requested by including these pieces of identification information.

Furthermore, the UE_A 10 may request to validate the RQoS for the user data communication initiated by the UE by transmitting the 41st identification information and/or the 42nd identification information included in the uplink packet.

Furthermore, the UE_A 10 may request that the QoS flow used for the transmission and/or reception of the uplink packet indicated by the routing information of the uplink packet to be changed to the QoS flow indicated by the 42nd identification information, by transmitting the 41st identification information and/or the 42nd identification information included in the uplink packet.

Note that the UE_A 10 may determine which piece of identification information out of the 41st identification information and the 42nd identification information is to be included in the uplink packet, based on capability information of the UE_A 10, and/or a policy such as a UE policy, and/or preference of the UE_A 10. Note that the determination performed by the UE_A 10 as to which piece of identification information is to be included in the uplink packet is not limited to the determination described above.

The UPF_A 235 receives the uplink packet (S1200). The UPF_A 235 may forward the received uplink packet to the DN_A 5 and/or the apparatus in the DN_A 5, based on the reception of the uplink packet.

Next, the UPF_A 235 transmits a request notification message to the SMF_A 230, based on the reception of the uplink packet and/or the transfer of the uplink packet (S1202). Specifically, the UPF_A 235 transmits the request notification message to the SMF_A 230 using the N4 interface. Furthermore, the request notification message is not limited to this as long as the request notification message is a message indicating the request for the validation of the RQoS for the user data communication.

Here, the UPF_A 235 may include the identification information included in the received uplink packet in the request notification message. In other words, the UPF_A 235 may transmit the request notification message including the received 41st identification information and/or the 42nd identification information, or may indicate that the validation of the RQoS for the user data communication is requested by transmitting these pieces of identification information.

The SMF_A 230 receives the request notification message (S1202), and performs the 31st condition determination. The 31st condition determination is to determine whether the SMF_A 230 accepts the request of the UE_A 10. In the 31st condition determination, the SMF_A 230 determines whether the 31st condition determination is true or false. The SMF_A 230 initiates the procedure of (A) in the present procedure in a case that the 31st condition determination is true (in other words, in a case that the request of the UE_A 10 is accepted), and initiates the procedure of (B) in the present procedure in a case that the 31st condition determination is false (in other words, in a case that the request of the UE_A 10 is rejected). Note that steps in the case that the 31st condition determination is false will be described later.

As follows, steps in a case that the 31st condition determination is true, in other words, each step of the procedure of (A) in the present procedure will be described. The SMF_A 230 transmits an RQoS validation notification message to the UPF_A 235 (S1204), based on the 31st condition determination and/or the reception of the request notification message, to initiate the procedure of (A) in the present procedure. Specifically, the SMF_A 230 transmits the RQoS validation notification message to the UPF_A 235 using the N4 interface. Note that the RQoS validation notification message is not limited thereto, and may be a message indicating the validation of the RQoS for the user data communication.

Here, the SMF_A 230 may include the 31st identification information and/or the 32nd identification information in the RQoS validation notification message, or may indicate that the request of the UE_A 10 has been accepted by including these pieces of identification information.

Furthermore, the SMF_A 230 may indicate that the request for the validation of the RQoS has been accepted or may indicate that the RQoS is validated by transmitting the 31st identification information and/or the 32nd identification information included in the RQoS validation notification message.

Furthermore, the SMF_A 230 may indicate that the QoS flow used for the transmission and/or reception of a specific downlink packet is changed to the QoS flow indicated by the 32nd identification information by transmitting the 31st identification information and/or the 32nd identification information included in the RQoS validation notification message.

Note that the SMF_A 230 may determine which piece of identification information among the 31st identification information and the 32nd identification information is included in the RQoS validation notification message, based on the received identification information, and/or the capability information of the network, and/or the policy such as the operator policy, and/or the state of the network.

For example, the SMF_A 230 may transmit the 31st identification information and/or the 32nd identification information included in the RQoS validation notification message in a case that the 41st identification information and/or the 42nd identification information is received, and/or in a case that the request indicated by the received 41st identification information and/or the 42nd identification information has been accepted.

Note that the 32nd identification information may be determined based on the 42nd identification information. In other words, the 32nd identification information may be information identifying the same QoS flow as the QoS flow indicated by the 42nd identification information, or may be information identifying a QoS flow different from the QoS flow indicated by the 42nd identification information. Note that determination performed by the SMF_A 230 as to which piece of identification information is to be included in the RQoS validation notification message is not limited to the determination described above.

Here, the SMF_A 230 may create contexts for RQoS, based on each piece of identification information acquired based on the reception of the request notification message, and/or the capability information of the network, and/or the subscriber information, and/or the operator policy, and/or the state of the network, and/or the context already held by the SMF_A 230.

The UPF_A 235 receives the RQoS validation notification message (S1204). The UPF_A 235 recognizes the contents of various types of identification information included in the RQoS validation notification message by receiving the RQoS validation notification message. The UPF_A 235 may create a QoS rule and/or the context for the RQoS, based on each identification information acquired in the reception of the RQoS validation notification message.

Furthermore, the UPF_A 235 may receive a downlink packet transmitted by the DN_A 5 and/or the apparatus in the DN_A 5 (S1206). The UPF_A 235 transmits the downlink packet to the UE_A 10, based on the reception of the RQoS validation notification message and/or the reception of the downlink packet from the DN_A 5 (S1206).

Specifically, the UPF_A 235 transmits the downlink packet to the UE_A 10 using the N9 interface and/or the N3 interface and/or the radio bearer. Here, the UPF_A 235 may select the UE_A 10 in the routing direction based on the information held by the UPF_A 235. More specifically, the UPF_A 235 may select the QoS flow and/or the UE_A 10 used for the transmission of the downlink packet by comparing the routing information of the downlink packet with the routing rules held by the UPF_A 235 and/or the QoS rules. Note that in a case that the routing rules and/or the QoS rules that match the routing information of the downlink packet are not present, the UE_A 10 may select the QoS flow and/or the UPF_A 235 used for the transmission of the downlink packet using the default routing rules and/or the default QoS rules.

Here, the routing information of the downlink packet may be information identifying the application or may be five tuples. More specifically, the routing information of the downlink packet may be an IP address of the transmission destination, and/or an IP address of the transmission source, and/or a protocol number, and/or a port number of the transmission destination, and/or a port number of the transmission source, or may be information of these combined. Note that the routing information of the downlink packet is not limited to these.

Furthermore, the downlink packet may be a message transmitted to the UE_A 10 from the DN_A 5 and/or the apparatus in the DN_A 5 in the user data communication, may be a message transmitted from the apparatus in the core network to the UE_A 10, or may be a message that forwards these messages of the user data communication. Accordingly, the inclusion of the identification information in the downlink packet may be to include the identification information in the header of the downlink packet, may be to include the identification information in the header of the downlink packet not including a message used for the transfer, may be to include the identification information in the header of the message used for the transfer of the downlink packet, or may be to include the identification information in the message used for the transfer of the downlink packet. Note that in a case that there is no downlink packet received from the DN_A 5 and/or the apparatus in the DN_A 5, the UPF_A 235 may transmit a dummy downlink packet to the UE_A 10.

Here, the UPF_A 235 may include the 31st identification information and/or the 32nd identification information in the downlink packet, may indicate that the RQoS for the user data communication is validated by including these pieces of identification information, or may indicate that the request of the UE_A 10 has been accepted.

Furthermore, the UPF_A 235 may indicate that the request of the validation of the RQoS has been accepted or may indicate that the RQoS is validated, by transmitting the 31st identification information and/or the 32nd identification information included in the downlink packet.

Furthermore, the UPF_A 235 may indicate that the QoS flow used for the transmission and/or reception of a specific downlink packet is changed to the QoS flow indicated by the 32nd identification information by transmitting the 31st identification information and/or the 32nd identification information included in the downlink packet.

Note that the UPF_A 235 may determine which piece of identification information among the 31st identification information and the 32nd identification information is to be included in the downlink packet, based on the received identification information, and/or the capability information of the network, and/or the policy such as the operator policy, and/or the state of the network.

For example, the UPF_A 235 may transmit the 31st identification information and/or the 32nd identification information included in the downlink packet in a case that the 31st identification information and/or the 32nd identification information is received, and/or in a case that the 41st identification information and/or the 42nd identification information is received, and/or in a case that the SMF_A 230 has determined that the request indicated by the received 41st identification information and/or the 42nd identification information can be accepted.

Note that the 32nd identification information may be determined based on the 42nd identification information. In other words, the 32nd identification information may be information identifying the same QoS flow as the QoS flow indicated by the 42nd identification information, or may be information identifying a QoS flow different from the QoS flow indicated by the 42nd identification information. Note that the determination performed by the UPF_A 235 as to which piece of identification information is to be included in the downlink packet is not limited to the determination described above.

The UE_A 10 receives the downlink packet (S1206). The UE_A 10 receives the downlink packet and recognizes the contents of various types of identification information included in the downlink packet.

The UE_A 10 further performs the sixth process, based on the reception of the downlink packet (S1208).

Here, the sixth process may be a process in which the UE_A 10 recognizes a matter indicated by the UPF_A 235. Furthermore, the sixth process may be a process in which the UE_A 10 stores the received identification information as a context, or may be a process in which the UE_A 10 transfers the received identification information and/or user data to a higher layer and/or a lower layer.

Furthermore, the sixth process may be a process in which the UE_A 10 validates the RQoS for the user data communication. In other words, the sixth process may be a process in which the UE_A 10 creates a QoS rule (Derived QoS Rule) and/or a routing rule for the uplink packet based on the received downlink packet, or may be a process for the validation of the created QoS rule and/or routing rule.

More specifically, the sixth process may be to create a QoS rule and/or a routing rule by the UE_A 10 associated with the routing information of the uplink packet paired with the routing information of the received downlink packet, or may be to validate the created QoS rule and/or routing rule. The QoS flow used for the transfer of the uplink packet indicated by the created QoS rule and/or the routing rule may be the QoS flow indicated by the 32nd identification information.

Furthermore, the sixth process may be a process in which the UE_A 10 recognizes the QoS flow and/or the QoS rule and/or the routing rule associated with the routing information of the received downlink packet. More specifically, the sixth process may be for the UE_A 10 to recognize that the QoS flow used for the transfer of the downlink packets indicated by the routing information of the received downlink packet is the QoS flow indicated by the 32nd identification information.

Furthermore, the sixth process may be a process in which the UE_A 10 starts a Reflective QoS Timer (RQoS timer, also referred to as an RQ timer). More specifically, the sixth process may be a process in which the UE_A 10 starts an RQoS timer configured with a timer value received from the network and/or a timer value held by the UE_A 10.

Note that the start of the RQoS timer may be performed based on the creation and/or the validation of the QoS rule and/or routing rule. In a case that a QoS rule and/or a routing rule associated with the routing information of the uplink packet paired with the routing information of the received downlink packet is already present, the UE_A 10 may restart the running RQoS timer.

Note that the timer value received from the network may be a timer value received from the apparatus in the core network in the registration procedure and/or the PDU session establishment procedure, or may be, for example, a timer value indicated by the 16th identification information received in the registration procedure and/or the PDU session establishment procedure. Note that the timer value received from the network may be a timer value received by the UE_A 10 from the network prior to the sixth process, but the timer value is not limited thereto.

The timer value held by the UE_A 10 may be a timer value configured in advance to the UE_A 10 at the time of shipping. Note that the timer value held by the UE_A 10 may be a timer value configured to the UE_A 10, but the timer value is not limited thereto.

Furthermore, in a case that the UE_A 10 has previously transmitted the uplink packet including the 41st identification information and/or the 42nd identification information, the sixth process may be a process in which the UE_A 10 recognizes that the RQoS to be controlled initiatively by UE validation procedure has been accepted by the network. Note that the sixth process may not be limited to these processes.

Next, the UE_A 10 may transmit the uplink packet to the UPF_A 235, based on the reception of the downlink packet and/or the completion of the sixth process (S1210). Furthermore, in a case that the uplink packet is received, the UPF_A 235 may forward the received uplink packet to the DN_A 5 and/or the apparatus in the DN_A 5 (S1210). In this case, the DN_A 5 and/or the apparatus in the DN_A 5 receives the uplink packet.

Note that the UE_A 10 may use the QoS rule and/or the routing generated in the sixth process for the transmission of the uplink packet. Furthermore, the uplink packet may be the same message as the previously transmitted uplink packet (S1200) or may be a different message.

Each apparatus completes the procedure of (A) in the present procedure, based on the transmission and/or reception of the downlink packet (S1206) and/or the completion of the sixth process (S1208) and/or the transmission and/or reception of the uplink packet (S1210).

Next, steps in a case that the 31st condition determination is false, in other words, each step of the procedure of (B) in the present procedure will be described. The SMF_A 230 transmits an RQoS validation reject message to the UPF_A 235 (S1212), based on the 31st condition determination and/or the reception of the request notification message, and initiates the procedure of (B) in the present procedure. Specifically, the SMF_A 230 transmits the RQoS validation reject message to the UPF_A 235 using the N4 interface. Note that the RQoS validation reject message is not limited thereto, and may be a message indicating that the request for the validation of the RQoS for the user data communication has been rejected.

Here, the SMF_A 230 may include the 51st identification information in the RQoS validation reject message, or may indicate that the request of the UE_A 10 has been rejected by including the identification information.

Furthermore, by transmitting the 51st identification information included in the RQoS validation notification message, the SMF_A 230 may indicate that the request for the validation of the RQoS has been rejected, may indicate the cause for rejecting the request for the validation of the RQoS, or may indicate that the RQoS cannot be validated.

Note that the SMF_A 230 may determine whether or not the 51st identification information is to be included in the RQoS validation reject message, based on the received identification information, and/or the capability information of the network, and/or the policy such as the operator policy, and/or the state of the network.

For example, the SMF_A 230 may transmit the 51st identification information included in the RQoS validation notification message in a case that the 41st identification information and/or the 42nd identification information is received, and/or in a case that the request indicated by the received 41st identification information and/or the 42nd identification information cannot be accepted. Note that determination performed by the SMF_A 230 as to which piece of identification information is to be included in the RQoS validation reject message is not limited to the determination described above.

The UPF_A 235 receives the RQoS validation reject message (S1212). The UPF_A 235 recognizes the contents of various types of identification information included in the RQoS validation reject message by receiving the RQoS validation reject message.

Furthermore, the UPF_A 235 may receive a downlink packet transmitted by the DN_A 5 and/or the apparatus in the DN_A 5 (S1214). The UPF_A 235 transmits the downlink packet to the UE_A 10, based on the reception of the RQoS validation reject message and/or the reception of the downlink packet from the DN_A 5 (S1214).

Specifically, the UPF_A 235 transmits the downlink packet to the UE_A 10 using the N9 interface and/or the N3 interface and/or the radio bearer. Here, the UPF_A 235 may select the UE_A 10 in the routing direction based on the information held by the UPF_A 235. More specifically, the UPF_A 235 may select the QoS flow and/or the UE_A 10 used for the transmission of the downlink packet by comparing the routing information of the downlink packet with the routing rules held by the UPF_A 235 and/or the QoS rules. Note that in a case that the routing rules and/or the QoS rules that match the routing information of the downlink packet are not present, the UE_A 10 may select the QoS flow and/or the UPF_A 235 used for the transmission of the downlink packet using the default routing rules and/or the default QoS rules.

Here, the routing information of the downlink packet may be information identifying the application or may be five tuples. More specifically, the routing information of the downlink packet may be an IP address of the transmission destination, and/or an IP address of the transmission source, and/or a protocol number, and/or a port number of the transmission destination, and/or a port number of the transmission source, or may be information of these combined. Note that the routing information of the downlink packet is not limited to these.

Furthermore, the downlink packet may be a message transmitted to the UE_A 10 from the DN_A 5 and/or the apparatus in the DN_A 5 in the user data communication, may be a message transmitted from the apparatus in the core network to the UE_A 10, or may be a message that forwards these messages of the user data communication. Accordingly, the inclusion of the identification information in the downlink packet may be to include the identification information in the header of the downlink packet, may be to include the identification information in the header of the downlink packet not including a message used for the transfer, may be to include the identification information in the header of the message used for the transfer of the downlink packet, or may be to include the identification information in the message used for the transfer of the downlink packet. Note that in a case that there is no downlink packet received from the DN_A 5 and/or the apparatus in the DN_A 5, the UPF_A 235 may transmit a dummy downlink packet to the UE_A 10.

Here, the UPF_A 235 may include the 51st identification information in the downlink packet, may indicate that the RQoS for the user data communication has not been validated by including the identification information, or may indicate that the request of the UE_A 10 has not been accepted.

Furthermore, by transmitting the 51st identification information included in the RQoS validation notification message, the UPF_A 235 may indicate that the request for the validation of the RQoS has been rejected, may indicate the cause that the request for the validation of the RQoS has been rejected, or may indicate that the RQoS cannot be validated.

Note that the UPF_A 235 may determine whether or not the 51st identification information is to be included in the downlink packet, based on the received identification information, and/or the capability information of the network, and/or the policy such as the operator policy, and/or the state of the network.

For example, the UPF_A 235 may transmit the 51st identification information included in the RQoS validation notification message in a case that the 51st identification information is received, and/or in a case that the 41st identification information and/or the 42nd identification information is received, and/or in a case that the SMF_A 230 has determined that the request indicated by the received 41st identification information and/or the 42nd identification information cannot be accepted. Note that the determination performed by the UPF_A 235 as to which piece of identification information is to be included in the downlink packet is not limited to the determination described above.

The UE_A 10 receives the downlink packet (S1214). The UE_A 10 receives the downlink packet and recognizes the contents of various types of identification information included in the downlink packet.

The UE_A 10 further performs the seventh process, based on the reception of the downlink packet (S1216).

Here, in a case that the UE_A 10 has previously transmitted the uplink packet including the 41st identification information and/or the 42nd identification information, the seventh process may be a process in which the UE_A 10 recognizes that the RQoS to be controlled initiatively by UE validation procedure has been rejected by the network, or may be a process for recognizing the cause that the RQoS to be controlled initiatively by UE validation procedure has been rejected.

In other words, the seventh process may be a process in which the UE_A 10 recognizes that the RQoS to be controlled initiatively by UE validation procedure is not allowed, based on the received 51st identification information, or may be a process for recognizing the cause that the RQoS to be controlled initiatively by UE validation procedure is not allowed.

Furthermore, the seventh process may be a process in which the UE_A 10 starts a backoff timer for inhibiting the initiation of the RQoS to be controlled initiatively by UE validation procedure for a certain period of time. Note that the value of the backoff timer for inhibiting the initiation of the RQoS to be controlled initiatively by UE validation procedure for a certain period of time may be a value configured in advance to the UE_A 10, or may be a timer value received from the network.

Furthermore, the seventh process may be a process in which the UE_A 10 initiates the present procedure again after a certain period of time, may be a process in which the UE_A 10 initiates a procedure for changing and/or disconnecting the PDU session established, or may be a process in which the request of the UE_A 10 to transition to a limited state. Note that the seventh process may not be limited to these processes.

Each apparatus completes the procedure of (B) in the present procedure, based on the transmission and/or reception of the downlink packet (S1214) and/or the completion of the seventh process (S1216).

Each apparatus completes the present procedure, based on completion of the procedure of (A) or (B) in the present procedure. Note that each apparatus may transition to a state in which the RQoS for the user data communication is validated, based on the completion of the procedure of (A) in the present procedure. Each apparatus may recognize that the present procedure has been rejected, may transition to a state in which the RQoS for the user data communication is not validated, or may maintain a state in which the RQoS for the user data communication is not applied, based on the completion of the procedure of (B) in the present procedure.

Furthermore, each apparatus may perform processing based on identification information transmitted and/or received in the present procedure, based on completion of the present procedure. In other words, the UE_A 10 may perform the sixth process or may perform the seventh process, based on the completion of the present procedure.

Furthermore, each apparatus may perform the user data communication using the QoS rule and/or routing rule validated in the present procedure after the completion of the present procedure. Furthermore, each apparatus may initiate the RQoS deactivation procedure after the completion of the present procedure.

The 31st condition determination may be performed based on identification information, and/or subscriber information, and/or an operator policy included in the uplink packet and/or the request notification message. For example, the 31st condition determination may be true in a case that the network allows a request of the UE_A 10. The 31st condition determination may be false in a case that the network does not allow a request of the UE_A 10. Furthermore, the 31st condition determination may be true in a case that the network of a destination of registration of the UE_A 10 and/or an apparatus in the network supports a function requested by the UE_A 10, and may be false in a case that the network and/or the apparatus does not support the function. Note that conditions for determining whether the 31st condition determination is true or false may not be limited to the above-described conditions.

### 1.3.4.2. RQoS to be Controlled Initiatively by Network Validation Procedure Example

An example of an order of the RQoS to be controlled initiatively by network validation procedure will be described with reference to FIG. 12. In this section, the RQoS to be controlled initiatively by network validation procedure is also referred to as the present procedure. Note that the present procedure may be referred to as the RQoS validation procedure controlled via the User Plane initiated by the network. Furthermore, the RQoS to be controlled initiatively by network validation procedure is similar to the procedure of (A) in the RQoS to be controlled initiatively by UE validation procedure, and thus only the part with differences will be described here.

The UE_A 10 performs the sixth process (S1208) described above, based on the reception of the downlink packet (S1206). In the sixth process, the UE_A 10 can further reject the application of the RQoS. In this case, the UE_A 10 transmits the uplink packet including information indicating that the application of the RQoS is rejected to the UPF_A 235 (S1210).

### 1.3.5. Overview of RQoS Deactivation Procedure

Next, a procedure for deactivating (also referred to as invalidating) activated (also referred to as validated) Reflective QoS (RQoS) will be described. The procedure to deactivate the RQoS includes a first deactivation procedure initiated by the UE and a second deactivation procedure initiated by the network. These procedures are initiated while the RQoS controlled via the User Plane (UP) is validated. In other words, these procedures are initiated while the value of the RQoS timer has not disappeared.

Note that these procedures can also be used to invalidate the RQoS controlled via the UP validated initiatively by the network, or can also be used to invalidate the RQoS controlled via the UP validated initiatively by the UE.

### 1.3.5.1. Overview of First RQoS Deactivation Procedure

First, the case of the first deactivation procedure will be described. The UE_A 10 transmits a QoS Flow ID (QFI) for identifying a QoS flow to be deactivated, and a Reflective QoS Indication (RQI) indicating deactivation request included in a header of an uplink packet to be transmitted to the apparatus in the core network. In a case that the RQI includes 1 bit, it is preferably configured to 0, but may be configured to 1. In addition, in a case that the RQI includes multiple bits, it is preferably configured to all 0. however, the configuration is not limited thereto, and for example, it may be configured to all 1. The UE_A 10 may transmit information indicating the request for deactivation instead of the RQI included in the header of the uplink packet to be transmitted. Note that, in a case that deactivation for multiple QoS flows is requested, multiple sets of QFI and RQI or multiple sets of QFI and information indicating a request for deactivation can be transmitted included in the header of the uplink packet. Furthermore, in a case that deactivation for all of the QoS flows is requested, QFI may not be included. Note that to include, by the UE_A 10, information such as QFI or RQI in the header of the uplink packet may be to include, by the UE_A 10, information such as QFI or RQI in the uplink packet.

The apparatus in the core network receives, from the UE_A 10, the header of the uplink packet including one or more sets of QFI and RQI, or one or more sets of QFI and information indicating a request for deactivation. Here, in a case that the apparatus in the core network is requested to deactivate multiple QoS flows from the UE_A 10, the apparatus in the core network may accept a request for deactivation for all QoS flows, may reject a request for deactivation for all QoS flows, may accept a request for deactivation for some QoS flows, or may reject a request for deactivation for the remaining QoS flow. In a case that the apparatus in the core network accepts a request for deactivation for a certain QoS flow, the apparatus in the core network transmits the QFI corresponding to the QoS flow and information indicating that the request for deactivation is accepted included in the header of the downlink packet to the UE_A 10. In a case that the apparatus in the core network rejects a request for deactivation for a certain QoS flow, the apparatus in the core network transmits the QFI corresponding to the QoS flow and information indicating that the request for deactivation is rejected included in the header of the downlink packet to the UE_A 10. Note that these pieces of information may be transmitted while being included in a header of one downlink packet or may be transmitted while being included in a header of each separate downlink packet. The apparatus in the core network may not include QFI in a case of accepting or rejecting a request for deactivation for all QoS flows. Note that to include, by the apparatus in the core network, information such as QFI or RQI in the header of the downlink packet may be to include, by the apparatus in the core network, information such as QFI or RQI in the downlink packet.

In a case that the UE_A 10 receives the header of the downlink packet including the QFI and the information indicating that the request for deactivation is accepted, the UE_A 10 deletes the configuration for the RQoS corresponding to the QoS flow identified by the QFI even in a case that the value of the RQoS timer has not disappeared. In other words, in a case that the UE_A 10 receives the header of the downlink packet including the QFI and the information indicating that the request for deactivation is accepted, the UE_A 10 deletes the configuration for the RQoS corresponding to the QoS flow identified by the QFI even in a case that the execution of the RQoS timer has not expired. At this time, the UE_A 10 applies the default QoS to the QoS flow. Conversely, in a case that the UE_A 10 receives the header of the downlink packet including the QFI and the information indicating that the request for deactivation is rejected, the UE_A 10 maintains the configuration for the RQoS corresponding to the QoS flow identified by the QFI.

Note that, in the description of the first deactivation procedure, all of the various types of information are included in the header. However, the present invention is not limited thereto. For example, in a case that there is uplink data to be transmitted, the UE_A 10 may transmit at least a portion of the various types of information transmitted while being included in the header of the uplink packet, included in the uplink data. At this time, the network side can recognize the meanings of various kinds of information included in the uplink data. In a case that there is downlink data to be transmitted, the network may transmit at least a portion of the various types of information transmitted while being included in the header of the downlink packet, included in the downlink data. At this time, the UE_A 10 side can recognize the meanings of various types of information included in the downlink data.

### 1.3.5.2. Overview of Second RQoS Deactivation Procedure

Next, the case of the second deactivation procedure will be described. The apparatus in the core network may deactivate all of one or more QoS flows, may deactivate some QoS flows, or may deactivate and deactivate some QoS flows. In a case that the apparatus in the core network deactivates a certain QoS flow, the apparatus in the core network transmits the QFI corresponding to the QoS flow and information indicating the deactivation included in the header of the downlink packet to the UE_A 10. In a case that the apparatus in the core network deactivates a certain QoS flow, these pieces of information may be transmitted while being included in a header of one downlink packet or may be transmitted while being included in a header of each separate downlink packet. The apparatus in the core network may not include QFI in a case of deactivating all QoS flows. Note that the apparatus in the core network does not transmit anything in a case of not deactivating a certain QoS flow.

In a case that the UE_A 10 receives the header of the downlink packet including the QFI and the information indicating the deactivation, the UE_A 10 deletes the configuration for the RQoS corresponding to the QoS flow identified by the QFI even in a case that the value of the RQoS timer has not disappeared. In other words, in a case that the UE_A 10 receives the header of the downlink packet including the QFI and the information indicating the deactivation, the UE_A 10 deletes the configuration for the RQoS corresponding to the QoS flow identified by the QFI even in a case that the execution of the RQoS timer has not expired. At this time, the UE_A 10 applies the default QoS to the QoS flow. Conversely, in a case that the UE_A 10 does not receive the header of the downlink packet including the QFI and the information indicating the deactivation, the UE_A 10 maintains the configuration for the RQoS corresponding to the QoS flow identified by the QFI.

Note that, in the description of the second deactivation procedure, all of the various types of information are included in the header. However, the present invention is not limited thereto. For example, in a case that there is downlink data to be transmitted, the network may transmit at least a portion of the various types of information transmitted while being included in the header of the downlink packet, included in the downlink data. At this time, the UE_A 10 side can recognize the meanings of various types of information included in the downlink data.

### 2. Modified Examples

A program running on an apparatus according to the present invention may serve as a program that controls a Central Processing Unit (CPU) and the like to cause a computer to operate in such a manner as to realize the functions of the above-described embodiment according to the present invention. Programs or information handled by the programs are temporarily stored in a volatile memory such as a Random Access Memory (RAM), a non-volatile memory such as a flash memory, a Hard Disk Drive (HDD), or another storage device system.

Note that a program for realizing such functions of the embodiment according to the present invention may be recorded on a computer-readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically retaining the program for a short time, or any other computer readable recording medium.

Furthermore, each functional block or various characteristics of the apparatuses used in the above-described embodiment may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor, or may be a processor of a known type, a controller, a micro-controller, or a state machine instead. The above-mentioned electric circuit may include a digital circuit, or may include an analog circuit. Furthermore, in a case that a circuit integration technology that replaces the present integrated circuit appears with advances in semiconductor technology, one or more aspects of the present invention can also use a new integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

1. A User Equipment (UE) comprising:
a transmitter, wherein
a first Protocol Data Unit or Packet Data Unit (PDU) session establishment request message is a PDU session establishment request message using a first user identity and a first Data Network Name (DNN), and
in a case that a reject cause value indicating user authentication or authorization failed is received in response to the first PDU session establishment request message, the transmitter restricts transmission of a second PDU session establishment request message using a user identity for the first DNN until a change to a user identity different from the first user identity is made, or until a terminal is powered on/off or a Universal Subscriber Identity Module (USIM) is ejected and/or inserted.

2. A User Equipment (UE) comprising:
a transmitter, wherein
a first Protocol Data Unit or Packet Data Unit (PDU) session establishment request message is a PDU session establishment request message using a first user identity and a first Data Network Name (DNN), and
in a case that a reject cause value indicating user authentication or authorization failed is received in response to the first PDU session establishment request message, the transmitter restricts a second PDU session establishment request message using a user identity for the first DNN, and
in a case a change to a user identity different from the first user identity is made while the second PDU session establishment request message is restricted, transmission of the second PDU session establishment request message using the user identity is allowed for the first DNN.

3. A User Equipment (UE) comprising:
a transmitter, wherein
a first Protocol Data Unit or Packet Data Unit (PDU) session establishment request is a PDU session establishment request using a first user identity, a first Data Network Name (DNN), and a first Single Network Slice Selection Assistance information (S-NSSAI), and
in a case that a reject cause value indicating user authentication or authorization failed is received in response to the first PDU session establishment request is received, the transmitter restricts transmission of a second PDU session establishment request message using a user identity for the first DNN and the first S-NSSAI until a change to a user identity different from the first user identity is made, or until a terminal is powered on/off or a Universal Subscriber Identity Module (USIM) is ejected and/or inserted.

4. (canceled)

5. (canceled)
